(19) United States
(12) Patent Application Publication
(10) Pub. No.: US 2010/0000491 A1
(43) Pub. Date: Jan. 7, 2010

(54) Rotary engines, systems and methods

(76) Inventor: Cameron L. Tinder, Clarkston, WA (US)

Correspondence Address: Gregory IPL, P.C., Suite 904, 601 West Main, Spokane, WA, 99201-3825, US

(21) Appl. No.: 12/217,483

(22) Filed: Jul. 3, 2008

(51) Int. Cl. F01C 19/02; F02B 53/00

(52) U.S. Cl. 123/205; 418/142

(57) ABSTRACT

Rotary engine and operational methods wherein a rotor rotates within a stator having an enclosed combustion housing. Housing seals bear upon the rotor and seals on the rotor move in response to the housing interior wall. Combustion chambers are defined between the stator, stator seals, rotor and rotor seals. Multiple combustion chambers are provided for increased torque and varied firing frequencies. Multiple ignitions can be performed per chamber per revolution to provide high torque. The average firings per revolution and fuel and air introduction may be controlled to provide various frequencies and patterns of combustion chamber activity and operating pressures to optimize performance and economy.

### TECHNICAL FIELD

The technical field of the inventions are rotary engines and associated systems and methods of operation.

### BACKGROUND OF THE INVENTION

The internal combustion engine has been a predominant source of power for more than a century. It has been used in many different applications and has been developed in various configurations. The history of the internal combustion engine has been one of continuing efforts to improve the performance, efficiency, power density and reliability of this technology. The internal combustion engine has been used in hundreds of millions or even billions of different units and thus represents an area of longstanding development and extremely large amounts of time and money invested in expensive programs to provide relatively small incremental improvements in the technology over more than a century of development.

One of many areas of use for the internal combustion engine has been in transportation and utility vehicles. Trucks and automobiles alone represent great amounts of emissions from internal combustion engines. These emissions have been recognized as problematic in a number of different ways including odor, chemical composition of the atmosphere, and as a major source of carbon dioxide. Carbon dioxide combustion emission is currently getting a great deal of attention in both the popular and scientific press because of studies indicating it is a causative agent in the apparent global temperature change.

The internal combustion engine has also been a major source of nitrous oxides which are also considered deleterious to atmospheric composition. Production of nitrous oxides have in some studies been linked with the temperatures generated in the combustion chambers of internal combustion engines.

Although there is a great deal of research being done on non-carbon containing fuels, the reality of the current situation is that hydrocarbon fuels are the major type of fuels used in internal combustion engines and that this is very likely to remain the case for decades. Still further, the carbon present in most fuels used in internal combustion engines, generate particles of fine size which contain some carbon. These particles can remain suspended in the air and add to particulate content of the atmosphere. A high particulate content is also considered to be deleterious and arises from engines and many other sources. Despite these other sources, the particulate emissions from internal combustion engines remains significant in the amount of particulates suspended in the air.

Thus, there has been a long-felt need for improvements in the internal combustion engine to increase efficiency and reduce the fuel consumed and the emissions emitted from this very widely used technology. A great many developments and new approaches have been made over a long period of time in efforts to achieve even small incremental improvements in the art of internal combustion engines.

Some of the many prior approaches have been successful whereas many others have resulted in failed engine technologies with which is associated a tremendous amount of wasted capital in trying to make the various engines workable or accepted by the consuming groups utilizing internal combustion engines.

The failures of different types of internal combustion engines are numerous and some are based on one or more problems. Some problems that have led to failed internal combustion technology have been associated with the amount of emissions emitted per useable amount of energy produced. Others have simply been mechanically not as reliable as alternatives already available. Still others have not produced the type of power needed for use in their intended applications. Furthermore, others have just simply not worked.

Due to the extremely large number of internal combustion engines being used, even very small gains in efficiency, power, and emissions have a large effect on equipment costs, fuel consumption, air quality and costs of operation. Thus, it can be easily appreciated the complexity, difficulty, and tremendous costs which have been demonstrated over a long period of time to optimize this important technology. Although a great deal of development has occurred, there is still a tremendous need for such machines which are still more improved, while also complying with this network of considerations, some or all of which may come into play in determining whether a new engine technology is successfully accepted. Billions of dollars are spent each year in the search for improved or new configurations for internal combustion engines due to their importance in human society all over the globe. Failure in even just a single aspect from the myriad of constructional, operational, or control aspects or considerations may cause a new engine or improvement to not be commercially accepted.

The largest numbers of internal combustion engines are reciprocating piston engines. Reciprocating piston engines have demonstrated a high degree of reliability, performance and efficiency in the struggle to produce usable power with an internal combustion engine as the prime mover. These engines have been used in a wide variety of sizes and applications, such as from model airplane engines having fractions of a cubic inch displacement up to huge thirty-two cylinder engines used in some countries to generate electrical power or to power natural gas or other gas transmission compressors requiring great amounts of power. Nearly every type of transportation device employs reciprocating engines, including motor vehicles, locomotives, aircraft and water vessels. This further demonstrates the extremely high level of effort and creativity which has been used in the technology of internal combustion engines. Thousands or even possibly millions of engineers and scientists have focused on these developments yet there is still the potential of economic gain to be produced through improved designs and operation.

Another area of internal combustion engine development has been rotary engines. In rotary engines the more typical reciprocating piston and attached piston rod are usually totally eliminated. However, for various reasons the large amount of effort devoted to developing rotary engines has only led to very limited adoption of this technology. It might take a book to discuss all the various reasons why prior rotary engines have not been accepted for widespread use. Whatever the particular reasons for failure or unsuitability in any particular engine or alleged improvement, these failures have not been for lack of effort and investment.

The long period of time over which rotary engines have been worked upon is nearly as long as the period internal combustion engines have been operational. Approach after approach have been used on rotary engines in an effort to achieve the type of performance, efficiency, power density, reliability and other factors to bring them into a position of widespread acceptance, yet they are far behind in preference to the established reciprocating piston engine. Thus, there has been and continues to be a long-felt need for internal combustion engines which provide improved properties yet demonstrate the balance of characteristics which allow for actual commercial acceptance. This has been even more challenging with regard to rotary engines than for reciprocating piston engines. The failures are so numerous in the field of rotary engine technology that it demonstrates a pattern of extreme difficulty in developing a rotary engine design with operational characteristics which provide the combination of numerous structural and operational attributes which may cause it to be favored over the predominant reciprocating piston engines. Thus, it is clear that the challenges in developing improvements in rotary engines are even more difficult and less obvious than in piston engines.

Some or all of the problems explained above and other problems may be helped or solved by the inventions shown and described herein. Such inventions may also be used to address other problems not set out above or which are only understood or appreciated at a later time. The future may also bring to light currently unknown or unrecognized benefits which may be appreciated or more fully appreciated in the future associated with the novel inventions shown and described herein.

### BRIEF DESCRIPTION OF THE DRAWINGS

Preferred forms, configurations, embodiments and/or diagrams relating to and helping to describe preferred aspects and versions of the inventions are explained and characterized herein, often with reference to the accompanying drawings. The drawings and all features shown therein also serve as part of the disclosure of the inventions of the current document, whether described in text or merely by graphical disclosure alone. Such drawings are briefly described below.

FIG. 1 is a side view of a preferred two combustion chamber rotary engine according to the inventions.

FIG. 2 is a front view of the engine of FIG. 1.

FIG. 3 is a rear view of the engine of FIG. 1.

FIG. 4 is a front view in isolation of the rotor core used in the engine of FIG. 1.

FIG. 5 is a rear view in isolation of the rotor core used in the engine of FIG. 1.

FIG. 6 is a bottom view of the rotor core of FIG. 5.

FIG. 7 is a top view of the rotor core of FIG. 5.

FIG. 8 is a side view of a second embodiment of rotary engine according to the inventions taught herein. This embodiment has three combustion chambers.

FIG. 9 is a front view of the rotary engine shown in FIG. 8.

FIG. 10 is a front view of a rotor core and drive shaft for the engine of FIG. 8.

FIG. 11 is a side view of a third embodiment rotary engine according to the inventions taught herein having four combustion chambers.

FIG. 12 is a front view of the embodiment of FIG. 11.

FIG. 12A is a perspective view from an oblique rear viewpoint of portions of the rotating assembly for the embodiment of FIG. 12.

FIG. 12B is a perspective view from an oblique rear viewpoint of substantially all of the rotating assembly for the embodiment of FIG. 12.

FIG. 12C is perspective view from an oblique front viewpoint of a portion of the rotating assembly for the embodiment of FIG. 12.

FIG. 12D is a perspective view from an oblique front viewpoint of substantially all of the rotating assembly for the embodiment of FIG. 12.

FIG. 13 is a front view in isolation of the rotor core and drive shaft used in the engine of FIG. 11.

FIG. 14 is a side view of a fourth embodiment rotary engine according to the inventions according hereto having six combustion chambers.

FIG. 15 is a front view of the embodiment of FIG. 14.

FIG. 16 is a front view of the rotor core and drive shaft in isolation for the embodiment of FIG. 14.

FIG. 17 is a front view of another embodiment of rotary engine according hereto having eight combustion chambers.

FIG. 18 is a front view of the rotor core and drive shaft in isolation for the embodiment of FIG. 17.

FIG. 19 is an exploded assembly view of the embodiment of FIG. 11 and is exemplary of many components used in other embodiments shown herein and otherwise according to the inventions described in this document.

FIG. 20 is a view similar to FIG. 11 showing the plane of section line 21-21 as used for the sectional view of FIG. 21.

FIG. 21 is a sectional view taken along line 21-21 of FIG. 20.

FIG. 22 is an enlarged sectional view showing an upper portion of the sectional view of FIG. 21 in greater detail.

FIG. 23 is a sectional view similar to FIG. 21 with the rotor moved to a different angular position associated with having displaced exhaust gases through the exit port from the combustion chamber.

FIG. 24 is another sectional view similar to FIGS. 21 and 23 with the rotor in a third angular position associated with the sealing rockers positioned adjacent to housing seals which are positioned at joinder positions of the housing sections.

FIG. 25 is a front view of a rotor core and drive shaft in isolation made for using sliding vane rotor seals.

FIG. 26 is a sectional view similar to that taken along line 21-21 of FIG. 20 for the sliding vane embodiment shown in FIG. 25. The rotor is in an angular position wherein exhaust gases have been emitted from the engine.

FIG. 27 is a sectional view similar to FIG. 26 with the rotor in a different angular position wherein the rotor seals are adjacent the housing seals.

FIG. 28 is a sectional view similar to FIGS. 26 and 27 with the rotor seals positioned in anticipation for ignition within a relatively smaller confined region of the combustion chamber.

FIG. 29 is a perspective view showing an engine assembly having four combustion chambers according to the inventions.

FIG. 30 is a front view of the engine assembly of FIG. 29.

FIG. 31 is a rear view of the engine assembly of FIGS. 29 and 30.

FIG. 32 is a right side view of the engine assembly of FIGS. 29-31.

FIG. 33 is a bottom view of the engine assembly of FIGS. 29-32.

FIG. 34 is a block diagram showing components used in some preferred engine systems according to the inventions.

FIG. 35 is a further diagram showing additional control and sensor features and components used in some preferred engine systems according to the inventions.

FIG. 36 is a sectional view of the four chamber engine used in describing operational considerations.

### DETAILED DESCRIPTION OF THE PREFERRED EMBODIMENTS

### Table of Subsections

Introductory Notes
General Summary of Different Configurations and Embodiments
Reference Numerals
Basic Common Features and Aspects
Four Combustion Chamber Model
Flywheel Casing and Flywheel
Drive Shaft Assembly Generally 212
Engine System Sheaves or Pulleys
Engine Stator Housing
Housing Joints and Seals
Housing Face Pieces
Combustion Recesses On Interior of Peripheral Housing Core Pieces
Rotor Assembly Core
Rotor Peripheral Channel and Rotor Seals
Rotor Core for Rotor Rocker Seals
Rotor Core for Rotor Vane Seals
Rotor Face Piece Seals
Fuel Injectors
Combustion Air Injectors
Mixing of Combustion Materials
Combustion Aids
Timing Control Assembly
Three Chamber Version
Six Chamber Version
Air Pressures
Eight Chamber Version
Additional Versions
Four Chamber Radial Vane Seal Version
Four Chamber Rocker Seal Version
Alternative Numbers of Combustion Chambers
Operation of Apparatus in Conjunction with Peripheral Devices
Modes of Operation Where All Chambers Fire Together
Modes of Operation Where Less Than All Chambers Fire Together
Modes of Operation Where Chambers Fire Alone
More About Methods Performed
Methods Concerning Manner of Use and Utility of the Inventions
More about Preferred Manners of Making
Interpretation Notes

### Introductory Notes

The readers of this document should understand that the embodiments described herein may rely on terminology used in any section of this document and other terms readily apparent from the drawings and the language common therefor as may be known in a particular art and such as known or indicated and provided by dictionaries. Dictionaries were used in the preparation of this document. Widely known and used in the preparation hereof are Webster's Third New International Dictionary (© 1993), The Oxford English Dictionary (Second Edition, ©1989), and The New Century Dictionary (©2001-2005), all of which are hereby incorporated by reference for interpretation of terms used herein and for application and use of words defined in such references to more adequately or aptly describe various features, aspects and concepts shown or otherwise described herein using more appropriate words having meanings applicable to such features, aspects and concepts.

This document is premised upon using one or more terms with one embodiment that may also apply to other embodiments for similar structures, functions, features and aspects of the inventions. Wording used in the claims is also descriptive of the inventions, and the text of both claims and abstract are incorporated by reference into the description entirely in the form as originally filed. Terminology used with one, some or all embodiments may be used for describing and defining the technology and exclusive rights associated herewith.

The readers of this document should further understand that the embodiments described herein may rely on terminology and features used in any section or embodiment shown in this document and other terms readily apparent from the drawings and language common or proper therefor. This document is premised upon using one or more terms or features shown in one embodiment that may also apply to or be combined with other embodiments for similar structures, functions, features and aspects of the inventions and provide additional embodiments of the inventions.

### General Summary of Different Configurations and Embodiments

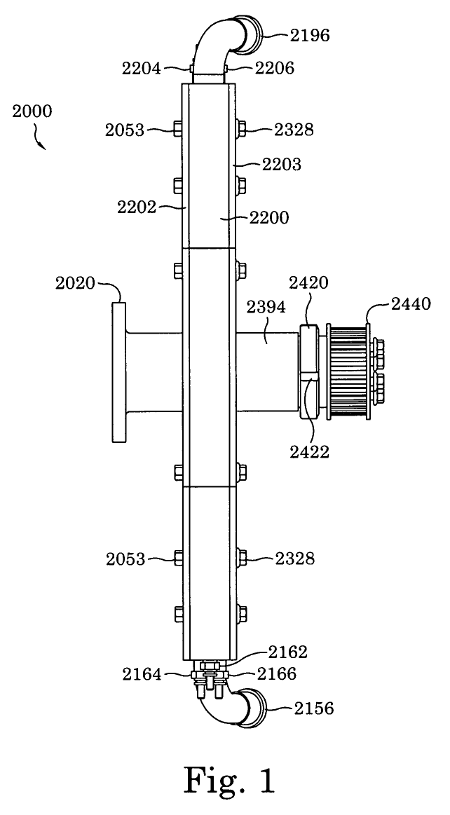

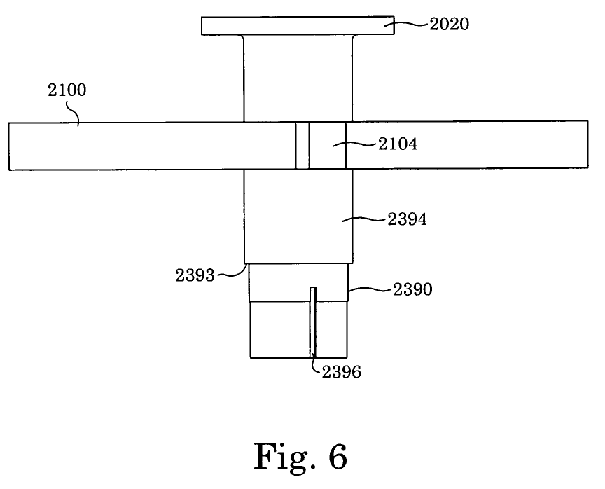

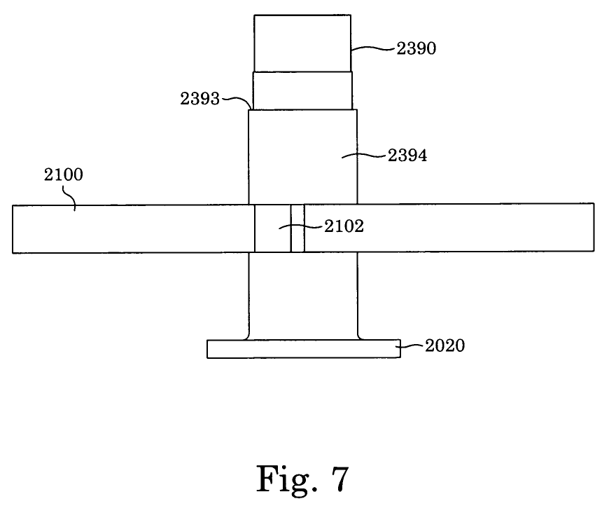

FIGS. 1-7 show views of one preferred embodiment of rotary engine 2000 constructed in accordance with at least some of the novel combinations of features, steps and aspects of the inventions shown and/or described herein. The embodiment depicted in FIG. 1 has two combustion chambers which will be more fully described below.

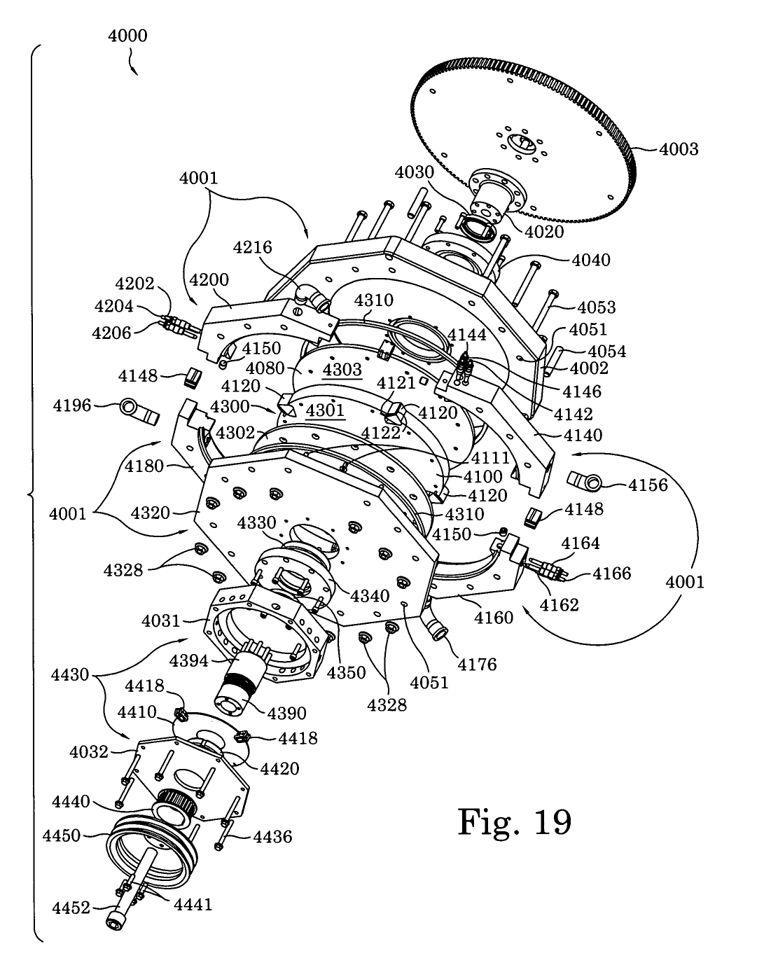

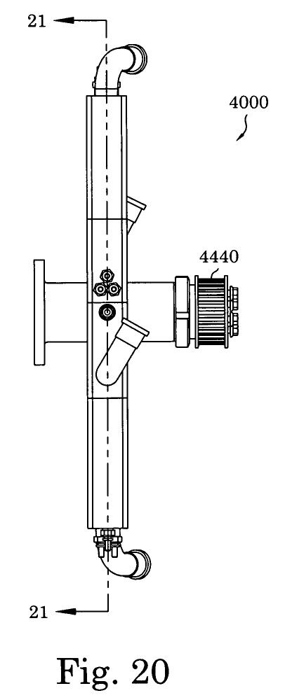

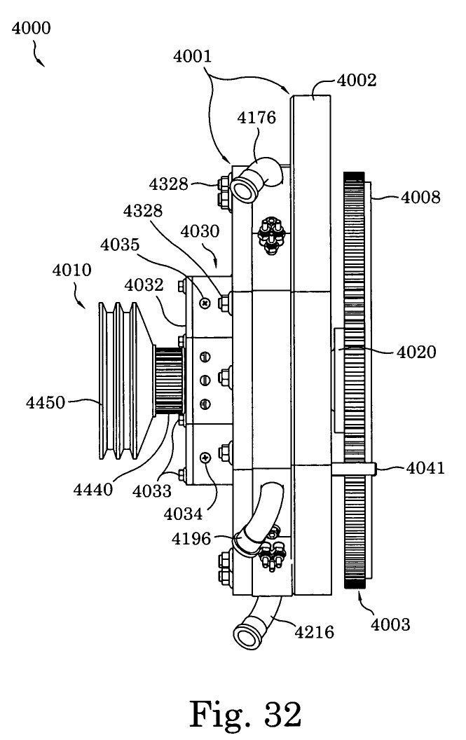

The general configuration of the engine 2000 is also indicated by similarity to the four combustion chamber engine 4000 shown in exploded view in FIG. 19 and in FIGS. 20-35. Additional detail will be provided below for engine 2000 to the extent needed to point out differences.

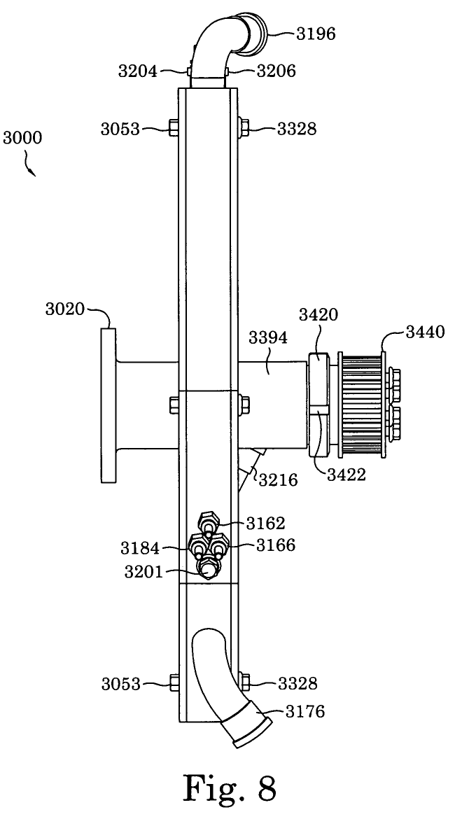

FIGS. 8-10 show views of another preferred embodiment of rotary engine 3000 which has three combustion chambers and associated parts also indicated by description and analogous views of the four combustion chamber versions illustrated in FIGS. 19-36. Further details of engine 3000 will be covered below in greater detail.

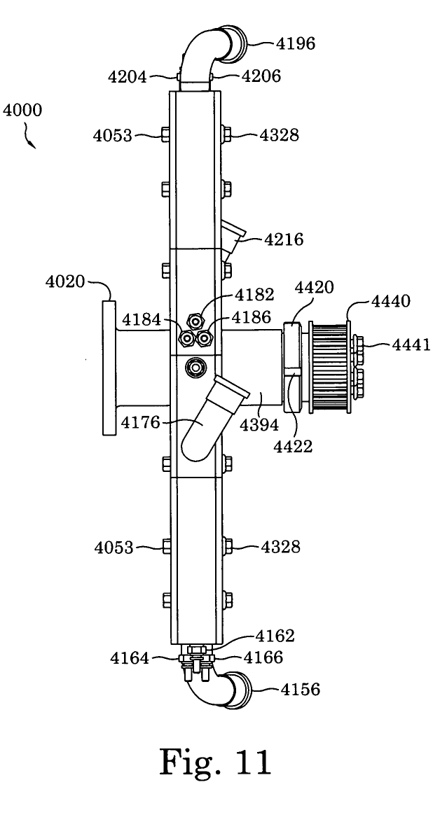

FIGS. 11-13 show another embodiment engine 4000 according hereto. Additionally FIGS. 19-36 further show features and aspects of engines having four combustion chambers and provide greater details and variations thereof. The four combustion chamber versions will be described in the greatest detail with similar features being applicable to other engines having different numbers of combustion chambers and other variations in construction.

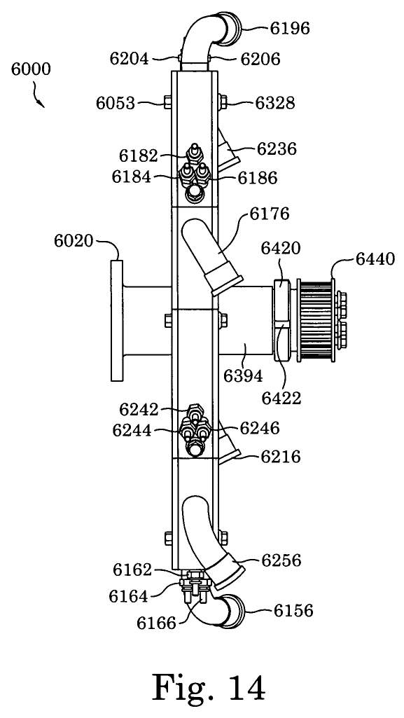

FIGS. 14-16 also show a rotary engine 6000 in accordance herewith having six combustion chambers. Again the various details of the four combustion chamber engines will be applicable to rotary engine 6000.

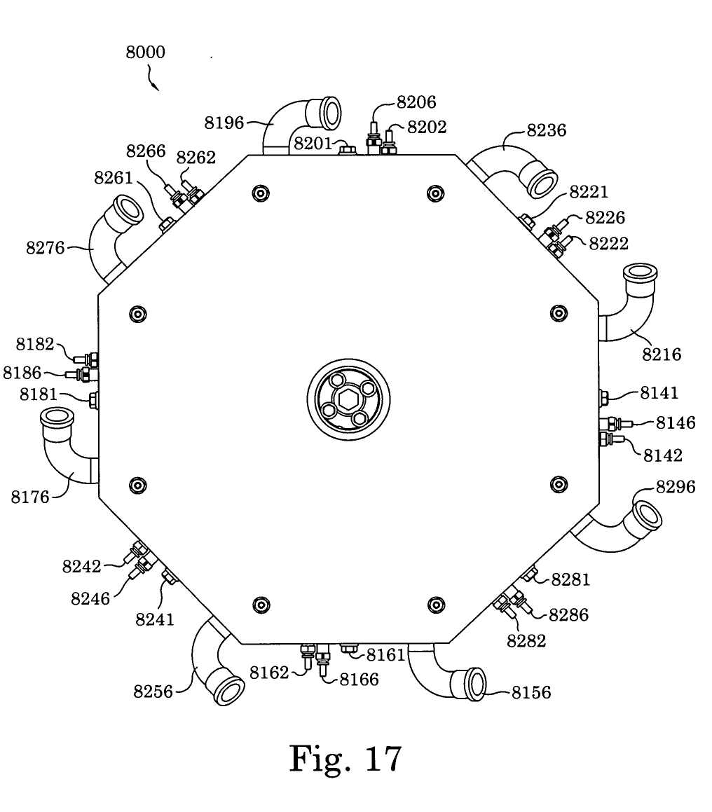

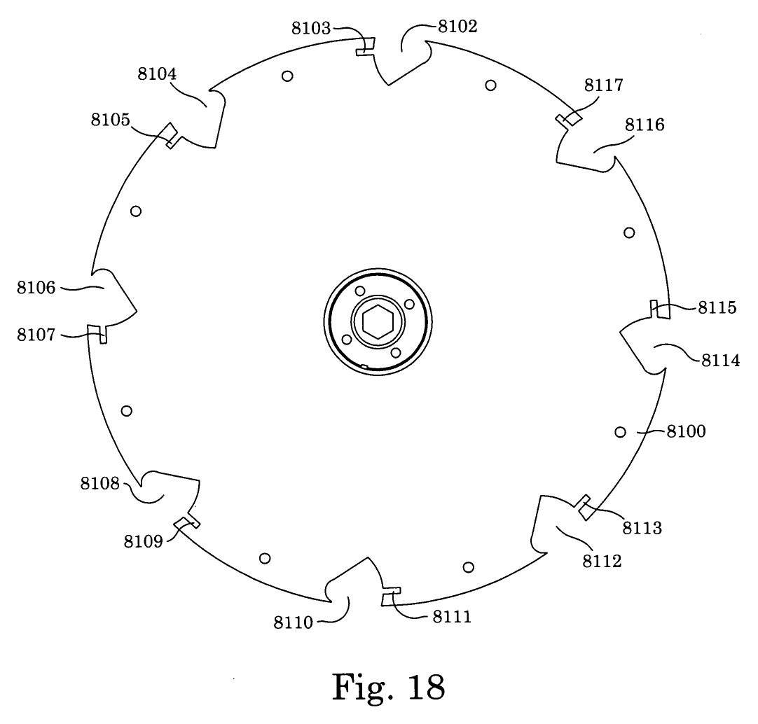

FIGS. 17-18 show portions of another rotary engine 8000 having eight combustion chambers. The various features of the four combustion chamber engines which are presented in greater detail are also indicative of the constructions which may be used in the eight combustion chamber engine 8000.

### REFERENCE NUMERALS

It should be appreciated that each of the different exemplary embodiments shown and discussed herein include many components that are identical or substantially similar to components of other exemplary embodiments. To simplify understanding of the drawings, many components have the same numbers in the different embodiments for the same or similar components. This may not apply to all components, and at some places the numbers for similar parts may be different to more properly aid in the description of these embodiments. However, in general, the similar parts are numbered similarly with respect to each of the different embodiments except for changes in the thousands column of the reference numeral.

### Basic Common Features and Aspects

To further facilitate understanding of the more specific description of each of the exemplary embodiments, an explanation of basic features and aspects common to all embodiments is first provided. Exemplary embodiments 2000, 3000, 4000, 6000 and 8000 will then be described with added specificity to the extent needed to supplement the common features described herein. The explanation of the basic common features and aspects is provided with respect to specific drawing figures associated with specific embodiments. However, it is to be understood that the explanation of the basic common features and aspects can be applied to several embodiments. It is to be further understood that specific configurations of the common features and aspects are exemplary only, and that such common features and aspects can have any of a number of alternative specific configurations within the intended scope of the inventions.

With reference to FIGS. 19, 21 and 22, common features can include a rotor assembly 4300, and a housing assembly 4001. The rotor assembly 4300 can be substantially enclosed within the housing assembly 4001. The rotor assembly 4300 can be rotatable relative to the housing assembly 4001. The rotor assembly 4300 can be rotatable about a fixed center of rotation. The rotor assembly 4300 can be configured to rotate substantially continuously in a given direction in accordance with various exemplary embodiments.

During operation of an exemplary embodiment, the rotor assembly does not change direction of movement. In accordance with the various exemplary embodiments depicted in the accompanying figures, the rotor assembly 4300 is configured to rotate, during operation, in a clockwise direction when viewed from the front. However, it is to be understood that in accordance with alternative embodiments not specifically depicted or described herein, an apparatus can be configured such that the rotor rotates in a counterclockwise direction.

Common features also include a housing seal 4148 and a rotor seal 4120, which are described in detail herein below. Generally, the housing seal 4148 can be supported by or otherwise connected to the housing assembly 4001. In this manner the housing seal 4148 can be generally configured to seal against the rotor assembly 4300. Similarly, the rotor seal 4120 can be supported by or otherwise connected to the rotor assembly 4300. In this manner, the rotor seal 4120 can be generally configured to seal against the housing assembly 4001. More specifically, the housing seal 4148 can remain substantially stationary relative to the housing 4001. The rotor seal 4120 can rotate along with the rotor assembly 4300. The rotor seal 4120 and/or the housing seal 4148 are configured to allow the rotor seal to pass the housing seal during rotation of the rotor assembly 4300. This can be accomplished by configuring one or more of the rotor seal 4120 and/or the housing seal 4148 to be retractable. Specific manners of configuring the rotor seal 4120 to be retractable are described below with respect to the exemplary embodiments of the inventions.

Further common features include a combustion chamber 4291. The combustion chamber 4291 can be defined between the rotor assembly 4300, the housing assembly 4001, the rotor seal 4120 and the housing seal 4148. Other specific components described below with respect to various exemplary embodiments can define at least a portion of the combustion chamber 4291.

The combustion chamber 4291 expandable in volume as the rotor rotates from a initiation position where the rotor seal is positioned upon a stator seal. More specifically, the working volume of the combustion chamber 4291 expands as the rotor seal moves in a substantially circumferential direction with the rotation of the rotor 4300. Expansion of the combustion chamber 4291 can occur as a function of rotation of the rotor 4300 relative to the housing assembly 4001. This expansion can occur with firing of the combustion chamber or even though that particular combustion chamber is not fired. The operational supply of air and fuel will vary dependent upon a number of operational parameters as will be explained further herein.

The combustion chamber 4291 can also be viewed as separated between the expansion volume area and a contractible exhausting volume area. This separation is achieved by the rotor seals. More specifically, the combustion chamber 4291 can be described as expandable during a combustion event or cycle. The combustion chambers are simultaneously contracting on the leading edge side of the rotor seals. If the prior action in that combustion chamber has been a firing action, then the contracting portion is performing to help exhaust combustion gases out through the exhaust ports. The rotor seals serve to provide contraction and any expulsion of exhaust gases or other gases until the rotor seals pass over the exhaust port. The rotor seals then continue to define a contracting volume until passage over the housing seals 4148.

A combustion event and an exhaust event can occur in the combustion chamber 4291 simultaneously as the combustion chamber is divided into two parts by the sealing of the rotor seals against the inside of the combustion chambers. More specifically, a combustion event can occur in the combustion chamber 4291 after the rotor seals pass the housing seal 4148 and input ports so that they lie behind a trailing side of the rotor seal 4120.

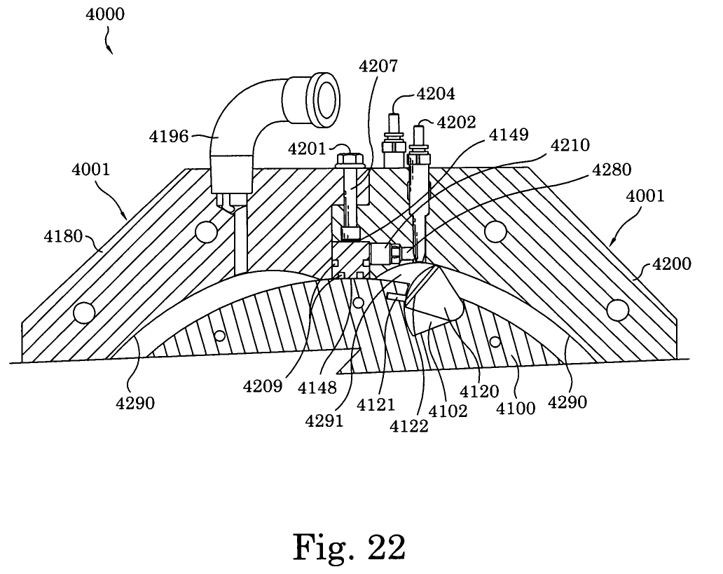

Even more preferably, the combustion events can occur in a two-stage process of pre-combustion in a pre-combustion chamber 4280 (FIG. 22) which may begin approximately as the rotor seals pass over the port between pre-combustion chamber 4280 and combustion chamber 4291 and then expand into the combustion chamber 4291 soon thereafter as the igniting combustion gases or combustion materials expand and cause increasing pressure to drive the rotor in a rotational action.

An exhaust event occurs in the combustion chamber along the contracting side of the rotor seal 4120. The exhausting step usually occurs in the combustion chamber as the next subsequent rotor seal passes the charging area along the leading edge of the next rotor seal as explained above. The leading side of the rotor seal 4120 is the side facing toward the direction of rotation of the rotor 4300. Conversely, the trailing side of the rotor seal 4120 is the side facing away from the direction of rotation of the rotor 4300.

In accordance with various exemplary embodiments, at least a portion of a given combustion chamber 4291 expands while another portion of the given combustion chamber substantially simultaneously contracts. This occurs when the frequency of combustion is occurring with each passage of the rotor seals through a given combustion chamber. Where the frequency of combustion is different then exhausting can occur immediately after or potentially in contraction of some subsequent stage as may be possible by injection of air or non-injection of air, or due to control on the exhaust ports using valving (not shown). In general it is preferably to exhaust the combustion gases using the immediately following rotor seal. Injection air may or may not be introduced to help clear a particular combustion chamber depending upon the frequency of use of a particular chamber. For example, when a chamber is fired and then exhausted, the next rotor seal defines what might be a initial combustion chamber but fuel can be prevented from entering and air injected to better clear the combustion chamber. This may or may not prove to achieve greater economy or better operation depending upon any particular frequency of firing and the operating conditions experienced, load required and other operational considerations.

Common features additionally include one or more various means of introducing fuel, air, and/or air/fuel mixture into the combustion chamber 4291. Such means can include, but are not limited to, one or more various types of valves, injectors, manifolds, ports, compressors, blowers, and the like. Various specific means of introducing fuel, air, and/or air/fuel mixture into the combustion chamber 4291 are described below with respect to the exemplary embodiments depicted in the drawing figures.

Apparatus in accordance with various embodiments of the present disclosure can be configured to employ any of a number of various types of fuel. For example, various embodiments of apparatus in accordance with the present disclosure can be respectively configured to use fuels including, but not limited to diesel fuel, bio-diesel, vegetable oil, gasoline, liquified natural gas, liquified petroleum gas, propane, butane and other suitable fuels the extent of which may not be currently known or which may be hereafter developed and found appropriate for use in some or all of the embodiments of the inventions described herein. Although fluid fuels, particularly diesel fuel, are most likely to be employed with the inventions, other forms of fuel are within the intended scope of the inventions.

Means of exhausting combustion gases and/or other combustion residue from the combustion chamber 4290 are also included among the common features. Such exhausting means can include, but are not limited to various types of valves, ports, manifolds and the like. In accordance with at least one alternative embodiment of the disclosure not specifically depicted herein, a scavenging air pump can be employed to facilitate removal of combustion residue from the combustion chamber. Such a scavenging air pump can be substantially the same as an intake blower or the like and/or can be configured to force intake air through the combustion chamber and at least partially out of the exhaust port to substantially scavenge the combustion chamber of exhaust. At least one specific means of exhausting the combustion chamber 4290 is described below with respect to the exemplary embodiments.

A combustion event, or more simply combustion, can occur within the combustion chamber 4290 when fuel and/or air/fuel mixture or some type of oxidizer or other reactive substance and fuel is ignited within the combustion chambers 4290, or more preferably first within the pre-combustion chambers 4280 and then into the combustion chambers 4290. This can be done either in a single ignition or by intermittently introducing the combustion materials into the pre-combustion chambers to produce multiple or phased ignition. This may also be done so as to occur directly in the combustion chambers. In some preferred versions it is done intermittently so that intermittent ignition events start in the pre-combustion chambers progressing into the combustion chambers in a sequential or pulsed manner to supplement combustion as the volume of the combustion chamber increases with rotation of the rotor.

It will be appreciated that high pressure gases resulting from combustion of fuel and air or other combustion materials within the combustion chamber 4291 as described more specifically herein can cause the rotor assembly 4300 to be rotated relative to the housing 4001 in a clockwise direction (when viewed from the front side) in accordance with the exemplary embodiments depicted in the accompanying figures. Alternatively, the engine can be constructed in a reverse orientation.

An exemplary combustion event or cycle can result in generation of mechanical power in the form of forceful rotation of the rotor 4300 relative to the housing 4001. Exhaust gases and other combustion residue such as soot or the like can be substantially swept from the combustion chamber 4291 following the combustion event. More specifically, following a combustion event, exhaust gases can be substantially trapped between the leading side of the rotor seal and the housing seal. Thus, with rotation of the rotor seal 4120 along with the rotor 4300, a substantial portion of any exhaust gasses resulting from combustion can be pushed or swept out of the combustion chamber 4291.

Specific exemplary embodiments are now discussed below with reference to respective figures of the accompanying drawings.

### Four Combustion Chamber Model

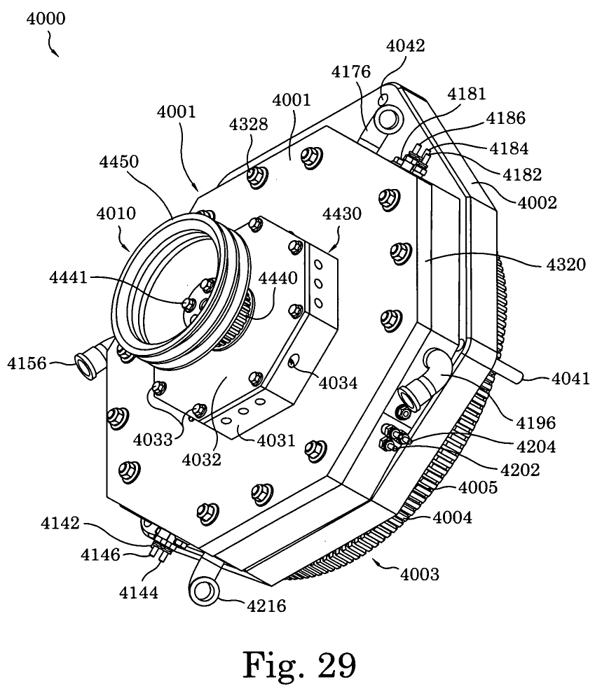

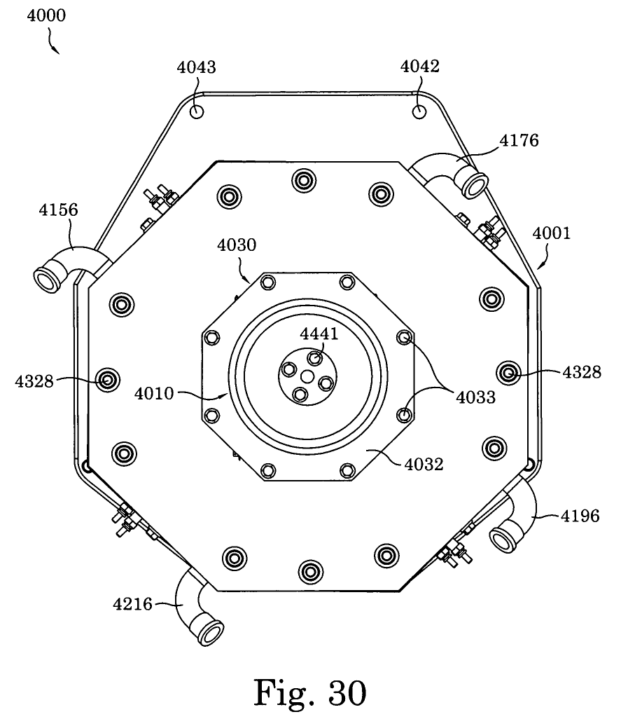

FIG. 29 shows in perspective a four combustion chamber engine system embodiment which is similar in many respects to other embodiments described and depicted herein. FIG. 29 can give the viewer a general sense of how exemplary assembled engines and engine systems appear in perspective. FIG. 19 shows this embodiment in exploded perspective. FIGS. 30-33 are orthographic views of the embodiment shown in perspective in FIG. 29. The reader is directed to these views to help in gaining a general understanding of the novel engines and engine assemblies discussed herein in fully or nearly fully assembled condition.

The engines themselves are shown alone without additional system components in many views. In other views, engine systems show the novel engines with added parts for engines applied to one widespread use of this technology, in particular, as used for powering vehicles. It will be appreciated that the engine or engine assembly may be constructed with different optional parts or variations which may adapt the engine differently for the needs of the wide variety of alternative uses for which prime mover engines powered by combustible fuels are used or for which they are hereafter found to be desirable for use. The engine alone or components thereof may be shown in some views without certain parts preferred for vehicular use.

Referring to FIG. 29 an engine assembly 4000 is adapted for vehicular use. Engine assembly 4000 includes a stator assembly or stationary assembly housing 4001 which may in some instances be more easily referred to merely as the stator. The housing 4001 can include at least a front housing portion 4320 and a rear housing portion 4002. The housing 4001 can include additional housing portions as is described in greater detail herein.

Rotatably mounted within the housing 4001 is the rotor assembly, which is described in detail with respect to other drawing figures as specifically noted. Mounted on the front of the engine 4000 is a cover assembly 4430. The cover assembly 4430 can include a housing 4031 and a cover 4032. The cover 4032 can connect to the housing 4031 such as by fastening as depicted. Connected to the rear of the engine 4000, or forming a part thereof, is a rear mounting assembly 4002.

### Flywheel Casing and Flywheel

FIG. 29 shows that part 4002, in this configuration, can serve as a flywheel casing 4002. The flywheel casing 4002 can include one or more various attachment and/or alignment features to facilitate attachment to and/or alignment with various other devices including but not limited to a transmission (not shown) and the like. For example, such attachment and/or alignment features can be in the form of one or more bosses or alignment pins 4041, 4044. The flywheel casing 4002 can include other attachment features 4042, 4043, that can be in the form of holes or apertures, as depicted in the exemplary engine 4000. Such holes or apertures can be employed in conjunction with fasteners such as bolts (not shown) or the like to mount and/or connect the engine assembly 4000 to an associated device such as a transmission, frame or chassis (not shown) or the like.

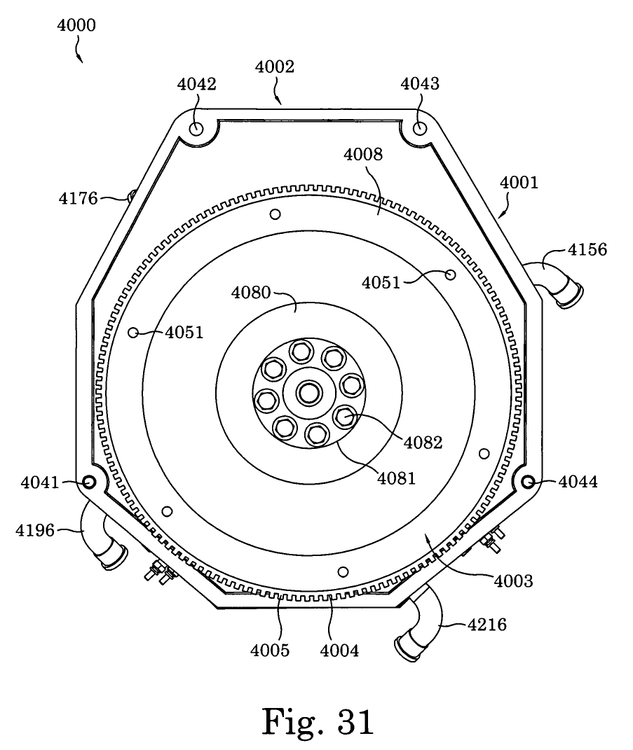

Within flywheel casing 4002 is a flywheel 4003. The flywheel 4003 is depicted in FIGS. 31, 32 and 33, which are a rear view, a side view and a bottom view, respectively, of engine apparatus 4000. The flywheel 4003 can advantageously include intermittent notches 4004 or projections 4005 extending about the periphery of the flywheel. These notches and teeth may be in the various forms of different shaped gear teeth or cogs or the equivalent features to allow or provide flywheel engagement with other components. Such other components can include, but are not limited to, engine starter motors and other motor-driven components. Such other motor-driven components can include, but are not limited to, engine support components and/or components associated with one or more various vehicle operating systems.

In other embodiments the flywheel 4003, if provided, may not be adapted for peripheral engagement, but some other type of engagement. Such alternative engagements may be against any part of the flywheel using various forms of mechanical engagement mechanisms. For example, the flywheel 4003 can be provided with teeth. An alternative form of the flywheel 4003 may have a smooth or other flywheel periphery or other surface which can be used to apply force thereto or derive power therefrom. In some embodiments, the engine or assembly can be provided without any function other than as a flywheel.

Whereas, in other situations the flywheel 4003 may be altogether unnecessary due to unique construction features of the inventions and the associated designs and configurations that can result in an engine which is smooth in torque application. Specifically, an engine within the scope of the present disclosure can employ one or more rotor assemblies being configured to have associated features and/or a given quantity of rotatable mass which can substantially serve the purpose of a flywheel. Alternatively, an engine within the scope of the present disclosure may be coupled in a coaxial relationship with a driven piece of equipment or machinery which itself has a rotating assembly which provides adequate torsional inertia or dampening effect on torque and power fluctuations to provide smoother application of torque without substantial angular velocity changes, angular accelerations, and angular jerk which might develop for unknown or known reasons.

Flywheel 4003 not only provides a greater radius of gyration to the entire rotating assembly, but also can be used as mentioned above to drive the engine during startup using an auxiliary or starting motor (not shown), or to extract some or all of the engine torque and power generated during normal operation of the engine in alternative configurations (not illustrated). The flywheel 4003 can serve as a structural connection to other parts of a vehicle, such as downstream portions of a vehicle drive train (not illustrated). An example might be to a drive line transmission casing. The uses of the flywheel need not be limited to such functions which are merely exemplary in many embodiments shown and described herein. Other forms of the inventions may illustrate otherwise.

The flywheel 4003 can define a face 4008. The face 4008 can serve as a friction surface or the like when a conventional type clutch (not shown) is employed with engines within the scope of the present disclosure. The flywheel 4003 can define a recessed mounting area 4081. The recessed mounting area 4081 can serve to keep associated fasteners and the like substantially flush or under flush with respect to the flywheel face 4008. An intermediate area 4080 can be defined on the flywheel 4003. The intermediate area 4080 can be substantially between the recessed area 4081 and the face 4008. One or more flywheel mounting fasteners 4082 can be employed to mount or otherwise attach the flywheel 4003 to another component of the engine 4000 such as an output shaft or the like. The flywheel housing 4002 as shown also serves as part of the engine housing 4001 and more specifically, as shown, provides the back wall of the engine stator, more specifically as the back wall of the housing to in part define and confine an interior compartment discussed below.

### Drive Shaft Assembly Generally

FIG. 19 also shows part 4394 which may be termed a main shaft part. The main shaft part has a threaded section between the larger diameter part at the end of the lead line from reference number 4394 and the section 4390 which is of smaller diameter. The threaded section is adapted to receive in a threaded relationship the part 4420 which retains the timing disk 4410 against a shoulder formed at the interface between the threads and the larger portion of part 4394.

The main shaft part 4394 is also advantageously provided with features which increase the ability to carry and resist torque developed in the shaft. As shown, this is implemented by a group of pins extending rearwardly as shown in FIG. 19. These pins are received in the apertures surrounding the central opening in the part 4020 which also receives the bold 4452 in the central aperture. As illustrated and preferred, there are eight pins that extend from part 4394 into part 4020.

The joinder of parts 4394 and 4020 form the major components of the drive shaft. These two parts are held in secure relationship during operation by the bolt 4452 received into the central aperture of part 4020. Other parts of the drive shaft assembly and more general rotor assembly are described elsewhere herein.

Although the engines illustrated and described herein use multiple part drive shaft assemblies, it is alternatively possible to use a single drive shaft having a single piece. Such can then be fitted with additional components as shown herein or otherwise found desirable.

### Engine System Sheaves or Pulleys

To further gain a general understanding of some preferred versions of the inventions, FIG. 29 also shows accessory drive features 4010 mounted at the first end or, more generally, the front end of the engine assembly. Accessory drive features 4010 can include a toothed sprocket 4440, as shown in FIG. 29. The accessory drive features 4010 can include one or more sheaves or pulleys 4450, which are shown in FIG. 19. The pulleys 4450 can be of a type used to drive flexible belts, such as so-called V-belts. Such V-belt drive sheaves may be used for driving various accessories or components associated with operation of an internal combustion power plant or automotive vehicle systems. For example, such accessories can include automotive electrical generators or alternators, air conditioning systems, cooling fans, hydraulic pumps, thermactors, or other accessories in a manner similar to existing or future vehicles (not shown herein). Although V-belts and associated sheaves are specifically depicted herein, it is to be understood that other types of accessory drive means can be employed within the scope of the inventions. For example, flat or toothed serpentine belts and associated sheaves can alternatively or additionally be employed.

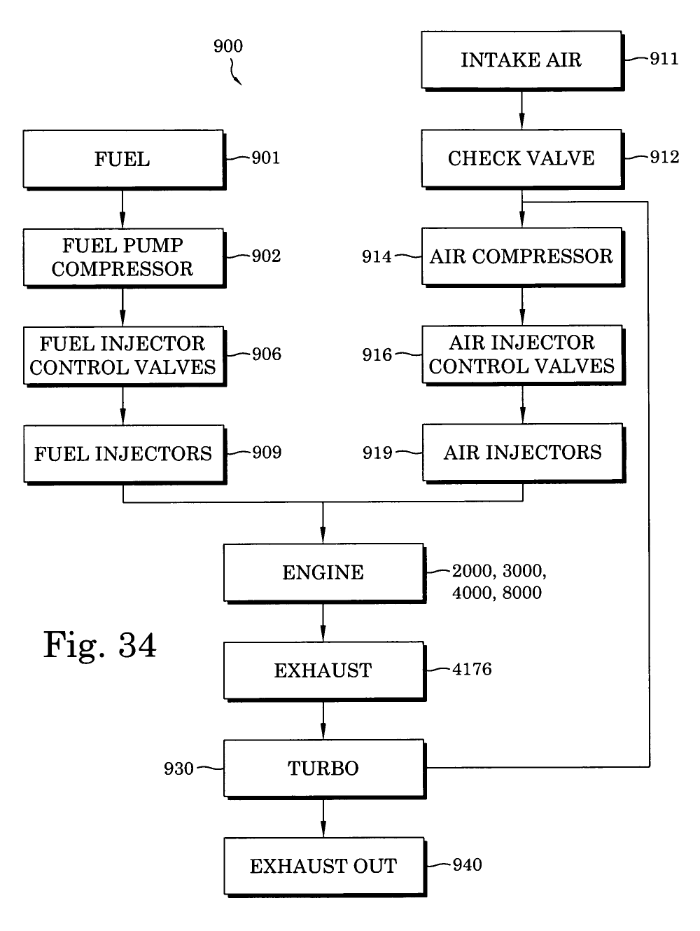

With reference to FIGS. 19 and 29, the toothed wheel or sprocket 4440 (see also FIG. 11) can be connected to the drive shaft and may be used to drive various different singular or multiple accessories, such as a super charger (not shown), if used in some variants, or an air compressor 914 (FIG. 34) which typically require greater amounts of driving torque than other accessories to the engine as might be powered by pulleys 4450.

As FIGS. 11, 19 and 29 show, toothed wheel 4440 is securely fastened to the drive shaft 4394 using fasteners 4441 which may also connect the sheaves 4450 to the drive shaft. A fastener, such as bolt 4452 can be installed as depicted in FIG. 19. As shown, bolt 4452 serves by extending through the main rotor or drive shaft assembly to hold the drive shaft assembly together. The bolt 4452 extends through a central aperture in shaft part 4394 shown in FIG. 19. Threads (not shown) on bolt 4452 are received in part 4020 in the central aperture thereof.

FIG. 29 also shows a timing assembly 4430 having a preferred timing assembly housing 4031 with timing assembly housing cover 4032 advantageously fastened thereto, such as by way of using a plurality of cover fasteners in the form of bolts 4033. FIG. 29 further shows sets of firing feeds, such as air injector assembly 4146, 4186, fuel injector assembly 4144, 4184, and a combustion aid 4182, 4202. In the preferred embodiment, the combustion aid 4182, 4202 can be a glow plug.

FIG. 29 further depicts exhaust conduits or pipes 4156, 4176, 4196, and 4216 which connect with exhaust ports formed in the engine housing assembly 4001. Additional aspects and features of the engine 4000 will now be described in detail before returning to further aspects and features desirably used in a vehicle application.

### Engine Stator Housing

FIG. 29 shows an engine housing assembly 4001 generally. The housing can be made of a single piece or multiple pieces as shown in the drawings. The housing or housing pieces may be cast of suitable materials, such as iron, aluminum or other suitable materials now known or hereafter developed.

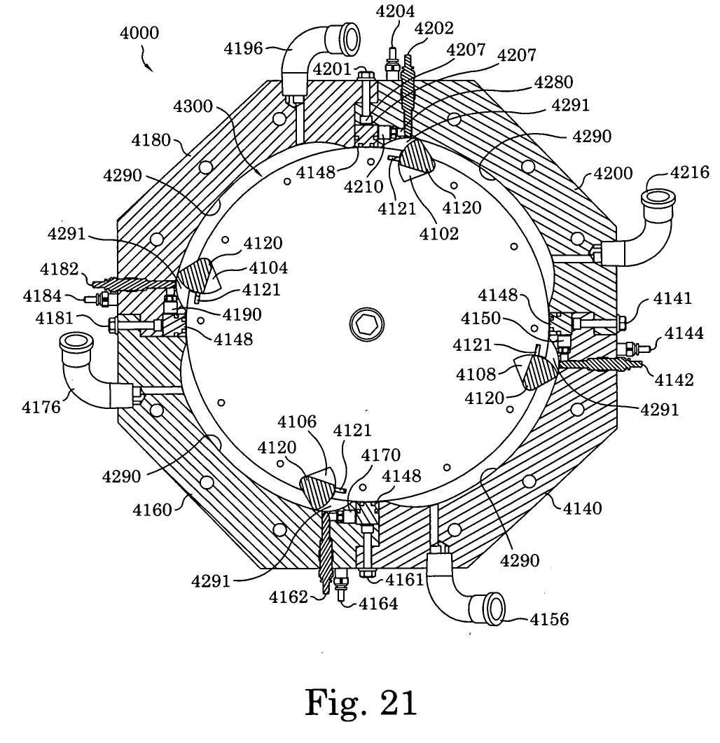

In the illustrated housing of FIG. 29, housing assembly 4001 includes a peripheral assembly made of housing core pieces 4140, 4160, 4180 and 4200 (see FIG. 21). FIG. 21 is a cross-sectional view of the engine 4000, and shows in greater detail a preferred construction for engine 4000 which utilizes the four peripheral parts 4140, 4160, 4180 and 4200. In this engine each peripheral part preferably extends approximately, or more preferably, 90° of arc about the housing. These parts are preferably provided with a special housing joint construction further described below.

In accordance with the exemplary apparatus 4000, each of the peripheral parts 4140, 4160, 4180 and 4200 is connected between two other peripheral parts to form a ring-like structure. In accordance with at least one embodiment of the present disclosure, each peripheral part 4140, 4160, 4180, 4200 is connected end-to-end with another of the parts to form a ring-like structure, which in turn forms at least a portion of the housing assembly 4001. Within the ring-like structure formed by peripheral parts 4140, 4160, 4180 and 4200, the rotor core 4100 can be positioned as is seen from a study of FIGS. 21 and 22.

It is to be understood that the four peripheral parts 4140, 4160, 4180, 4200 are shown as being illustrative of only one possible exemplary embodiment. That is, in accordance with each of a number of various embodiments of the present disclosure, an engine housing assembly can include an associated number of peripheral parts. In accordance with one or more embodiments, the number of peripheral parts of the engine housing can be the same as the number of combustion recesses and/or can be the same as any of the associated combustion chamber components, including but not limited to, stator seals, exhaust ports, fuel injectors, air injectors and the like. However, in at least one conceivable alternative embodiment within the scope of the disclosure, an engine housing assembly can include a number of peripheral parts, such as parts 4140, 4160, 4180, 4200, that is different than the number of combustion chambers in the engine assembly with appropriate internal construction for the rotor involved.

One or more of the stator components can have at least one void adjacent to 4150, 4170, 4190, 4210, as depicted in FIG. 21. The voids filled with space occupying plugs 4150, 4170, 4190, 4210 can serve any of a number of possible purposes, or can serve substantially no purpose other than as a result of one or more various manufacturing processes. For example, the voids that are filled with plugs 4150, 4170, 4190, 4210 can be formed in one or more peripheral parts 4140, 4160, 4180, 4200, respectively, substantially as a result of a machining process performed during the manufacture or fabrication of the parts. As shown, the construction additionally uses the space occupying plugs to minimize the volume of the pre-combustion chambers 4280 (FIG. 21). This facilitates improved performance by allowing the two-stage ignition process wherein there is pre-combustion following by progressive combustion from the pre-combustion chambers to the greater combustion chambers by minimizing the volume which needs to be pressurized by the compressed combustion materials.

### Housing Joints and Seals

FIG. 22 shows in enlarged detail view of the apparatus depicted in FIG. 21. The detail view of FIG. 22 shows the preferred joints between adjacent housing pieces 4180, 4200. In this preferred configuration of a housing joint there is preferably an overlapping step configuration. FIG. 21 shows that such joints can be formed or defined between each pair of adjoining combustion housing sections 4140, 4160, 4180, 4200. Although stepped or overlapping housing section joints are specifically depicted and described with respect to the exemplary embodiments, it is to be understood that other forms or configurations of housing section joints can be employed within the scope of the present disclosure. As depicted in FIG. 21, the housing pieces 4140, 4160, 4180, 4200 can be assembled by way of respective fasteners that can include, for example, screws or bolts 4207 and associated flange nuts 4141, 4161, 4181, 4201. As shown, the housing fasteners are in the form of cylindrical socket headed cap screws which are installed from inside through the lapped joint in the housing segments and are threaded or otherwise taken up tight by the nuts 4201 and underlying washers may be included.

An engine according to the present disclosure can include a plurality of stationary combustion chamber seals 4148. With reference to FIGS. 21 and 22, the exemplary apparatus 4000 includes four such stationary combustion chamber seals 4148. The stationary combustion chamber seal 4148 can be supported by, or otherwise attached to, the housing assembly 4001. In the exemplary embodiment, the stator seal 4148 can be biased against one or more portions of the rotor assembly 4300, such as by way of a respective biasing member 4149 (FIG. 22), which can be in the form of a spring, for example.

With reference to both FIGS. 21 and 22, each stator seal 4148 can be supported by one or more respective combustion housing peripheral sections 4140, 4160, 4180, 4200 in the exemplary apparatus 4000. The combustion housing seal 4148 can be positioned at any of a number of possible locations according to various embodiments within the scope of the present disclosure. In accordance with various exemplary embodiments, the combustion chamber seal 4148 can be positioned substantially between respective adjoining combustion housing pieces 4140, 4160, 4180, 4200. More specifically, each stator seal 4148 can be positioned substantially proximate a respective joint formed between adjacent combustion housing sections 4140, 4160, 4180, 4200. As is depicted with respect to the exemplary apparatus 4000, each combustion chamber seal 4148 can be located within a respective gap or receptacle defined between adjoining combustion housing sections 4140, 4160, 4180, 4200. Such a gap or receptacle can be substantially in the form of a rectilinear notch as depicted.

The combustion housing seals 4148 can be oriented to face and/or to protrude substantially inwardly from the housing assembly 4001. More specifically, the stator seals 4148 can be positioned and/or oriented to face and/or protrude toward the rotor core 4100. Each of the housing seals 4148 is preferably adapted to contact peripheral portions of the rotor assembly 4300. More specifically, each of the housing seals 4148 can be oriented and/or otherwise adapted to contact at least a portion of the rotor assembly 4300, and more particularly with at least portions of the rotor core 4100, for sealing engagement therewith. As is shown with respect to FIG. 22, the housing seals 4148 can be biased toward the rotor assembly 4300 by way of a respective biasing member 4149, which can be in the form of a spring.

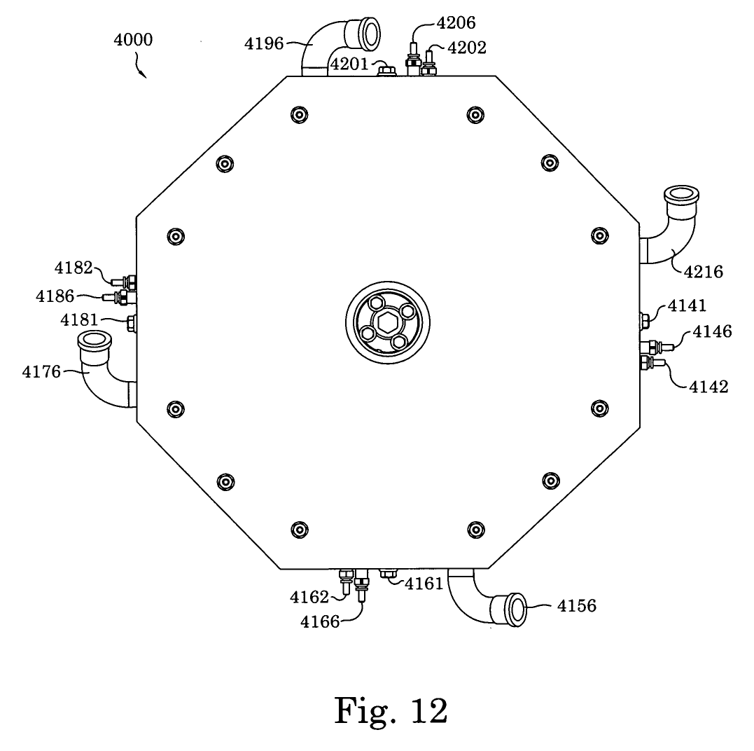

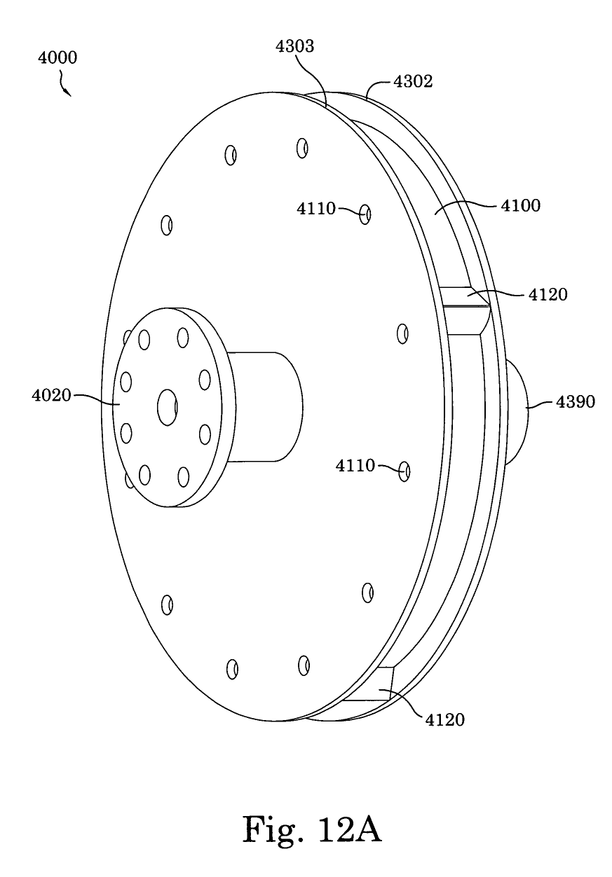

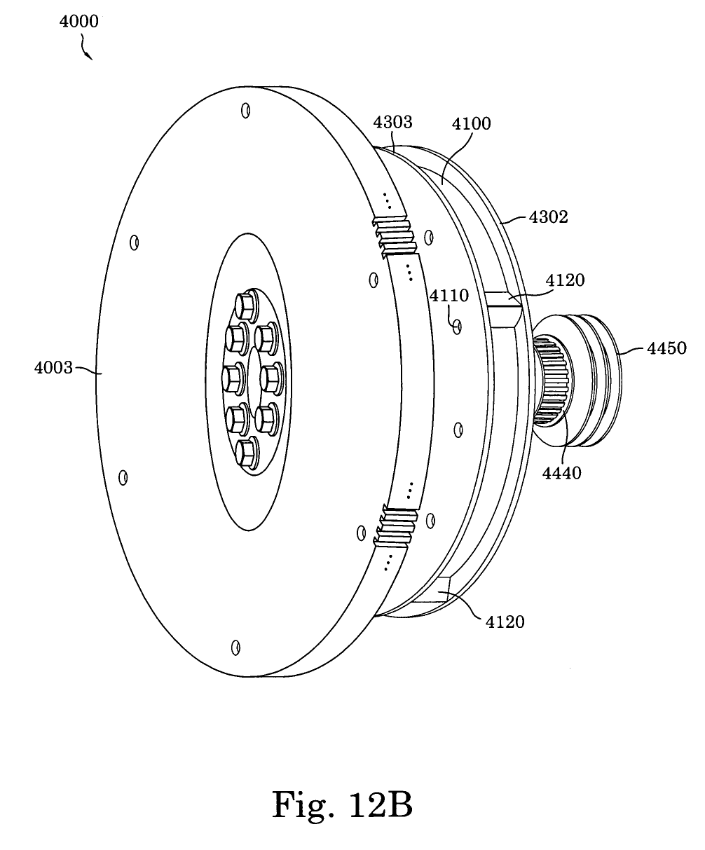

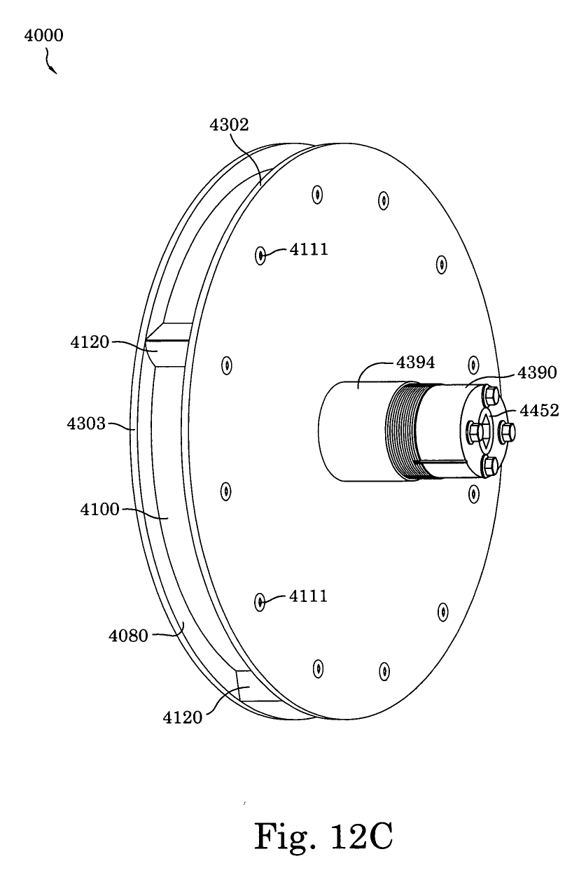

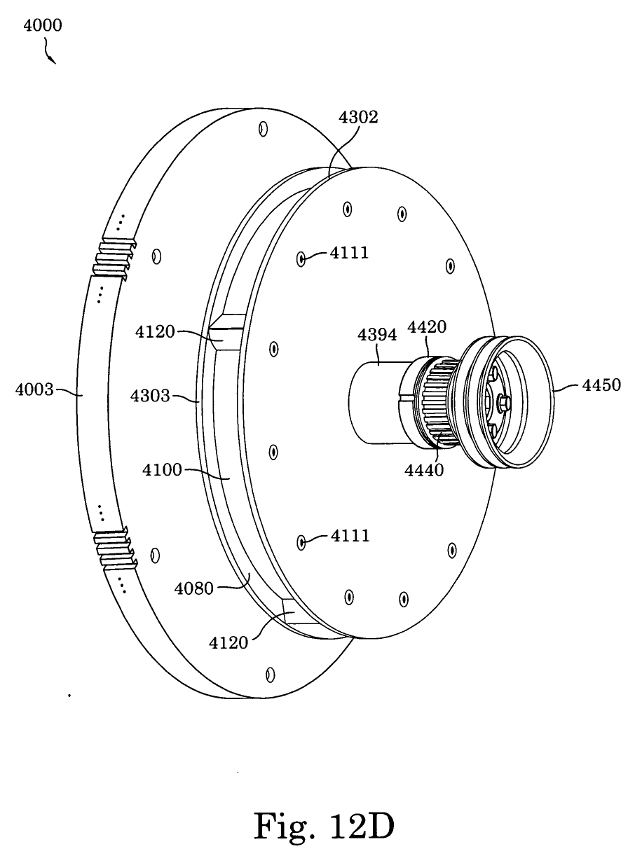

Such sealing engagement of the housing seals 4148 with portions of the rotor assembly 4300 can serve, at least in part, to define one or more combustion chambers 4291. In accordance with the exemplary apparatus 4000, one or more portions of the stator seal 4148 can be positioned and oriented for sealing engagement with one or more portions of the rotor core 4100. More specifically, the combustion housing seals 4148 can be oriented, positioned and/or otherwise configured to engage an outwardly facing groove or channel formed on the periphery of the rotor core 4100. This peripheral rotor groove or channel is best shown in FIGS. 12A-12D, and is described more fully herein with respect to the discussion of the rotor assembly and related components.

The housing seals 4148 preferably have small indents 4209 as best shown in FIG. 22. Suitable seal material is placed into such indents and a high pressure seal is formed between the adjacent housing pieces and rotor assembly 4300. The housing seals 4148 can have a substantially rectilinear cross section. Additionally, each housing seal 4148 can be sized to extend across the width of the combustion chamber 4291 and/or across the width of the combustion housing 4001. In accordance with an exemplary embodiment, the housing seals 4148 are substantially the same width as the combustion housing sections 4140, 4160, 4180, 4200. It is understood that the stator seals 4148 can have alternative forms and/or configurations within the scope of the present disclosure, which are not specifically depicted or described herein.

### Housing Face Pieces

FIG. 19 shows that the housings are provided with face pieces, such as front face piece 4320 and rear face piece 4002 which are fastened to the core of the housing formed by the peripheral housing pieces using fasteners 4053 which extend through suitably placed apertures 4051 in parts 4002, 4320 and the peripheral housing core pieces 4140, 4160, 4180 and 4200. Fasteners 4053 are secured with nuts 4328 (FIG. 19). One or more spacers or sleeves 4054 can be employed in conjunction with one or more fasteners for any of a number of various purposes known in the art. As is seen from a study of FIGS. 19 and 29, the rear housing face piece 4002 may be substantially in the form of, or may include, a flywheel housing. The front and rear face pieces 4320, 4002 can substantially form opposing side walls of one or more combustion chambers 4291 described herein with respect to FIG. 21.

A rear bearing assembly housing 4040 can be supported by or otherwise attached to the rear face piece 4002. The rear ring 4040 can be mounted substantially on the outer side of the rear face piece 4002. The rear ring 4040 can have any of a number of specific functions and/or configurations, and/or can be substantially in the form of any of a number of specific components in accordance with respective embodiments of the present disclosure. For example, the rear ring 4040 can be substantially in the form of a rear shaft bearing support having a rear bearing or bearing assembly of various suitable types know in the art (not shown due to the exploded view), in accordance with at least one embodiment of the present disclosure. The engine assembly 4000 can include one or more rear shaft seals 4030 as shown in FIG. 19.

A front ring 4340 can be mounted to or otherwise attached to the front face piece 4320. The front ring 4340 can be mounted substantially on the outer side of the front face piece 4320. The front ring 4320 can have any of a number of specific functions and/or configurations, and/or can be substantially in the form of any of a number of specific components in accordance with respective embodiments of the present disclosure. For example, the front ring 4340 can be substantially in the form of a carrier or support for a front shaft bearing or bearing assembly 4330 in accordance with at least one embodiment of the present disclosure. The engine assembly 4000 can include one or more front shaft seals 4350.

### Combustion Recesses on Interior of Peripheral Housing Core Pieces

FIG. 21 shows that the housing core pieces 4140, 4160, 4180, 4200 can have interior surfaces which are shaped to provide combustion recesses 4290 which extend outwardly relative to peripheral portions of the rotor assembly 4300. Thus, the rotor seals 4120 described below in greater detail move inwardly and outwardly relative to the rotor in order to stay in contact or near contact with the combustion recesses as the rotor revolves. In one extreme the rotor seals 4120 are extended to the full degree; whereas in another rotational position the rotor seals are retracted to pass over the housing seals 4148. In accordance with one or more embodiments, the interior surfaces of the combustion recesses 4290 can serve as cam surfaces that act upon the rotor seal 4120 to cause the rotor seal to extend and retract.

The rotor seals, such as rockers 4120, can be configured so as to be biased toward an extended position. This can be accomplished, for example, by use of a biasing member (not shown) such as a spring or the like. Moreover, the rotor seals 4120 can be configured so as to be biased outwardly against, and in sealing engagement with, the interior surfaces of the combustion recesses 4290. As the rotor assembly 4300 rotates within the housing 4001, the rotor seals 4120 are pushed toward their respective retracted positions as they approach the stator seals 4148. As mentioned above, this can be accomplished by way of a cam action provided by an undulating profile of the interior surface of the combustion recesses 4290 as is depicted. In this manner, each rotor seal 4120 is in a substantially retracted position as it passes over a given stator seal 4148. After a rotor seal 4120 passes over a given stator seal 4148, the profile of the interior surface of the combustion recesses 4290 can allow the rotor seal to again extend outwardly. In this manner, the rotor seal 4120 is able to remain in substantial sealing contact and/or engagement with the stator (e.g., the interior surface of the combustion recesses 4290) substantially throughout rotation of the rotor, while also being able to clear or pass over each stator seal 4148 without substantial interference.

### Rotor Assembly Core

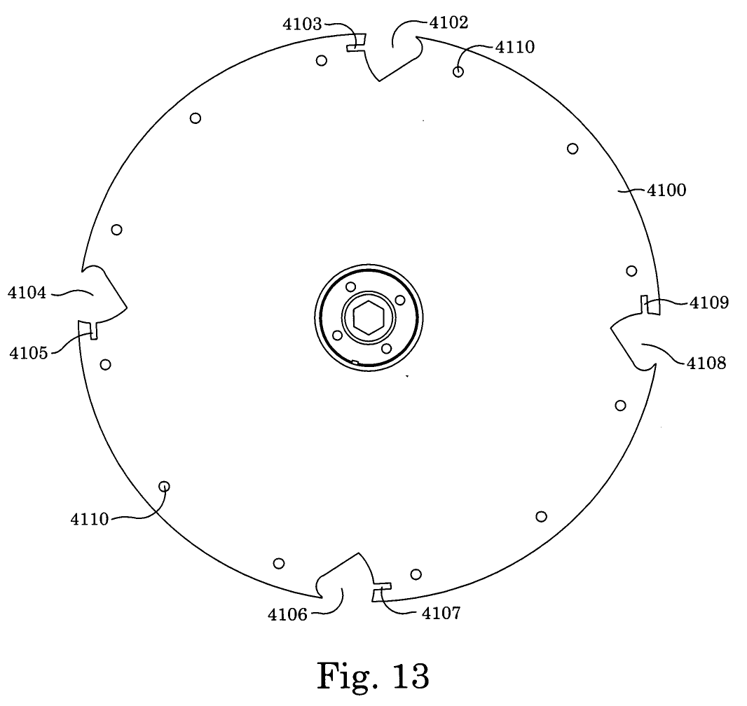

FIG. 13 shows the rotor core 4100 in isolation. FIG. 19 shows this rotor core 4100 in relative relationship to remaining portions of the rotor assembly 4300. FIG. 13 indicates the rotor core includes core piece 4100 which has removed portions at rotor seal areas 4102, 4104, 4106 and 4108. In this embodiment the rotor seal areas 4102, 4104, 4106 and 4108 are shaped to hold rockers 4120 which are adapted to rock or pivot about a pivot point or about a feature such as the rounded or other suitably shaped leading ends of the rockers.

FIG. 13 also shows that the rotor seal areas, or receptacles, 4102, 4104, 4106 and 4108 have adjacent rocker end seal recesses 4103, 4105, 4107 and 4109. Flexible or other suitable seal pieces 4121 fit therein to seal the moving end face of the rockers 4120. FIG. 13 further shows a diametrical array of apertures 4110 through which extend rotor assembly screws 4111 (FIG. 19) that connect the rotor core 4100 and rotor face pieces 4302 and 4303 into an assembly 4300.

The rotor core 4100 can have any of a number of specific configurations. For example, the rotor core 4100 can be substantially a single-piece rotor core. Alternatively, the rotor core 4100 can be a multi-piece rotor core as is shown by depiction of the exemplary embodiments. In accordance with the exemplary embodiment depicted in FIG. 19, the rotor core 4100 can be a three-piece rotor, thus referring to three main portions of the rotor core as described in greater detail below. Specifically, the rotor core assembly 4100 can include a center portion 4301 as well as a pair of end portions 4302, 4303.

As is depicted in FIG. 19, the center portion 4301 of the rotor core 4100 can be positioned between each of the end portions 4302, 4303 of the rotor core. Each of the rotor core end portions 4302, 4303 can be attached, connected or otherwise mounted to the rotor core center portion 4301 by any of a number of various means. For example, in accordance with the exemplary embodiment depicted in FIG. 19, each of the end portions 4302, 4303 can be fastened to the center portion 4301 by way of fasteners 4111. Each of the end portions 4302, 4303 can have a respective inner surface defined thereon. For example, in the exemplary embodiment depicted in FIG. 19, the end portion 4303 defines an inner surface 4080.

The rotor core assembly 4100 can be generally in the form of a circular disk as is depicted in the accompanying figures. In accordance with at least one embodiment, the rotor center portion 4301 can be substantially in the form of a circular disk. As in the exemplary embodiment, the rotor core center portion 4301 can be substantially in the form of a flat, circular disk. Likewise, one or more of the rotor core end portions 4302, 4303 can be substantially in the form of a circular disk, or can be substantially in the form of a flat, circular disk as in the depicted exemplary embodiment.

In accordance with the exemplary embodiment, both of the rotor end portions or rotor core sides 4302, 4303 can be substantially similar in size. For example, each of the rotor core sides 4302, 4303 can have substantially the same diameter. Likewise, each of the rotor core sides 4302, 4303 can have substantially the same thickness. One or more of the rotor end portions 4302, 4303 can be substantially the same size as the rotor core center portion 4301. For example, one or more of the rotor core sides 4302, 4303 can have substantially the same diameter and/or can have substantially the same thickness as the rotor core center portion 4301.

In accordance with the exemplary embodiment, one or more of the rotor core sides 4302, 4303 can be larger than the rotor core center portion 4301. More specifically, in the exemplary embodiment, both of the rotor core sides 4302, 4303 are depicted as having a respective diameter that is larger than the diameter of the rotor core center portion 4301. One or more of the rotor core sides 4302, 4303 and/or the rotor core center 4301 can have a substantially cylindrical outer periphery. More specifically, as is depicted with respect to the exemplary embodiments, each of the rotor core end pieces 4302, 4303 as well as the rotor core center 4301 can be substantially in the form of a short right circular cylinder.

With reference to FIG. 19, a main shaft 4394 can be fastened or otherwise attached to the rotor assembly 4300. The shaft 4394 can have one or more portions 4390. The portion 4390 can be employed for mounting various goo components such as pulleys, sheaves and the like to the shaft 4394. A collar 4420 can be mounted on the shaft 4394 for purposes of securing the timing wheel or disk 4410 into position against a shoulder formed at the inboard end of the threads included upon the rotating assembly shaft member 4394. The collar 4420 can have a number of various possible configurations, including the ring shown. FIG. 11 shows notches 4422 which facilitate the tightening of the collar 4420 upon the threaded section of the rotor shaft piece 4394 using a spanner wrench or other suitable tool. Other types of retainers or collars can alternatively be used if adapted to be suitable for the construction being used.

With continued reference to FIG. 19, the exemplary engine assembly 4000 can include an output shaft portion 4020. The output shaft portion 4020 can include and/or can be substantially in the form of an output flange. The flywheel 4003 can be mounted or otherwise attached to the output shaft portion 4020. The flywheel 4003 can be mounted by way of respective fasteners, for example. The output shaft portion 4020 can be connected to the front shaft portion 4394 and is advantageously provided with receptacles which receive pins on the inward end of front shaft portion 4394. In accordance with at least one embodiment of the present disclosure, the output shaft portion 4020 is attached or otherwise connected to the rotor assembly 4300. In accordance with the exemplary engine apparatus 4000, the front shaft portion 4394 and the output shaft portion 4020 together make up an engine main shaft.

In accordance with at least one embodiment of the disclosure, the front shaft portion 4394 is rotatably supported by a front bearing assembly 4330. At least one front shaft seal 4350 can be employed to surround the front shaft portion 4394 for sealing engagement therewith. Similarly, in accordance with at least one embodiment of the present disclosure, the output shaft portion 4020 is rotatably supported by a rear bearing assembly 4040. At least one rear shaft seal (not specifically shown) can be employed to surround the output shaft portion for sealing engagement therewith.

### Rotor Peripheral Channel and Rotor Seals

As is seen from a study of FIGS. 12A-12D, the rotor core assembly 4100 can be configured to substantially form a peripheral groove about the rotor core between the face pieces. Specifically, as depicted with respect to the exemplary embodiments, the rotor core assembly 4100 can be configured in such a way that the two rotor core sides, or face pieces 4302 and 4303 are larger in diameter than the center 4301. This peripheral groove can be substantially in the form of a channel. Specifically, the groove can be in the form of a substantially U-shaped channel. In accordance with the illustrated embodiments, the groove may have a substantially rectilinear cross section. The rotor core center 4301 and sides 4302, 4303 can be configured as respective short right circular cylinders as described herein above, in which case the peripheral channel can be made to have substantially flat sides or walls and a substantially flat floor or bottom that extends between the walls. More specifically, the floor of the channel can be substantially normal to each of the channel walls.

In accordance with one or more embodiments, the peripheral rotor groove is substantially in the form of a channel that has a pair of spaced apart walls in mutual juxtaposition with a floor extending therebetween. Each of the channel walls can be formed by the inner side of a respective rotor end piece 4302, 4303. For example, with reference to FIG. 19, one channel side wall of a peripheral rotor groove can be formed by at least a portion of the inner face 4080 of the rotor end piece 4303. In accordance with the exemplary embodiment, the channel floor or bottom of the peripheral rotor groove can be formed by at least a portion of the periphery of the rotor core center 4301.

It is to be understood that such a peripheral channel or groove can be defined on the rotor 4100 in accordance with alternative embodiments not specifically depicted herein, wherein the rotor is not a multi-piece rotor, or wherein the rotor core is configured or constructed differently than the exemplary configurations. Regardless of how the peripheral rotor core groove or channel is formed or defined, the groove can be configured to allow the rockers 4120 to be provided with side seals 4122 (FIG. 19) which seal the rocker along three sides to better maintain the pressures experienced during operation into their respective combustion chambers 4291 (FIG. 22) which change in volume as the rotor rotates during operation and the explosive or expanding combustion gases develop changing pressures.

Additionally, one or more portions of the housing assembly 4001 and/or the housing seals 4148 and/or related components can be configured to protrude into the peripheral channel or groove of the rotor assembly 4300, as is shown with respect to the exemplary embodiments. In accordance therewith, one or more of the housing seals 4148 can be configured to substantially seal against the side walls and floor of the outwardly facing channel formed on the periphery of the rotor assembly 4300.

### Rotor Core for Rotor Rocker Seals

FIG. 13 shows an exemplary rotor core 4100 having rocker seal receptacles 4102, 4104, 4106, 4108 extending substantially inwardly from the periphery of the rotor core. Each of the rocker seal receptacles 4102, 4104, 4106, 4108 is adapted to operatively receive therein a respective rotor rocker seal 4120 as depicted in FIGS. 21 and 22. Each of the rotor seals 4120 is configured to pivotally reciprocate or oscillate with respect to the rotor core 4100. The pivotally reciprocating nature of the rotor seals 4120 can enable the seals to substantially follow the inwardly facing interior walls of the combustion housing assembly 4001. More specifically, the seals 4120 can reciprocally pivot relative to the rotor 4100 to remain in substantial contact for sealing engagement with the inwardly facing walls of the combustion recesses 4290 (FIGS. 21, 22).

With continued reference to FIG. 13, each of the rocker receptacles 4102, 4104, 4106, 4108 can have a substantially rounded pocket formed therein proximate a respective leading edge of each receptacle. As is seen from a study of FIGS. 21 and 22, the rotor seals 4120 can have a substantially wedge-shaped cross section in accordance with one or more exemplary embodiments of the disclosure. In accordance with the exemplary embodiments depicted in FIGS. 21 and 22, the rotor seals 4120 can each have a substantially rounded leading edge. This rounded leading edge of each rotor seal 4120 can be received into or captured within the rounded pocket of a respective seal receptacle 4102, 4104, 4106, 4108. More specifically, the rotor rocker seal 4120 can be adapted to be pivotal. Conversely, the rocker seal 4120 can be adapted to rock within the respective rounded pocket formed in each of the receptacles 4102, 4104, 4106, 4108.

Each of the receptacles 4102, 4104, 4106, 4108 can define a secondary seal recess 4103, 4105, 4107, 4109 therein. Each of the secondary seal recesses 4103, 4105, 4107, 4109 is adapted to operatively receive therein a secondary seal or seal element 4121. The seal element or seal piece 4121 is adapted to substantially seal between the rotor core 4100 and a respective rocker seal 4120. More specifically, the secondary seal piece 4121 is configured to maintain substantial contact with a corresponding rocker seal 4120 for substantial sealing engagement therewith.

The secondary seal recess 4103, 4105, 4107, 4109 can be substantially in the form of a slot that connects with a respective main rocker seal recess 4102, 4104, 4106, 4108. In accordance with the exemplary embodiment depicted in FIG. 13, each secondary seal recess 4103, 4105, 4107, 4109 can be substantially rectilinear. The secondary seal recesses 4103, 4105, 4107, 4109 can be advantageously located proximate the trailing edge and sides of a respective rocker seal receptacle 4102, 4104, 4106, 4108. One or more secondary seal recesses 4103, 4105, 4107, 4109 can have a substantially tangential or circumferential orientation as shown.

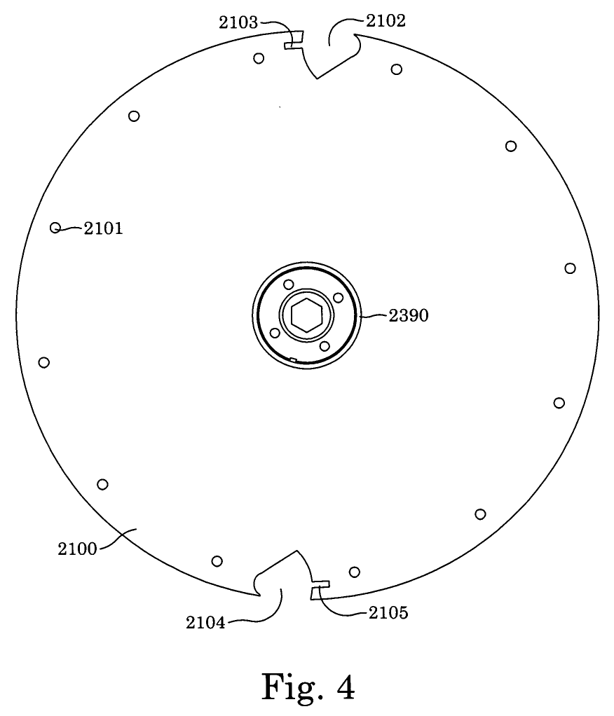

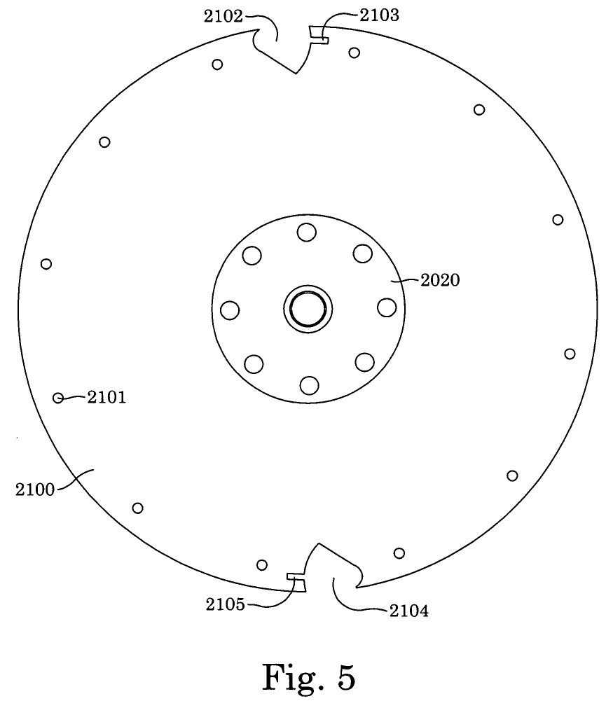

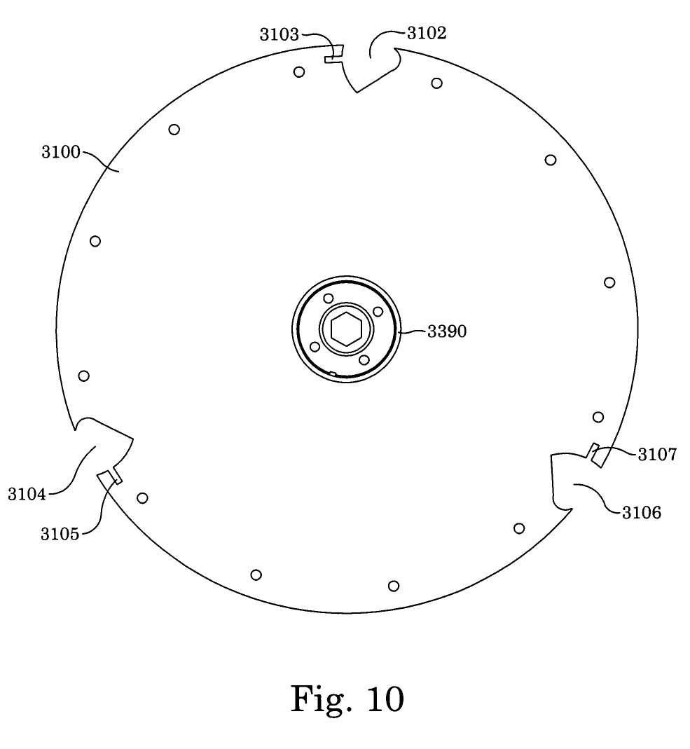

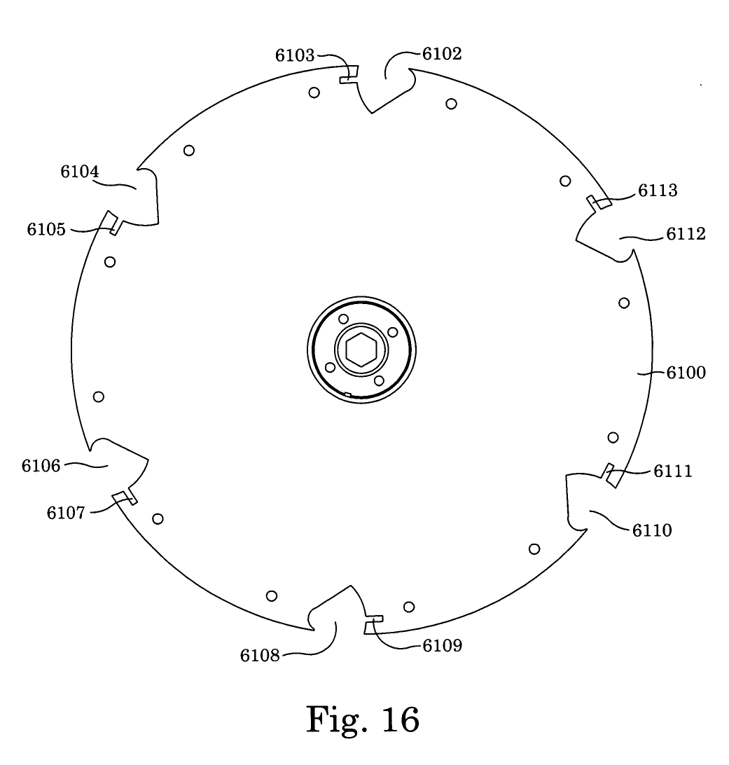

A two-seal rotor core 2100 in accordance with an alternative exemplary embodiment of the disclosure is depicted in FIGS. 4 and 5. A three-seal rotor core 3100 in accordance with another alternative exemplary embodiment is shown in FIG. 10. Likewise, a six-seal rotor core 6100 in accordance with yet another exemplary embodiment of the disclosure is shown in FIG. 16. Similarly, an eight-seal rotor core 8100 in accordance with still another embodiment is depicted in FIG. 18. Each of these alternative exemplary rotor cores can have respective numbers of rotor rocker receptacles and/or secondary seal recesses, which are described above with respect to the four-seal rotor core 4100 depicted in FIG. 13. Other numbers of seals and combustion chambers are also possible.

### Rotor Core for Rotor Vane Seals

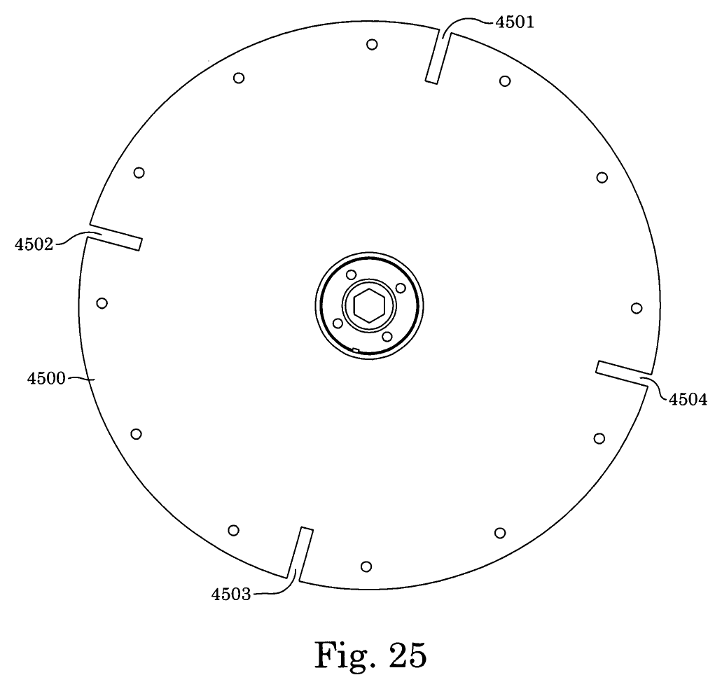

FIG. 25 shows an alternative rotor core 4500 having sliding vane receptacles 4501-4504 extending inwardly from the periphery of the rotor core. These vane receptacles 4501, 4502, 4503, 4504 are adapted to receive sliding vane seals 4516 therein which reciprocate or otherwise extend and retract to maintain contact between the distal ends of the seals and the interior surfaces of the housing assembly, including the combustion recesses and housing seal areas. The rotor vane or other seals now known or hereafter developed are preferably sized and configured to also seal along the sides between the vane seals and the rotor face pieces 4302 and 4303. This can be done for the same reasons that the rocker seals can be provided with side seals 4122 as discussed above with respect to FIG. 19.

In accordance with at least one embodiment of the present disclosure, each of the vane seals 4516 is adapted to substantially remain operatively located within an outwardly facing groove or channel formed on the periphery of the rotor core 4100. A description of this outwardly facing peripheral groove or channel is included in a detailed discussion of the rotor core 4100 with respect to various drawing figures. In accordance with one or more exemplary embodiments, the vane receptacles 4501, 4502, 4503, 4504 are located within such an outwardly facing peripheral rotor groove. More specifically, the vane receptacles 4501, 4502, 4503, 4504 can be substantially defined within the floor of the peripheral rotor groove or channel.

In accordance with at least one embodiment, the vane seals 4516 may be adapted to be substantially radially slidable toward a lower, retracted position at one extreme, and toward a raised, extended position at another extreme. As is evident from a study of FIG. 25, the exemplary receptacles 4501, 4502, 4503, 4504 can be configured to substantially restrict movement of the vane seals 4516 to a substantially radial direction or other inward-outward suitable relative movement from respective fixed points on the rotor core 4100. More specifically, the receptacles 4501, 4502, 4503, 4504 and/or the vane seals 4516 can be configured such that operative movement of each vane seal is restricted to substantially slidable movement along a substantially radial dimension or a substantially radially oriented path.

Each of the vane seals 4516, while operatively received within a respective receptacle 4501, 4502, 4503, 4504, can be biased toward an extended position. Biasing of the vane seals 4516 can be accomplished by way of any of a number of possible biasing means. For example, in accordance with at least one embodiment of the present disclosure, a biasing member can be positioned within each receptacle 4501, 4502, 4503, 4504 substantially between the bottom thereof and the respective vane seal 4516. In this manner, each vane 4516 can be depressed toward a lower or retracted position against a biasing force provided by the biasing member. The biasing force of such a biasing member can serve to bias one or more respective vane seals 4516 toward an extended position. Such a biasing member can have any of a number of possible forms and/or configurations. Such biasing member forms and/or configurations can include, but are not limited to mechanical springs, air springs, gas pressure, magnetic force, electro-magnetic force, and the like, now known or hereafter developed.

In accordance with the exemplary embodiment depicted in FIGS. 25-28, the vane seals 4516 can have a substantially rectilinear shape. More specifically, the vane seals 4516 can have a substantially flat bar shape. Likewise, each of the vane seal receptacles 4501, 4502, 4503, 4504 can have a corresponding rectilinear shape. As is further depicted, the vane seals 4516 can have a substantially rounded outer edge or contact face that is adapted for operative sealing engagement or contact with the combustion chamber inner walls (FIGS. 21, 22).

### Rotor Face Piece Seals

FIG. 19 also shows that the rotor assembly 4300 has face seals 4310. The exemplary engine apparatus 4000 includes both front and rear face seals 4310. The rear rotor assembly face seal 4310 can be captured between the stator housing end piece 4002 and the rotor face piece 4303 to provide a pressure resistant seal therebetween. Similarly, the opposing housing end piece 4320 can be sealed by another face seal 4310 relative to the opposing front housing end piece 4320. The face seals 4310 help to confine pressures resulting from combustion events occurring within the combustion chambers 4291. More specifically, the face seals 4310 can serve to prevent or reduce significant pressure loss due to blow by or the like following a combustion event occurring within the combustion chamber 4291, thereby increasing efficiency of the apparatus 4000. Other means and/or manners of sealing not specifically described herein, including those known or not yet known, can be employed in conjunction with either the exemplary embodiments or with alternative embodiments not specifically depicted or described herein.

### Fuel Injectors

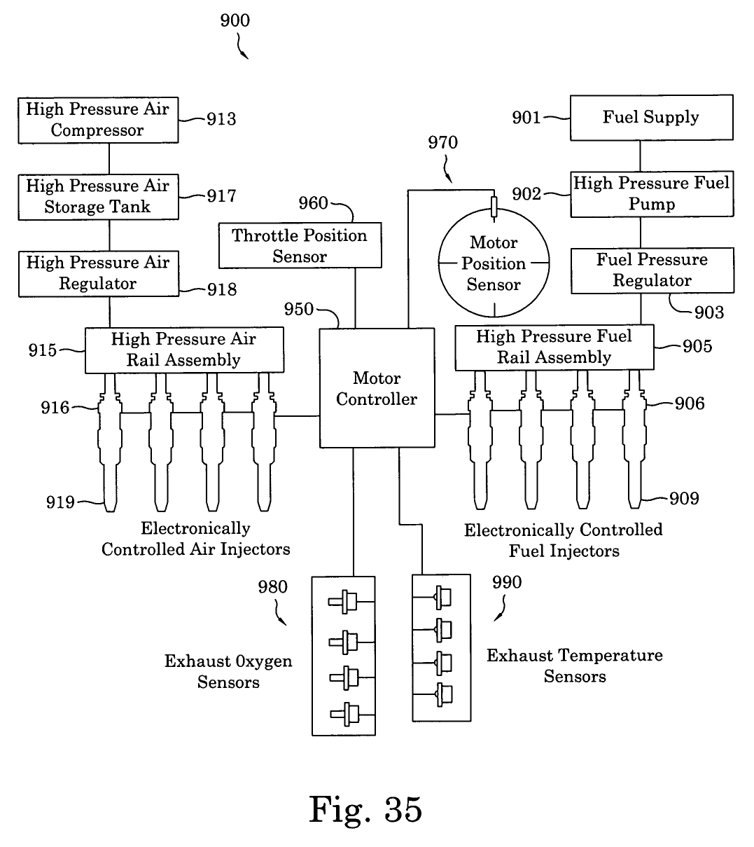

FIG. 21 shows the preferred engines include fuel injectors 4144, 4164, 4184, 4204. The fuel injectors 4144, 4164, 4184, 4204 preferably have an integrated control valve. The integrated control valves are identified in FIG. 35 as 906. These integrated valves have the capability to be controlled by the motor controller 950. The control valves are usually part of the injector itself to provide the desired degree of precision in control and output, but could alternatively be configured otherwise.

The amount of fuel, if any, is then preferably delivered to the pre-combustion chamber 4280 associated with a given fuel injector 4144, 4164, 4184, 4204. The fuel injector 4144, 4164, 4184, 4204, as well as related fuel control components, can be configured to be adjustable or modulating so as to be capable of selectively tailoring the amount of fuel injected into the respective combustion chamber. The pressure of the fuel supplied may vary. However, in the currently preferred versions, fuel will typically be delivered at pressures in the range of approximately 25,000 pounds per square inch to 40,000 pounds per square inch, even more preferably about 36,000 pounds per square inch. In this manner, optimal performance can be achieved in response to varying torque, power, and speed conditions. More specifically, the fuel injectors 4144, 4164, 4184, 4204 can be controllable with respect to a flow rate or quantity of fuel injected and/or with respect to the timing of the injection and/or with respect to the pressure with which the fuel is injected. The time the injector is the open is the currently preferred way to control the volume of fuel delivered by an injector. The pressure of the high pressure fuel rail is thus controlled to be approximately constant. Intermittent delivery of pulses of fuel during a combustion stage may provide improved performance, efficiency or other advantage in operation.

In accordance with at least one embodiment of the present inventions, the fuel injectors 4144, 4164, 4184, 4204 can be substantially identical to conventional high pressure fuel injectors known to those in the art particularly in connection with diesel engine design. More specifically, in accordance with one or more embodiments of the present disclosure, an engine can include one or more high pressure fuel injectors known to be used in conventional reciprocating internal combustion diesel engines. It is to be understood that other fuel injectors and/or fuel injecting means including such means not yet known can be included in apparatus within the scope of the inventions disclosed herein.

In accordance with at least one embodiment of the present disclosure, the fuel injectors 4144, 4164, 4184, 4204 can be selectively actuated by any of a number of possible control means. For example, in accordance with an exemplary embodiment depicted in FIG. 35, the fuel injectors 909 are adapted to be actuated in response to an electrical signal, wherein actuation of the fuel injectors is controlled by a controller 950, which can be, for example, a digital controller or processor. In this manner, one or more parameters of a fuel injection event can be selectively controlled. Such parameters can include, but are not limited to injection timing, fuel pressure, fuel volume and duration of injection. It is to be understood that alternative injection control means can be employed in apparatus within the scope of the present disclosure. For example, in accordance with at least one alternative embodiment of the disclosure, the fuel injectors can be mechanically actuated, and can be controlled by way of a cam shaft or the like.

### Combustion Air Injectors

The preferred engines according hereto further include air injectors, such as air injectors 4146, 4166, 4186, 4206. The air injectors are shown in FIGS. 34 and 35 generically as item 919. The amount of air injected into any particular combustion chamber can be controlled by air injector control valves 916 which can either be part of the injector itself, as shown, or a separate valve performing the same operation. The air injectors 4146, 4166, 4186, 4206 can be controlled with respect any of a number of parameters including, but not limited to, pressure, flow rate or quantity of air, timing of the air injection, and duration of injection.

In currently preferred engines according to this description, the high pressure air rail assembly 915 (FIG. 35) has a regulated and approximately constant air pressure as determined by the air regulator 918. The regulated air may for example be provided at approximately 2000 pounds per square inch, but pressures ranging from 1000 to 5000 pounds per square inch may also be just as suitable. Still other pressures may be desired depending on the mode of operation or configuration of the particular engine involved.

In accordance with at least one embodiment of the present disclosure, the air injectors 4146, 4166, 4186, 4206 can be substantially in the form analogous to a high pressure fuel injector with integral quick acting air valve.

The air injectors 4146, 4166, 4186, 4206 can be adapted to operate in conjunction with intake air compressor, and/or supercharger to admit air into a respective combustion chamber in a controlled manner under a relatively high pressure. In accordance with at least one embodiment of the disclosure, an air injector 4146, 4166, 4186, 4206 substantially in the form of a quick acting valve can be adapted to remain closed except substantially during ignition and a combustion event occurring within a combustion chamber. More specifically, an air valve 4146, 4166, 4186, 4206 can be adapted to remain substantially closed except during combustion of fuel within a respective combustion chamber of an engine in accordance with at least one embodiment of the disclosure.

In accordance with at least one embodiment of the present disclosure, the air injectors can be selectively actuated by any of a number of possible control means. For example, in accordance with an exemplary embodiment depicted in FIG. 35, the air injectors 919 are adapted to be actuated in response to an electrical signal, wherein actuation of the air injectors is controlled by a controller 950, which can be, for example, a digital controller or processor. In this manner, one or more parameters of an air injection event can be selectively controlled. Such parameters can include, but are not limited to injection timing, air pressure, air volume and duration of injection.

It is to be understood that alternative injection control means can be employed in apparatus within the scope of the present disclosure. For example, in accordance with at least one alternative embodiment of the disclosure, the air injectors 4146, 4166, 4186, 4206 can be mechanically actuated, and can be controlled by way of a cam shaft or the like. Moreover, in accordance with an exemplary embodiment of the present disclosure, at least one operational parameter of one or more air injectors 919 is controlled by a control device 950 such as a digital controller or processor, which also controls at least one operational parameter of one or more fuel injectors 909.

### Mixing of Combustion Materials

The type of fuel used and air or other reagent making combustion materials either alone or with other constituents are blended or mixed. This is preferably done in the pre-combustion chambers which help maintain the pressure of these combustion materials high to facilitate ignition, such as auto-ignition which is now preferred. As shown, emission sensors, such as the exhaust oxygen sensors 980 (FIG. 35) can be used as parameters in the motor controller to determine in whole or part the mix ratio of the combustion materials. Other parameters may also be found of benefit. Such as the exhaust temperature sensors 990.

Combustion materials consumed may be conserved by controlling both air and fuel or other materials being combusted. The temperature sensors for the exhaust are currently most pertinent to the control of the engine and mixture of combustion components and their introduction into the engine for the purpose of minimizing nitrous oxides (commonly referred to in their various mixes as NOₓ). Lower exhaust temperatures reduce such undesirable exhaust constituents.

Preferred operation also avoids over-rich conditions where fuel is unnecessarily more concentrated in the combustion mix to reduce undesirable effects such as smoking and higher fuel consumption and emissions.

### Combustion Aids

FIG. 29 and other Figs. show combustion aides 4142, 4162, 4182, 4202. The combustion aids 4142, 4162, 4182, 4202 can have any of a number of various specific forms or configurations. In accordance with at least one embodiment of the present disclosure, the combustion aids 4142, 4162, 4182, 4202 can be substantially in the form of glow plugs such as those with conventional diesel reciprocating engines. A glow plug 4142, 4162, 4182, 4202 can be adapted for substantially manual control or operation, such as by way of a switch or the like (not shown). Alternatively, a glow plug 4142, 4162, 4182, 4202 in accordance with at least one embodiment of the present disclosure can be automatically controlled by the main controller 950 shown in FIG. 35.

Alternatively, or additionally, one or more of the combustion aids 4142, 4162, 4182, 4202 can be substantially in the form of a glow plug such as used in presently available diesel engines which is operated at a lower temperature. For example, the glow plug can be operated at about half of normal voltage to provide one-quarter the power as compared to when used in the normal application of a diesel engine glow plug used to warm the ignition chamber for starting. The glow plugs as used in the current inventions are advantageously used all or most of the time at this reduced power and may be maintained in a powered condition constantly during sustained operation of the engine.

Alternatively, an engine employing one or more combustion aids 4142, 4162, 4182, 4202 may include additional associated devices not specifically depicted. For example, an engine employing a combustion aide in accordance with an alternative embodiment of the present disclosure which is not depicted herein can include a microprocessor, distributor, or other suitable device and have intermittent or controlled operation. Additionally, such an engine can include other ignition aiding configurations. Alternatively, such spark-ignition engines within the scope of the present disclosure can include a distributorless ignition-timing and distribution system. For example, with reference to FIG. 35, ignition timing and/or distribution of an exemplary engine within the scope of the disclosure can be substantially controlled by the motor controller 950.

An engine in accordance with at least one embodiment of the present inventions can include at least one other form of combustion aide 4142, 4162, 4182, 4202, including ignition timing and/or distribution devices, not specifically depicted or described herein, depending upon the type of fuel being used. It is to be understood that an engine in accordance with one or more embodiments of the present disclosure can employ at least one combustion aid or ignition aid that is not yet known.

### Timing Control Assembly

Engines according to the inventions also preferably include a timing system or timing control. The timing control can be mounted under the timing control cover 4430. The timing control cover can be mounted to a casing 4370 (FIG. 19). The timing control cover 4430 can be mounted to the casing 4370 by way of timing cover fasteners 4436. The timing control casing 4370 can be supported on the housing assembly 4001. In accordance with the exemplary engine apparatus 4000 depicted in FIG. 19, the timing control casing 4370 can be supported on the front housing face piece 4320.

The timing control can include a timing wheel or disk 4410. At least one rotation sensor 4418 can be supported within the timing control compartment to sense the rate of rotation of the timing wheel 4410. The timing wheel 4410 is preferably supported on or otherwise connected the rotating shaft of the engine. FIG. 19 shows, the timing wheel is provided with slots at positions commensurate with the number of combustion chambers. The timing control housing 4031 supports at least one sensor which detects the position of the rotating assembly. As shown in FIG. 19, there are two sensors 4418 which are preferably optical electrical sensors.

The currently preferred sensors have an emitting LED which beams toward the disk and is occluded except when a slit is positioned to allow the beam to pass there through. The sensors also include a detecting LED or other suitable detector that sensing when the beam passes through the disk slit and thus indicates both position and speed. In the construction shown, one detector is used to sense rotational speed and the other to indicate position. One or both are adjusted by the mounting fasteners 4034 (FIG. 29) which allow the position of the sensors to be adjusted. Turning of the fasteners 4034 moves the sensors tangentially and thus adjustment of the sensor may be provided. For example an adjustment of preferably at least 5 degrees of angular arc is desired for the sensor used to control timing of the engine. Similar adjustment may be provided to the other sensor to adjust the tachometer. In an alternative configuration a single sensor can be used to do both functions. Other means for detecting the angular position of the rotating assembly and/or providing adjustment of the timing may alternatively be possible. For example, angular position encoders know in the art or hereafter developed may be found suitable for use in engines according hereto 1290

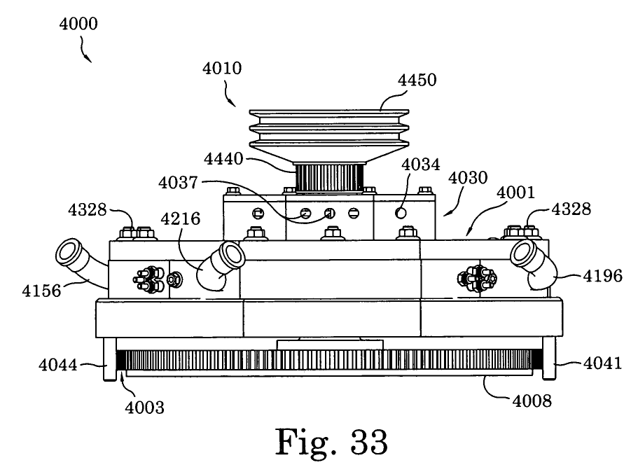

The timing casing 4370 may include at least one aperture 4037 (FIG. 33). The apertures 4037 defined in the timing casing 4370 may serve as ventilation ports or the like to dissipate heat.

The motor controller 950 can be adapted to receive a signal generated by the timing sensor 4418 and/or by some other component of the timing control. The signal received by the controller 950 can be employed to determine one or more operating parameters of an engine within the scope of the inventions. For example, a timing control or timing system within the scope of the present disclosure can be configured to control one or more various operational aspects of an associated engine, including but not limited to, fuel injection timing and/or sequence, air injection timing and/or sequence, as well as ignition timing and/or sequence. The timing control can be adapted to provide data and/or other output indicative of one or more aspects of engine operation.

### Two Chamber Version

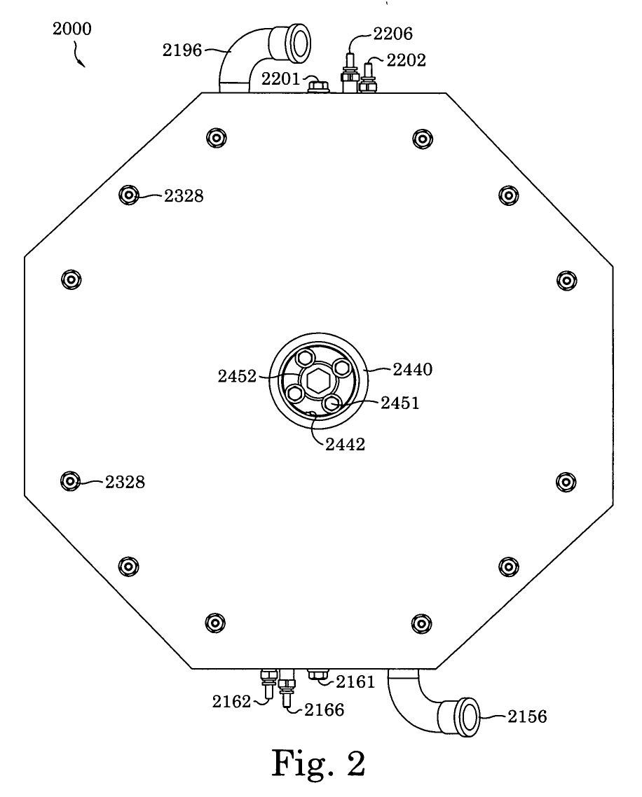

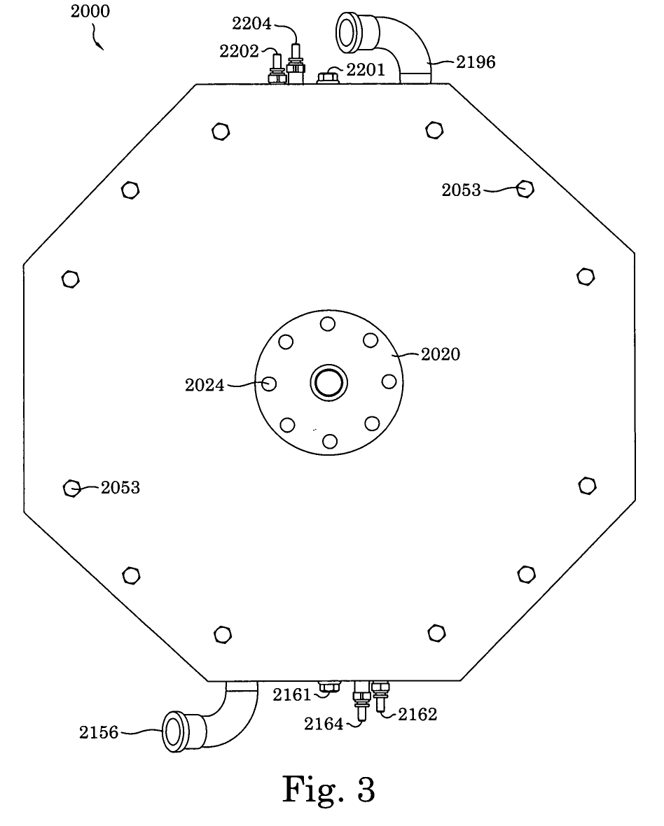

FIG. 1 is a side view showing an engine 2000 according to some preferred forms of the inventions. FIGS. 2 and 3 are front and rear views, respectively, of the engine 2000 shown in FIG. 1. Engine 2000 has two combustion chambers in a configuration which is similar to the four combustion chambers 4291 shown in engine 4000 of FIGS. 21 and 22. Many of the components of the two chamber engine 2000 can be identical to the corresponding components of the four chamber engine 4000 described herein above.

The combustion chambers of the two chamber engine 2000 can be made as depicted in the illustrated version 2000 by using two central housing pieces 2200. As indicated in FIG. 19, the central housing pieces 2200 can be very similar to pieces 4200 of FIG. 19, with the exception that pieces 2200 form half cylinder pieces versus the quarter cylinder pieces used in of the housing assembly 4001.

FIG. 1 shows that on opposing faces of the central housing pieces 2200 are suitable covers to substantially enclose an internal cavity of the housing. The housing formed by pieces 2200 are covered by a front or first housing piece 2203 and a rear or second housing piece or plate 2202. The covers preferably seal against the central housing pieces 2200 using suitable fastenings, such as fasteners 2053 and 2328 which mate, such as by a threaded connection using bolts 2053 and nuts 2328.

Engine 2000 has a housing assembly as described above which also includes combustion chamber recesses. The combustion chamber recesses of the engine 2000 can be substantially similar to the combustion chamber recesses 4290 of FIG. 21, except there are two in number rather than four as in the embodiment described above.

Engine 2000 can include one or more various first combustion accessories 2162, 2164, 2166 and second combustion accessories 2204, 2206. Specific forms of the combustion accessories 2162, 2164, 2166, 2204, 2206 can include, but are not limited to, various air injectors, fuel injectors, glow plugs and the like as explained in greater detail herein with respect to the four chamber engine apparatus 4000.

The engine 2000 can include a pulley 2440 or the like. The pulley 2440 can be employed in conjunction with a V-belt or the like for driving various accessories and/or peripheral devices, components and/or systems associated with the operation of the engine and/or with the operation of a vehicle (not shown). The engine 2000 can include exhaust conduits 2156, 2196. The exhaust conduits 2156, 2196 can be employed to facilitate removal of exhaust residue such as exhaust gases from the engine 2000. The engine 2000 can include one or more of an output flange 2020, a shaft 2394, a locking ring 2420 and an index marking 2422. The pulley 2440 can be retained by one or more fasteners 2451. The pulley 2440 can define a center opening 2452. A key 2442 can also be employed for securing the pulley 2440 to the shaft. The output flange 2020 can incorporate one or more various connection features 2024 such as holes, apertures or the like.

FIGS. 4, 5, 6 and 7 depict in isolation a front view, a rear view, a bottom view and a top view, respectively, of a rotor 2100. The rotor 2100 can be employed with the two chamber engine 2000. The rotor 2100 can include one or more various mounting features 2101, such as holes or the like, which can be employed for mounting various components to the rotor 2100. The shaft 2394 can at least one shoulder or step 2393. The shaft 2394 can be used to position a race portion of the shaft bearing (not shown). A keyway 2396 may be included in the shaft 2394 to facilitate fixing of an attached piece, such as the timing disk or other component.

The rotor 2100 can define first and second rotor seal receptacles 2102, 2104. The seal receptacles 2102, 2104 can be substantially evenly spaced about the periphery of the rotor 2100. Within each seal receptacle 2102, 2104, a secondary seal receptacle 2103, 2105 can be defined. The significance of the seal receptacles 2102, 2104 as well as that of the secondary seal receptacles 2103, 2105 is explained herein with respect to the more detailed description of the four chambered apparatus 4000. Although the seal receptacles 2102, 2104 are depicted as being rocker seal receptacles, it is to be understood that the rotor 2100 can have seal receptacles having any of a number of alternative configurations, including but not limited to radial vane seal receptacles which are described in detail herein with respect to FIGS. 25-28.

### Three Chamber Version

A three combustion chamber apparatus 3000 is depicted in FIGS. 8, 9 and 10. The three combustion chamber embodiment can be substantially similar to the four chamber embodiment and the two chamber embodiment described above, except for the number of certain features such as combustion chambers, seals and the like. In accordance with the exemplary embodiment of a three chamber engine 3000, each of the combustion chambers, as well as each of the related components and features can be spaced at substantially even intervals of 120° of arc.

Various fasteners 3053, 3328, can be employed for fastening various portions of the engine 3000. The engine 3000 can include various combustion accessories 3146, 3142, 3162, 3164, 3166, 3202, 3204, 3206. Specific exemplary forms of the combustion accessories 3146, 3142, 3162, 3164, 3166, 3202, 3204, 3206 include, but are not limited to air injectors, fuel injectors, glow plugs and the like as discussed in detail herein with respect to the four chamber apparatus 4000.

FIG. 10 depicts a front view of a rotor 3100 in isolation. The rotor 3100 can be employed with the exemplary engine 3000. As depicted, the rotor 3100 can include one or more various mounting features such as holes or the like, which can be employed for mounting various components to the rotor. The rotor 3100 can include at least one center assembly 3390, which can have any of a number of various specific forms and/or configurations.

The rotor 3100 can define first, second and third rotor seal receptacles 3102, 3104, 3106. The seal receptacles 3102, 3104, 3106 can be substantially evenly spaced about the periphery of the rotor 3100. Within each seal receptacle 3102, 3104, 3106 a secondary seal receptacle 3103, 3105. 3107 can be defined. The significance of the seal receptacles 3102, 3104, 3106 as well as that of the secondary seal receptacles 3103, 3105, 3107 is explained herein with respect to the more detailed description of the four chambered apparatus 4000. Although the exemplary three-seal rotor 3100 is depicted as having rocker seal receptacles, it is to be understood that a three-seal rotor within the scope of the present disclosure can have seal receptacles of any of a number of alternative configurations, including but not limited to radial vane seal receptacles, which are described in detail herein with respect to FIGS. 25-28.

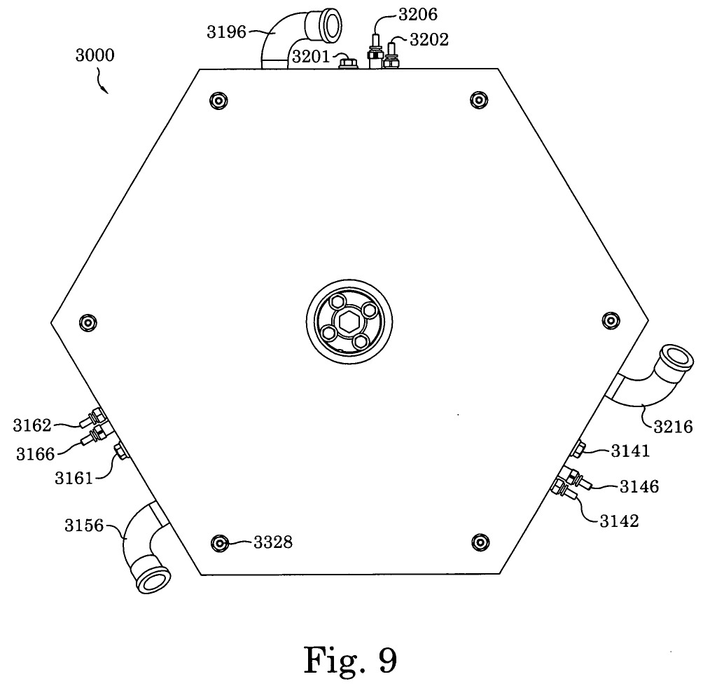

As is further evident from a study of FIG. 9, the engine 3000 can include at least one or more, and preferably three, housing fasteners 3141, 3161, 3201. The housing fasteners 3141, 3161, 3201 can be engaged with respective housing portions as discussed in detail herein with respect to the four chamber apparatus 4000. More specifically, the housing fasteners 3141, 3161, 3201 can be adapted to connect or fasten together adjacent housing portions as in the manner of the four chamber apparatus 4000 as is discussed herein.

The engine 3000 can include exhaust ducts, conduits or ports 3156, 3196, 3216 for exhausting or evacuating exhaust residue such as gases and the like from the engine 3000. The engine 3000 can include an output shaft 3394. An output flange 3020 can be defined on one end of the shaft 3394. A timing wheel (not shown in FIG. 8) can be secured by collar or ring 3420 and is preferably mounted on the shaft 3394. A collar notch or notches 3422 can be used to tighten the collar and fix the position of the timing wheel. The engine 3000 may include a pulley 3440 connected to the shaft 3394. The pulley 3440 can be employed to drive various accessories and/or components and/or systems associated with the operation of the engine 3000. The shaft 3394 preferably has a shoulder against which the timing wheel is positioned by the collar 3420.

### Six Chamber Version

A six combustion chamber apparatus 6000 is depicted in FIGS. 14, 15 and 16. The six combustion chamber embodiment can be substantially similar to the four chamber and the two chamber embodiments described above, except for the number of combustion chambers and related features and components. Specifically, each of the combustion chambers, as well as each of the related components and features can be spaced at intervals of 60° of arc.

Various fasteners 6053, 6328, can be employed for fastening various portions of the engine 6000. The engine 6000 can include various combustion accessories 6142, 6146, 6162, 6164, 6166, 6168, 6202, 6204, 6206, 6242, 6244, 6246, 6182, 6184, 6186, 6222, 6226. Specific exemplary forms of these combustion accessories include, but are not limited to air injectors, fuel injectors, glow plugs and the like.

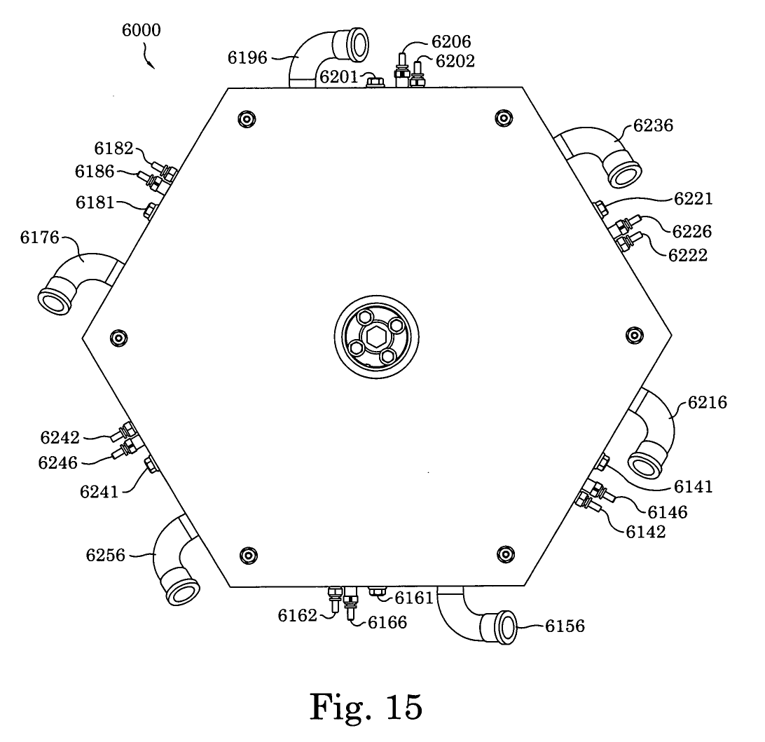

FIG. 16 depicts a front view of a rotor 6100 in isolation. The rotor 6100 can be employed with the engine 6000. As depicted, the rotor 6100 can include one or more various mounting features such as holes or the like, which can be employed for mounting various components to the rotor. The rotor 6100 can include at least one center assembly, which can have any of a number of various specific forms and/or configurations and/or can include any of a number of specific components as is described with respect to the engine assembly 6000 depicted in FIGS. 14 and 15.

With continued reference to FIG. 16, the rotor 6100 can define first, second, third, fourth, fifth and sixth rotor seal receptacles 6102, 6104, 6106, 6108, 6110, 6112. The seal receptacles 6102, 6104, 6106, 6108, 6110, 6112 can be substantially evenly spaced about the periphery of the rotor 6100. Within each seal receptacle 6102, 6104, 6106, 6108, 6110, 6112 a secondary seal receptacle 6103, 6105. 6107, 6109, 6111, 6113 can be defined. The significance of the seal receptacles 6102, 6104, 6106, 6108, 6110, 6112 as well as that of the secondary seal receptacles 6103, 6105. 6107, 6109, 6111, 6113 is explained herein with respect to the more detailed description of the four chambered apparatus 4000. Although the exemplary six-seal rotor 6100 is depicted as having rocker seal receptacles, it is to be understood that a six-seal rotor within the scope of the present disclosure can have seal receptacles of any of a number of alternative configurations, including but not limited to radial vane seal receptacles, which are described in detail herein with respect to FIGS. 25-28.

As is further evident from a study of FIG. 15, the engine 6000 may include at least one or more, and preferably six housing fasteners 6141, 6161, 6241, 6181, 6201, 6221. The housing fasteners 6141, 6161, 6241, 6181, 6201, 6221 can be employed to connect or fasten together adjacent housing portions in the manner discussed herein with respect to the four chamber version 4000.

The engine 6000 may include exhaust ducts, conduits or ports 6156, 6176, 6196, 6216, 6236, 6256 for exhausting or optionally evacuating exhaust gases and the like from the combustion chambers of engine 6000. The optional evacuating may occur when exhaust gases are drawn by the input of a turbo-charger, supercharger or other ancillary device that creates a suitable pressure condition in the exhaust port as the rotor seal displaces and exhausts the combustion gases or other gases contained within a particular combustion chamber at any particular instance of use.

It should be mentioned that although reference is made to use of turbo-chargers, such are not likely to be suitable in the preferred versions. This is because turbo-chargers create an impedance to flow of exhausting gases and thus provide some increase or back pressure. However, there may in some cases be possible to configure the exhausting gases to extract some useful energy toward compression of the intake air which does not lead to a significant back pressure and thus turbo-chargers are mentioned.

### Air Pressures

In general the air pressures provided in engines according to these inventions are high pressure in the range of providing 100-400 pounds per square inch in the pre-combustion compartments prior to ignition. After ignition is initiated then the pressures increase to much higher levels as the combustion event progresses from the pre-combustion chamber to the main combustion chamber after the rotor seal has passed the port which allows the pre-combustion chamber to be opened and the ignition and combustion expands into the main combustion chamber. This approach also has the advantage that the pre-combustion chamber is also much easier to keep hot because it is minimized in size and preferably aided by the glow plug to allow easy ignition.

The engine 6000 includes a drive shaft which can serve to drive an output, such as shaft 6394 and attached output flange 6020. Output flange 6020 can be defined on one end of the shaft 6394. Other configurations may also be possible. A timing wheel 6410 can be mounted on the shaft 6394. A timing mark 6422 can be defined on the timing wheel 6410. The engine 6000 can include a pulley 6440 connected to the shaft 6394. The pulley 6440 can be employed to drive various accessories and/or components and/or systems associated with the operation of the engine 6000.

### Eight Chamber Version

An eight combustion chamber apparatus 8000 is depicted in FIGS. 17 and 18. The eight combustion chamber embodiment can be substantially similar to the four chamber and the two chamber embodiments described above, except for the number of combustion chambers and related features and components. Specifically, each of the combustion chambers, as well as each of the related components and features can be spaced at intervals of 45° of arc or approximately 45° of arc. Other angular special relationships may also be possible having either equal or approximately equal angular spacings or it may conceivably be possible to configure the engine with variant spacings using control adjustments or other possible effects wherein the angular periods of expansion may vary from one combustion chamber to another to achieve some special or desirable effect.

The engine 8000 can include various combustion accessories 8142, 8146, 8162, 8166, 8202, 8206, 8242, 8246, 8182, 8186, 8222, 8226, 8262, 8266, 8282, 8286. Specific exemplary forms of these combustion accessories include, but are not limited to air injectors, fuel injectors, glow plugs and the like as is explained herein with respect to the exemplary four chamber version.

FIG. 18 depicts a front view of a rotor 8100 in isolation. The rotor 8100 can be employed with the engine 8000. As depicted, the rotor 8100 can include one or more various mounting features such as holes or the like, which can be employed for mounting various components to the rotor. The rotor 8100 can include at least one center assembly, which can have any of a number of various specific forms and/or configurations and/or can include any of a number of specific components as is described with respect to the other exemplary engine assemblies shown and discussed herein.

With continued reference to FIG. 18, the rotor 8100 can define first, second, third, fourth, fifth, sixth, seventh, and eighth rotor seal receptacles 8102, 8104, 8106, 8108, 8110, 8112, 8114, 8116. The seal receptacles 8102, 8104, 8106, 8108, 8110, 8112, 8114, 8116 can be substantially evenly spaced about the periphery of the rotor 8100. Within each seal receptacle 8102, 8104, 8106, 8108, 8110, 8112, 8114, 8116 a secondary seal receptacle 8103, 8105, 8107, 8109, 8111, 8113, 8115, 8117 can be defined. The significance of the seal receptacles 8102, 8104, 8106, 8108, 8110, 8112, 8114, 8116 as well as that of the secondary seal receptacles 8103, 8105, 8107, 8109, 8111, 8113, 8115, 8117 is explained herein with respect to the more detailed description of the four chambered apparatus 4000. Although the exemplary eight-seal rotor 8100 is depicted as having rocker seal receptacles, it is to be understood that an eight-seal rotor within the scope of the present disclosure can have seal receptacles of any of a number of alternative configurations, including but not limited to radial vane seal receptacles, which are described in detail herein with respect to FIGS. 25-28.

As is further evident from a study of FIG. 17, the engine 8000 can include at least one or more, and preferably eight, housing fasteners 8141, 8161, 8181, 8201, 8221, 8241, 8261, 8281. The housing fasteners 8141, 8161, 8181, 8201, 8221, 8241, 8261, 8281 can be employed to connect or fasten together adjacent housing portions in the manner of the four chamber version 4000 as described herein.

The engine 8000 can include exhaust ducts, conduits or ports 8156, 8176, 8196, 8216, 8236, 8256, 8276, 8296 for exhausting or evacuating exhaust residue such as gases and the like from the engine 8000. The engine 8000 can include one or more of the various features and/or components described above with respect to other exemplary embodiments described above. For example, the engine 8000 can include an output shaft (not shown), and an output flange (not shown) can be defined on the output shaft. A timing wheel (not shown) can be mounted on the shaft. A timing mark (not shown) can be defined on the timing wheel. As a further example, the engine 8000 can include a pulley connected to the shaft. The pulley can be employed to drive various accessories and/or components and/or systems associated with the operation of the engine 8000.

### Additional Versions

As is by now apparent, an apparatus in accordance with the principles of the inventions disclosed herein can be configured with nearly any number of combustion chambers, including even numbers of chambers or odd numbers of chambers such as five chamber, seven chambers and nine chambers and so on. More specifically, an apparatus in accordance with the principles of the present inventions can include a given number of combustion chambers, wherein such an apparatus can also include the given number of rotor seals and the given number of housing seals. Additionally, such an embodiment can include the given number of each of exhaust ports, fuel injectors, and air injectors. In accordance with preferably configured embodiments, such combustion chambers, seals and associated features are substantially evenly spaced about the periphery of the respective rotor and housing.

Furthermore, although all exemplary embodiments are shown and described herein as having identical numbers of associated housing features and rotor features, it is to be understood that alternative embodiments in accordance with the teachings of the inventions can have unequal numbers of associated housing features and rotor features. For example, in accordance with at least one embodiment of the present disclosure, an engine can have a given number of housing seals and the given number of combustion accessories (e.g. injectors, glow plugs, etc.) and the given number of exhaust ports and the like. But, unlike the exemplary embodiments shown and described herein, such an engine can have a number of rotor seals that is fewer than the given number. More specifically, such an engine in accordance with the alternative embodiment can be equipped with fewer rotor seals and associated rotor components than it is equipped with housing seals and associated housing components.

Similarly, an engine in accordance with another alternative embodiment of the present disclosure can be equipped with more rotor seals and associated components than it is equipped with housing seals and associated housing components. For example, an engine in accordance with an alternative embodiment of the disclosure can be equipped with one housing seal and one set of associated housing components (e.g. combustion accessories, exhaust ports), and with two rotor seals and associated rotor components. As a further example, an engine in accordance with another alternative embodiment of the disclosure can be equipped with three housing seals and three sets of associated housing components (e.g. combustion accessories, exhaust ports), and with two rotor seals and associated rotor components.

### Four Chamber Radial Vane Seal Version

A four chamber radial vane seal embodiment of the present disclosure is depicted in FIGS. 25, 26, 27 and 28. A radial vane seal engine can be substantially similar to a rocker seal engine except for the specific configuration of the seal receptacles defined in the rotor and the specific configuration of the seals themselves. The four chamber radial vane rotor 4500 is depicted in isolation in FIG. 25. The radial vane rotor 4500 defines four substantially straight radial slots, gaps or receptacles 4501, 4502, 4503 and 4504. A vane seal 4516 can be slidably disposed within each slot 4501, 4502, 4503 and 4504. The vane seal 4516 can be substantially straight as depicted. Each vane 4516 can be adapted to slide or reciprocate toward an extended position and toward a retracted position.

Each vane 4516 can be biased toward an extended position. Such biasing of the vanes 4516 can be achieved, for example, by use of a biasing member such as a spring or the like (not shown). More specifically, a biasing member (not shown) can be employed to push the respective vane 4516 toward an extended position. The biasing member is preferably configured to allow the associated biasing force to be overcome in order to allow the vane 4516 to be pushed inwardly toward the retracted position as the vane passes over the housing seal 4148, for example.

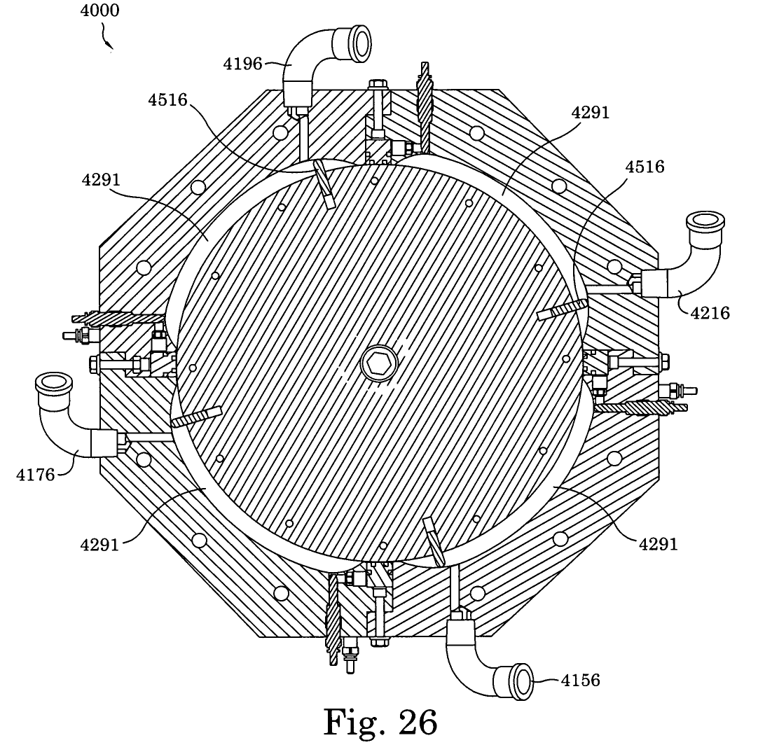

With specific reference to FIG. 26, the rotor 4500 is shown in a given position relative to the housing 4001, wherein the vanes 4516 are shown to be approaching the respective housing seals 4148 as the rotor rotates in a clockwise direction. A study of FIG. 26 reveals that the vanes 4516 can be biased outwardly toward and extended position so as to maintain substantial sealing engagement or contact with the housing 4001. Further study of FIG. 26 reveals that, as the interior walls of the housing 4001 can be shaped to curve inwardly toward the rotor 4500 as the wall approach each housing seal 4148. In this manner, as the rotor 4500 turns in a clockwise direction from the position depicted in FIG. 26, the vanes 4516 can be pushed into their respective slots toward respective retracted positions as the interior walls of the housing 4001 become closer to the outer periphery of the rotor.

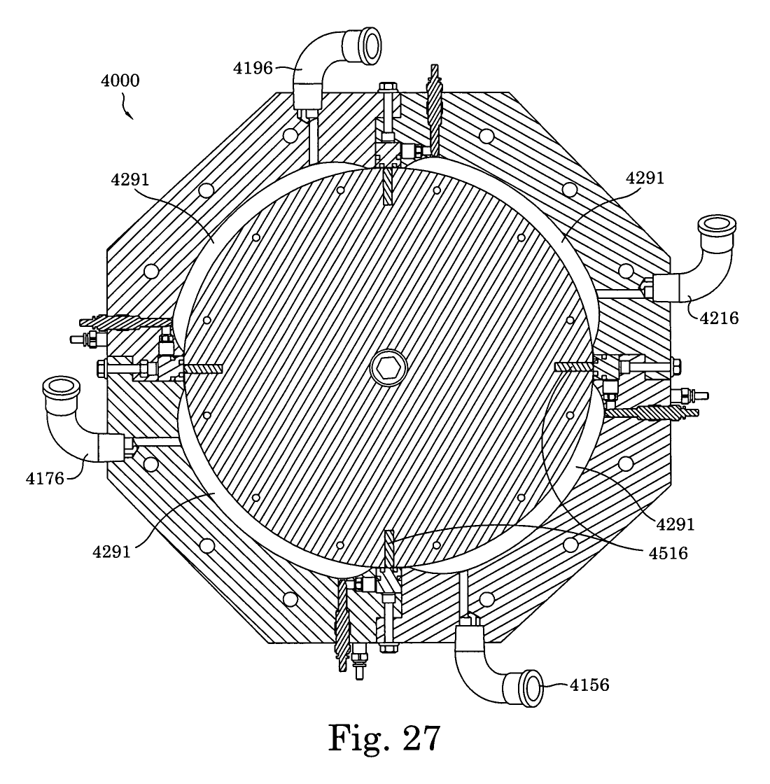

Turning now to FIG. 27, the rotor 4500 is shown to have rotated to a given position relative to the housing 4001, wherein the rotor seals 4516 are substantially aligned with the housing seals 4148. More specifically, the rotor 4500 is depicted to be in a position wherein the rotor seals 4516 are substantially adjacent to the housing seals 4148. As shown, FIGS. 26-28 depict substantially no space or gap between the rotor 4500 and the housing seals 4148. Accordingly, the vanes (i.e. rotor seals) 4516 have been pushed into their respective slots toward a retracted position. More specifically, the rotor seals 4516 can be retracted to as to be substantially flush with the outer periphery of the rotor 4500. It will be appreciated that, in this manner, the rotor seals 4516 can clear or pass over the housing seals 4148 as the rotor turns.

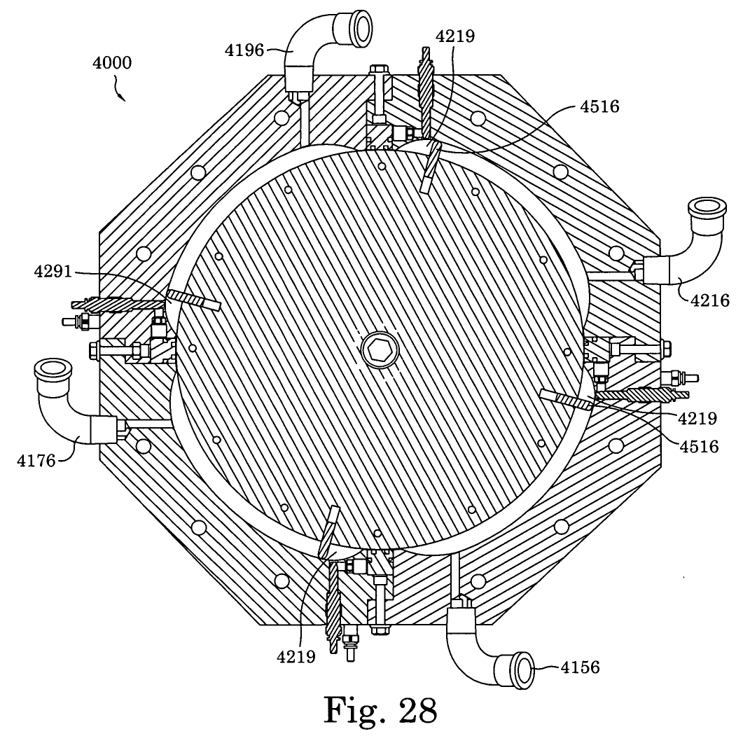

Turning now to FIG. 28, the rotor 4500 is shown to have continued to rotate to a given position wherein the vanes (i.e. rotor seals) 4516 have passed beyond the housing seals 4148. Moreover, the vanes 4516 have extended outwardly toward respective extended positions. Still referring to FIG. 28, at least a portion of a main combustion chamber 4291 has been formed between each housing seal 4148 and a trailing side of the nearest respective vane 4516. Each of these combustion chambers 4291 can be substantially adjacent to a respective air injector 919 and/or fuel injector 909, as depicted. Thus, in the given position of the rotor depicted in FIG. 28, fuel, air and/or air/fuel mixture can be introduced into the combustion chambers 4291 using the pre-combustion chambers as described above.

In response to introduction of fuel and air into the main combustion chambers 4291, a combustion event can take place therein. Combustion can be initiated by way of any of a number of manners including, but not limited to spark ignition (such as in an Otto Cycle engine) or compression ignition (such as in a Diesel Cycle engine). The occurrence of combustion within the combustion chamber 4291 can result in formation of high pressure gasses. Such formation of high pressure gasses within the combustion chamber 4291 while the rotor 4500 is substantially in the position depicted in FIG. 28 can result in the trailing side of each vane 4516 being pushed away from the nearest housing seal 4148. This can result in the production of mechanical power or torque in the form rotation of the rotor 4500 relative to the housing 4001.

Following the occurrence of combustion within the combustion chamber 4291, as described above, the combustion chamber can expand as the rotor 4500 turns in the exemplary clockwise direction. For example, following combustion, the rotor 4500 can turn from the position shown in FIG. 28 to the position shown in FIG. 26. When the rotor 4500 reaches the position depicted in FIG. 26, the respective exhaust ports 4156, 4176, 4196, 4256 for each combustion chamber are exposed to the exhaust gases. In this manner, the exhaust gases resulting from combustion can be substantially released or evacuated from the respective combustion chambers 4291. Moreover, as the rotor 4500 continues to rotate in a clockwise direction, the succeeding vanes 4516 can act to push or sweep the remaining exhaust gases substantially from the combustion chambers 4291. Combustion and exhaust can continue in this manner in accordance with one of a number of possible firing sequences to maintain operation and power output of the apparatus.

### Four Chamber Rocker Seal Version

Operation of a four chamber rocker seal embodiment of the apparatus is depicted in FIGS. 13, 21, 22, 23 and 24. Operation of the rocker seal embodiment can be substantially the same as that of the radial vane seal embodiment described immediately above with respect to FIGS. 25-28 except for the specific configuration and operation of the rotor seals. Specifically, the rocker type rotor seals, or rockers, 4120 may function by rocking within their respective chambers or means may be provided to cause true pivoting. Such versions can be constructed and operated rather than by reciprocating or sliding action of the rotor seals as in the radial vane seal embodiment.

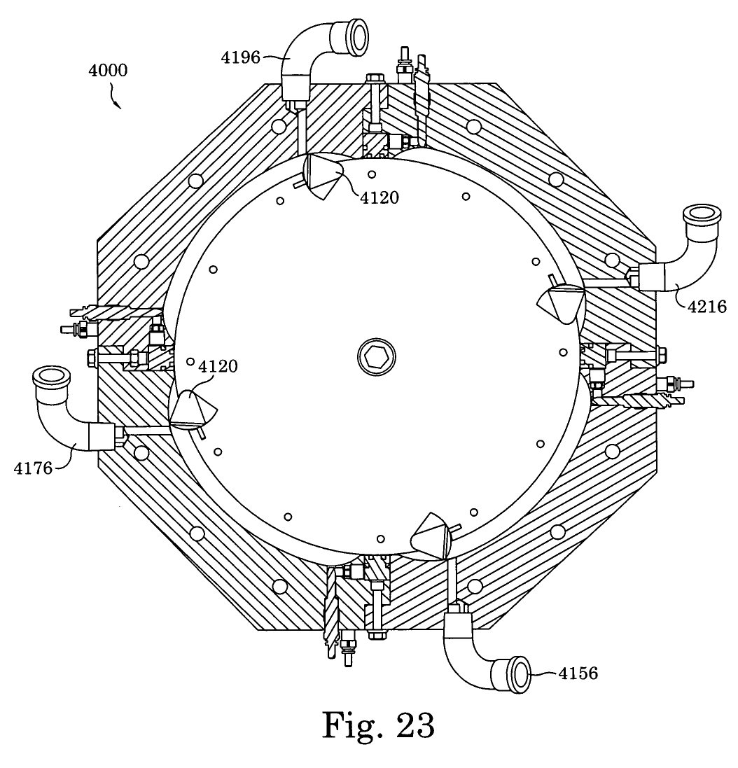

With reference to FIG. 23, each of the rocker seals 4120 can be substantially shaped as a cylindrical section or cylindrical wedge, as is depicted. Moreover, each rocker seal 4120 can define a small radius nose portion that is received into a complimentary small radius socket defined in the rotor 4100. This configuration can allow each rocker seal 4120 to pivot, or rock, about the small radius nose portion. Each of the rocker seals 4120 can be biased substantially outwardly. Such biasing of each rocker seal 4120 can be accomplished by way of a respective biasing member such as a spring or the like (not shown).

More specifically, the rocker seals 4120 can be biased outwardly toward an extended position so as to maintain substantial sealing contact or engagement with the inner wall of the housing 4001. As is described above with respect to FIGS. 26-28, the inner wall of the housing 4001 can act as a cam surface with respect to the rotor seals (e.g. rockers) 4120. Particularly, as depicted in FIG. 23, the rotor 4100 is shown to be in a given position, wherein each rocker 4120 is approaching a respective housing seal 4148. As the rotor 4100 continues to turn in a clockwise direction from its position depicted in FIG. 28, each rocker 4120 can be depressed or pushed toward a respective retracted position by the cam action provided by inner walls of the housing 4001, which can be configured to slope toward the outer periphery of the rotor 4100 as the wall approaches the housing seals 4148.

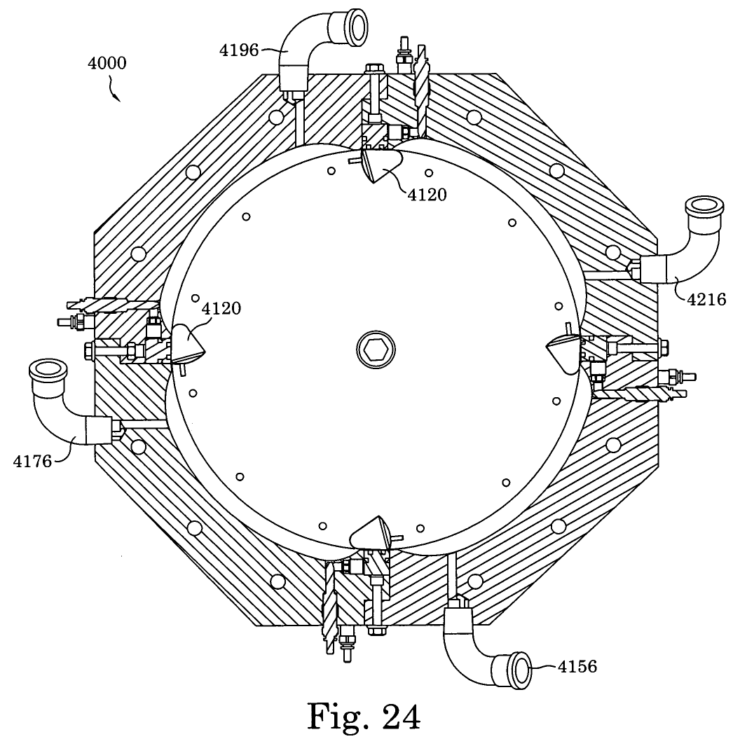

Turning now to FIG. 24, the rotor 4100 has rotated to a given position relative to the housing 4100, wherein the rockers 4120 are substantially adjacent to the housing seals 4148. It is seen that in the given position of the rotor 4100 as depicted, the rockers 4120 are illustratively shown to have been pushed toward a retracted position so as to be substantially flush or follow with the outer periphery of the rotor core 4301. In this manner, the rocker seals can clear or pass over the stator seals without substantial interference.

Turning now to FIG. 21, the rotor 4100 is shown to have continued to rotate to another given position, wherein the rockers 4120 have passed over the housing seals 4148. With the rotor 4100 in the position shown, air and/or fuel can be introduced into the combustion chamber 4291. The exemplary embodiment can also include a pre-combustion chamber 4280 associated with each respective combustion aide, such as combustion aide 4202. The pre-combustion chamber 4280 can be advantageously positioned adjacent to the respective combustion aide 4202. In accordance with at least one embodiment of the present disclosure, air and/or fuel can be introduced into the combustion chamber 4291 by way of the associated pre-combustion chamber 4280. Specifically, an initial charging portion of combustion chamber 4291 can be formed between each housing seal 4148 and a trailing side of the nearest rocker 4120. The air fuel mixture can be introduced into the initial charging portion of the combustion chamber through a passage adjacent to the part 4210, wherein such passage can include the pre-combustion chamber 4280.

The combustion chamber 4291 can be substantially adjacent to the fuel injector 909 and/or to the air injector 919, preferably immediately adjacent to the preferred pre-combustion chambers. Thus, fuel and/or air can be injected into each pre-combustion chamber achieving a possible charging action when the rotor 4100 is substantially in the position depicted in FIG. 21. Any aid to combustion can also be initiated or continued during any such charging phases of operation when a combustion chamber is to be active.

Following injection of fuel and/or air into the pre-combustion chamber, one or multiple combustion events can occur. Multiple events are achieved by multiple injections of the combustion materials during the segment of rotation wherein combustion in the main chamber is proceeding. More specifically fuel within each combustion chamber 4291 can be caused to ignite first in the pre-combustion chambers which are more easily maintained in a suitable hot condition by either the combustion therein or the glow plug or other combustion aid. Such initial combustion in the pre-combustion chamber then proceeds to each combustion chamber 4291 resulting in formation of high pressure gases, for example producing combustion using highly compressed air and highly pressurized fuel. The use of different fuels and/or operating regimes may result in substantially different operating pressures within the combustion chambers.

When air and fuel are injected under pressures in excess of 1000 pounds per square inch or greater the operational pressures experienced can be very high. Preferred injected air operating pressures can be in excess of 2000 pounds per square inch or greater, in some cases in excess of 3000 pounds per square inch or greater are preferred.

The formation of high pressure gasses within each combustion chamber 4290 when the rotor 4100 is substantially in the position shown in FIG. 21 can cause the respective rocker 4120 to be forced away from the nearest respective housing seal 4148 in a clockwise or other angular direction as dependent upon the orientation of the engine and components. This can result in the production of mechanical power and torque in the form of rotation of the rotor 4100.

The preferred engines according to the inventions can rotate at a variety of speed ranges depending on the size, operating conditions, and desired location in a vehicle among others. Engines such as the preferred models shown are expected to be able to idle at relatively low speeds of less than 100 revolutions per minute. This very slow idle speed aids in the conservation of fuel.

During loaded conditions the rotation speed or angular velocity will vary from the idle speeds to usually less than 2000 revolutions per minute. In currently preferred engines operation is from idle speed up to maximum operating speeds. However, the operating speeds are expected to be usually in the range of 500-1500 revolutions per minute under load, more preferably 500-800, even more preferably 700-750 revolutions per minute. The ideal angular speed may vary significantly depending upon the size or geometry of the engine.

Turning to FIG. 23, the rotor 4100 is shown to be in another given position, wherein the combustion chamber 4291 has expanded following combustion. Moreover, the exhaust ports 4156, 4176, 4196, 4256 have been exposed to the gases resulting from the recent combustion. Thus, the exhaust gases resulting from combustion can be vented or evacuated from the combustion chambers 4291 through the respective exhaust ports 4156, 4176, 4196, 4256. Continued rotation of the rotor 4100 in the clockwise direction from the position depicted in FIG. 23 can cause the succeeding rocker 4120 to substantially sweep the combustion chamber 4291 of exhaust gases.

### Alternative Numbers of Combustion Chambers

The illustrated embodiments show even numbers of combustion chambers except for the three-chamber embodiment 3000. Other constructions can use whatever number of combustion chambers as desired and are fold practically operational. Engines having from two up to sixteen have been contemplated as most desirable. But if an engine is to be used for extremely large power and torque applications, such as may now be used for gas turbines, then engines with even greater numbers of combustion chambers and associated rotor sections may prove desirable.

Additionally, in some situations it may be desirable to have multiple combustion housings joined in parallel, effectively side-by-side configuration. Such may be arranged so that torque is more evenly applied to a common or separate drive shaft by displacing the simultaneous angular positions of the rotor seals and combustion chambers. By utilizing increasing numbers of combustion chambers and increasing numbers of separate or conjoined rotors and combustion housings then almost perfectly even torque may be achieved.

Operation of Apparatus in Conjunction with Peripheral Devices

FIG. 34 is a schematic diagram depicting a number of peripheral devices relating to operation of an apparatus in accordance with at least one embodiment of the present disclosure. More particularly, fuel 901 can be supplied to a fuel pump or compressor 902. As explained above, the fuel 901 can be any of a number of possible specific types including, but not limited to, diesel oil, gasoline, liquified natural gas, liquified petroleum gas, butane, and propane.

The fuel pump 902 can be configured to pressurize the fuel 901 to a suitable pressure commensurate with the specific type and form of fuel used as well as with the specific type of combustion cycle employed (e.g. diesel cycle). From the fuel pump 902, the fuel 901 can be sent to fuel injector control valves 906. The fuel injector control valves 906 can include, for example, a pressure regulator valve or the like. From the fuel injector control valves 906, the fuel 901 can be sent to the fuel injectors 909. The fuel injectors 909 can then inject fuel 901 into the engine 2000, 3000, 4000, 6000, 8000 in accordance with predetermined operating conditions or schemes. More specifically, the fuel injectors 909 can inject the fuel 901 into one or more combustion chambers 200 of an engine.

Substantially simultaneously with the operations described immediately above with respect to FIG. 34, intake air 911 can be supplied through a check valve 912 to an air compressor 914. The air compressor 914 can have any of a number of specific forms and/or configurations suited to the specific parameters associated with a particular application. For example, such parameters can include fuel type, speed of operation of the engine, and the like. Examples of specific forms of the air compressor 914 include, but are not limited to, a positive displacement air pump or compressor, certain centrifugal air compressors, or an axial flow turbine compressor may be found suitable for some versions of the engines according hereto if operating characteristics are found operable, suitable or desirable in any particular design.

From the air compressor 914, pressurized intake air 911 can be sent to air injection control valves 916. The air injection control valves 916 can include, for example, a pressure regulator valve. From the air injection control valves 916, the intake air 911 can be sent to the air injectors 919. From the air injectors 919, the intake air 911 can be introduced into the engine 2000, 3000, 4000, 6000, 8000. More specifically, for example, the intake air 911 can be introduced into one or more combustion chambers 4290 from the air injectors 919.

Combustion, and more particularly a combustion event, can occur within the engine 2000, 3000, 4000, 6000, 8000 as is described in greater detail herein above. As the result of combustion within a combustion chamber 4291, for example, exhaust 4156, 4176, 4216 is produced. A turbo-charger 930 can be included to increase efficiency and/or performance of the engine. If a turbo-charger 930 is employed, the exhaust can be released from the engine to an exhaust turbine (not shown) of the turbo charger 930. After passing through the exhaust turbine of the turbo charger 930, the exhaust can be released to atmospheric pressure 940. An impeller portion (not shown) of the turbo charger 930 can be positioned within the intake stream between the check valve 912 and the air compressor 914. In this manner, a turbo charger 930 can pre-pressurize the intake air 911 before the intake air enters the air injection compressor 914.

Turning now to FIG. 35, another schematic diagram depicts various components of and peripheral devices employed with an apparatus 900 in accordance with at least one embodiment of the present disclosure. Specifically, various peripheral devices and/or components of an apparatus 900 can include a high pressure air compressor 913, a high pressure air tank 917, a high pressure air regulator 918, a high pressure air rail assembly 915, a high pressure fuel rail assembly 905, a fuel supply 901, a high pressure fuel pump 902, and a fuel pressure regulator 903.

Such components and/or devices can further include a throttle position sensor 960, a motor position sensor 970, exhaust oxygen sensors 980, exhaust temperature sensors 990, air injector components 916/919, and fuel injector components 906/909. The components of the apparatus 900 can also include a controller 950. The controller 950 can include, or can be substantially in the form of a processor and/or a digital memory device (not shown). The controller 950 can provide output commands as a function of various input signals and/or data.

For example, input signals and/or data can include various data generated by one or more of the throttle position sensor 960, the motor position sensor 970, the exhaust oxygen sensors 980 and the exhaust temperature sensors 990. Output commands of the controller 950 can include, for example, volume (e.g., flow rate) and/or pressure of fuel 901 and/or intake air 911 controllably delivered to the combustion chambers by the fuel injectors 909 and air injectors 919, respectively, as active combustion or non-active combustion chambers may found to be optimally operated. In this manner, power output, speed, as well as other engine parameters can be controlled.

### Modes of Operation Where All Chambers Fire Together

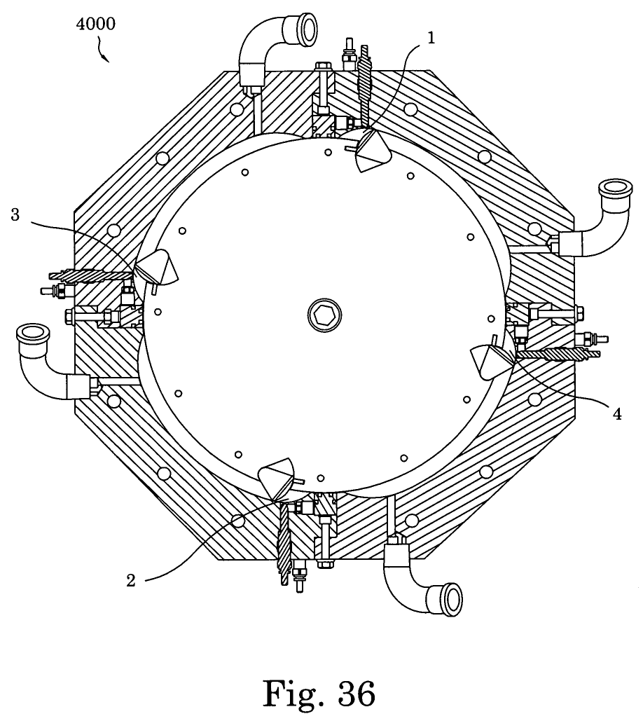

An engine in accordance with at least one embodiment of the present disclosure can have any one, or any combination, of a number of various firing orders and frequencies. The requirements needed and desired for optimal economy, power output, torque, or other performance objectives may vary. With reference to FIG. 36, an exemplary four chamber engine is depicted. For convenience each of the combustion chambers is labeled, 1, 2, 3, and 4, respectively. In accordance with one embodiment, all chambers 1-4 fire together.

For example, because of the configuration of the exemplary four chamber engine depicted, each combustion chamber can be fired four times for each revolution of the rotor. Because all four combustion chambers can be fired at the same time, and there are four positions for ignition, then sixteen combustion events may occur per revolution. The maximum number of combustion chambers that can be fired per revolution is dependent on the number of combustion chambers. However, it is not required that the combustion chambers fire four times per revolution.

As a further example, all combustion chambers can be fired at the same time, but only twice per revolution. This would provide a total of eight combustion chamber firings per revolution. Similarly, all combustion chambers can be fired at the same time, but only once per revolution. This would provide a total of four combustion chamber firings per revolution. Likewise, firing all combustion chambers at the same time, but only three times per revolution would provide a total of six combustion chamber firings per revolution.

A still further option would be to fire all combustion chambers at the same time, but only once every other revolution. This would provide an average of two combustion chamber firings per revolution. Thus, it is evident that when all four combustion chambers are fired at the same time, any number of average firings per revolution can be attained from a theoretical limit approaching zero to sixteen for the four chambered engine. Similar relationships apply to the engines with different numbers of combustion chambers.

### Modes of Operation Where Less Than All Chambers Fire Together

In accordance with at least some embodiments of the present disclosure, fewer than all combustion chambers are fired at the same time. For example, chambers 1 and 2 can be fired at the same time, and chambers 3 and 4 can be fired at the same time, provided that chambers 1 and 2 are not fired at the same time as chambers 3 and 4. Specifically, chambers 1 and 2 can be fired alternately with chambers 3 and 4.

In one example, chambers 1 and 2 are alternately fired with chambers 3 and 4, wherein each chamber is fired once per revolution. In another example, chambers 1 and 2 are fired once per revolution and chambers 3 and 4 are fired twice per revolution.

In yet another example, each chamber is fired twice per revolution. In still another example, chambers 1 and 2 are fired once every half of a revolution and chambers 3 and 4 are fired every three-quarters of a revolution. Thus a great number of combinations of chamber firings can be achieved when firing the chambers in pairs. Firing in opposing pairs or other balanced application of force to produce balanced torque are preferred in most constructions of engines according hereto.

### Modes of Operation Where Chambers Fire Alone

In accordance with still other operational embodiments of the present inventions, each of the chambers can be made to fire alone. For example, first chamber 1 can fire, then chamber 3 can fire, then chamber 2 can fire, then chamber 4 can fire. As a further example, first chamber 1 can fire, then chamber 2 can fire, then chamber 4 can fire, then chamber 3 can fire. This can occur at various frequencies of combustion.

### More About Methods Performed

In accordance with at least one embodiment of the present disclosure, an engine can be operated such that the frequency of combustion events per revolution is greater than the number of combustion chambers of the engine. For example, if an engine has four combustion chambers, the engine can be operated in accordance with at least one embodiment of the present disclosure such that the frequency of combustion events per revolution is greater than four.

Conversely, in accordance with at least one embodiment of the present disclosure, an engine can be operated such that the frequency of combustion events per revolution is less than the number of combustion chambers of the engine. For example, if an engine has four combustion chambers, the engine can be operated in accordance with at least one embodiment of the present disclosure such that the frequency of combustion events per revolution is less than four.

Moreover, in accordance with at least one embodiment of the present disclosure, an engine can be operated such that the frequency of combustion events per revolution is the same as the number of combustion chambers of the engine. For example, if an engine has four combustion chambers, the engine can be operated in accordance with at least one embodiment of the present disclosure such that the four combustion events occur per revolution.

In accordance with yet another embodiment of the present disclosure, an engine can be operated in a manner such that combustion events occur in opposing pairs. More specifically, in an engine having an even number of combustion chambers and an even number of rotor seals and associated rotor components, two combustion events occur substantially simultaneously in combustion chambers located on substantially opposite sides of the engine housing. Such combustion in opposing pairs can occur at a frequency that is substantially variable or that is substantially non-variable.

Control of ignition frequency and patterns of firing can also be done to shift from one chamber to another or from one pair of opposing chambers to another pair to help maintain the combustion chambers in a heated condition or reduced to achieve lower operating temperatures as desired for operational, life of engine, maintenance costs or other considerations.

### Methods Concerning Manner of Use and Utility of the Inventions

One or more aspects of the inventions taught herein can be employed with or in place of various types of power producing apparatus, and in particular, with or in place of various types of internal combustion engines. One or more teachings of the present disclosure can be employed to produce power in any of a number of various applications, including stationary, automotive, aerospace, and other applications now known or hereafter developed.

Benefits associated with one or more aspects of the inventions taught herein include reduction of reciprocating mass compared with conventional reciprocating internal combustion engines. More specifically, a high proportion of moving machine component mass is purely rotational compared with conventional reciprocating internal combustion engines. Benefits associated with one or more aspects of the inventions taught herein also include a low moving parts count compared with conventional reciprocating internal combustion engine designs.

More about Preferred Manners of Making

Various portions and components of apparatus within the scope of the inventions, including for example, structural components, can be formed by one or more various suitable manufacturing processes known to those in the art of building rotating machinery, and specifically to those in the art of building internal combustion engines. Such manufacturing processes can include, but are not limited to, forging, casting, milling, drilling, turning, grinding and the like. It is to be understood that one or more components of apparatus within the scope of the inventions can be made in accordance with means and/or processes not yet known.

Similarly, various portions and components of apparatus within the scope of the inventions can be made from suitable materials known to those in the art of machine building, and more particularly to those in the art of building internal combustion engines. Such materials can include, but are not limited to, iron, various types of steel, aluminum including various types of aluminum alloy, various other metals, as well as various composite materials. Furthermore, it is to be understood that one or more components of apparatus within the scope of the inventions can be made from one or more materials not yet known.

### Interpretation Notes

The above description has set out various features, functions, methods and other aspects of the inventions. This has been done with regard to the currently preferred embodiments thereof. Time and further development may change the manner in which the various aspects are implemented. Such aspecs may further be added to by the language of the claims which are incorporated by reference hereinto as originally filed.

The scope of protection accorded the inventions as defined by the claims is not intended to be necessarily limited to the specific sizes, shapes, features or other aspects of the currently preferred embodiments shown and described. The claimed inventions may be implemented or embodied in other forms while still being within the concepts shown, described and claimed herein. Also included are equivalents of the inventions which can be made without departing from the scope of concepts properly protected hereby.

I claim:

1. An apparatus forming a rotary internal combustion engine, comprising:
a stator;
at least one combustion housing forming at least part of said stator;
an interior cavity substantially enclosed within said at least one combustion housing when assembled;
a drive shaft which extends from the interior cavity;
a rotor which is cylindrical and has a peripheral channel, said rotor being mounted within the interior cavity and connected to said drive shaft for rotation therewith;
a plurality of combustion recesses formed along interior walls of the at least one combustion interior cavity in opposing relationship to the rotor peripheral channel;
a plurality of combustion chambers formed between peripheral portions of the rotor and the combustion housing interior walls;
plural stationary combustion chamber seals mounted in the at least one combustion housing and extending inwardly toward the cylindrical rotor for sealing against portions of the rotor to in part define the combustion chambers;
plural rotor seals mounted for movement upon the cylindrical rotor near a periphery of said at least one rotor within said peripheral channel, the rotor seals being mounted upon said at least one cylindrical rotor in a manner adapted to allow movement which includes radial movement to seal with the at least one interior cavity and the at least one combustion recess as the rotor rotates;
plural fuel injectors for injecting pressurized fuel into the plurality of combustion chambers adjacent to said plural stationary combustion chamber seals;
plural air injectors for injecting pressurized combustion air into the plurality of combustion chambers adjacent to said plural stationary combustion chamber seals;
plural exhaust ports to allow release of combustion gases from the plurality of combustion chambers.

2. An apparatus according to claim 1 wherein the rotor seals are radial vane seals that move within vane receptacles formed in peripheral portions of the rotor.

3. An apparatus according to claim 1 wherein the rotor seals are vane seals that move within vane receptacles formed in peripheral portions of the rotor and further comprising vane biasing which urges the vane seals outward against the combustion housing interior walls and the combustion recesses.

4. An apparatus according to claim 1 wherein the rotor seals are rockers that move within rocker receptacles formed in peripheral portions of the rotor.

5. An apparatus according to claim 1 wherein the rotor seals are rockers that move within rocker receptacles formed in peripheral portions of the rotor and further comprising rocker seals that seal between the rockers and rocker receptacles.

6. An apparatus according to claim 1 wherein there are rotor seals and stationary combustion chamber seals at approximately equal angular spacings between the respective seals.

7. An apparatus according to claim 1 wherein there are rotor seals and stationary combustion chamber seals at approximately equal angular spacings between the respective seals and there are an even number of said rotor seals and stationary combustion chamber seals to provide forces at diametrically opposing positions upon said rotor to help apply diametrically balanced torque on the rotor.

8. An apparatus according to claim 1 and further comprising a timing wheel which is sensed to aid in operation of the apparatus.

9. An apparatus according to claim 1 and further comprising at least one air compressor connected to provide compressed air to said plural air injectors.

10. An apparatus forming a rotary internal combustion engine, comprising:
a combustion housing forming at least part of a stator, said combustion housing having housing pieces, the housing pieces having interior walls with combustion recesses formed therein;
an interior cavity substantially enclosed within said combustion housing when the apparatus is assembled;
a drive shaft extending within the engine;
a rotor which is connected to said drive shaft and mounted in the interior cavity for rotation;
a plurality of combustion chambers formed within the interior cavity between the combustion recesses and the rotor;
radially movable rotor seals mounted upon said rotor which follow the interior walls with combustion recesses;
plural stationary combustion chamber seals which are positioned to seal against the rotor.

11. An apparatus according to claim 10 wherein the rotor seals are radial vane seals that move within vane receptacles formed in peripheral portions of the rotor.

12. An apparatus according to claim 10 wherein the rotor seals are vane seals that move within vane receptacles formed in peripheral portions of the rotor and further comprising vane biasing which urges the vane seals outward against the combustion housing interior walls and the combustion recesses.

13. An apparatus according to claim 10 wherein the rotor seals are rockers that move within rocker receptacles formed in peripheral portions of the rotor.

14. An apparatus according to claim 10 wherein the rotor seals are rockers that move within rocker receptacles formed in peripheral portions of the rotor and further comprising rocker seals that seal between the rockers and rocker receptacles.

15. An apparatus according to claim 10 wherein there are rotor seals and stationary combustion chamber seals at approximately equal angular spacings between the respective seals.

16. An apparatus according to claim 10 wherein there are rotor seals and stationary combustion chamber seals at approximately equal angular spacings between the respective seals and there are an even number of said rotor seals and stationary combustion chamber seals to provide forces at diametrically opposing positions upon said rotor to help apply diametrically balanced torque on the rotor.

17. An apparatus according to claim 10 and further comprising a timing wheel which is sensed to aid in operation of the apparatus.

18. A method for operating a rotary engine, comprising:
selecting a rotary engine having a housing with substantially enclosed interior compartment, a rotor mounted for movement within said interior compartment, a plurality of combustion chambers recesses formed along interior walls of the housing interior compartment, movable rotor seals along peripheral portions of the rotor, and housing seals which engage peripheral portions of the rotor to define a plurality of combustion chambers;
controllably injecting pressurized fuel into the combustion compartments;
controllably injecting pressurized air into the combustion compartments;
controlling the frequency of combustion events which occur to vary the power or torque developed by the rotary engine.

19. A method according to claim 18 wherein the combustion events occur at a frequency per revolution which is the number of said plurality of combustion chambers or less.

20. A method according to claim 18 wherein the combustion events occur at a frequency per revolution which is less than the number of said plurality of combustion chambers.

21. A method according to claim 18 wherein the combustion events occur at a frequency per revolution which is more than the number of said plurality of combustion chambers.

22. A method according to claim 18 wherein the combustion events occur in opposing pairs.

23. A method according to claim 18 wherein the combustion events occur in opposing pairs at a frequency which is variable.

24. A method according to claim 18 wherein the combustion events occur in opposing pairs which change over time so that different pairs of combustion chambers are used at different times in the operation of the engine.

25. A method according to claim 18 wherein the combustion events occur in different combustion chambers which change over time so that different combustion chambers are used at different times in the operation of the engine.

26. A method according to claim 18 wherein the combustion events occur in sets containing multiple combustion chambers spaced at equal angular positions.

27. A method of operating a rotary engine, comprising:
selecting a rotary engine having a housing with substantially enclosed interior compartment, a rotor mounted for movement within the interior compartment, a plurality of combustion chamber recesses formed along interior walls of the housing interior compartment, movable rotor seals along peripheral portions of the rotor, and housing seals which engage peripheral portions of the rotor to define a plurality of combustion chambers;
controlling injection of fuel and air into the combustion chambers to produce a first frequency of combustion events per revolution of the rotor to produce an associated power output;
receiving an input command to change the power output;
in response to receiving the input command, controlling injection of fuel and air into the combustion chambers to produce a second frequency of combustion events per revolution of the rotor.

28. A method according to claim 27, wherein:
the input command is a command to increase the power output;
the second frequency is greater than the first frequency.

29. A method according to claim 27, wherein:
the input command is a command to decrease the power output;
the second frequency is less than the first frequency.

30. A method according to claim 27, wherein:
the input command is a command to increase the power output by a given multiple;
the second frequency exceeds the first frequency by the given multiple.

31. A method according to claim 27, wherein:
the input command is a command to decrease the power output by a given multiple;
the first frequency exceeds the second frequency by the given multiple.

32. A method according to claim 27, wherein:
the input command is a command to produce maximum power output;
the second frequency is equal to the product of the number of rotor seals and the number of housing seals.

33. A method of operating a rotary engine, comprising:
selecting a rotary engine having a housing with substantially enclosed interior compartment, a rotor mounted for movement within the interior compartment, a plurality of combustion chambers recesses formed along interior walls of the housing interior compartment, movable rotor seals along peripheral portions of the rotor, and housing seals which engage peripheral portions of the rotor to define a plurality of combustion chambers;
controlling injection of fuel into the combustion chambers to produce a combustion event in each of a first fraction of the combustion chambers per revolution of the rotor to produce an associated power output;
receiving an input command to change the power output;
in response to receiving the input command, controlling injection of fuel into the combustion chambers to produce a combustion event in a second fraction of combustion events per revolution of the rotor.

34. A method according to claim 33, wherein:
the input command is a command to increase the power output;
the second fraction is greater than the first fraction.

35. A method according to claim 33, wherein:
the input command is a command to decrease the power output;
the second fraction is less than the first fraction.

36. A method according to claim 33, wherein:
the input command is a command to increase the power output by a given multiple;
the second fraction exceeds the first fraction by the given multiple.

37. A method according to claim 33, wherein:
the input command is a command to decrease the power output by a given multiple;
the first fraction exceeds the second fraction by the given multiple.

38. A method according to claim 33, wherein the input command is a command to produce maximum power output.

39. An apparatus forming a rotary internal combustion engine, comprising:
a combustion housing forming at least part of a stator, the housing having interior walls with combustion recesses formed therein;
an interior cavity substantially enclosed within the combustion housing when the apparatus is assembled;
a drive shaft extending within the combustion housing;
a rotor which is connected to the drive shaft and mounted in the interior cavity for rotation;
a plurality of combustion chambers formed within the interior cavity between the combustion recesses and the rotor;
radially movable rotor seals mounted upon the rotor which follow the interior walls with combustion recesses;
plural stationary combustion chamber seals which are positioned to seal against the rotor;
a control system adapted to cause a selected frequency of combustion events per revolution of the rotor to produce an associated power output, wherein each combustion event occurs within one of the plurality of combustion chambers.

40. An apparatus according to claim 39, the control system further adapted to:
receive an input command to change the amount of power output;
in response to receiving the input command, cause a change in the selected frequency of combustion events per revolution.

41. An apparatus according to claim 39, the control system further adapted to:
receive an input command to change the amount of power output;
in response to receiving the input command, cause a change in pressure developed in the combustion events.

42. An apparatus according to claim 39, the control system further adapted to:
receive an input command to change the amount of power output;
in response to receiving the input command, cause a change in pressure developed in the combustion events and cause a change in frequency of combustion events per revolution.

43. An apparatus according to claim 39, the control system further adapted to:
receive an input command to increase the power output;
in response to receiving the input command, cause an increase in the frequency of combustion events per revolution.

44. An apparatus according to claim 39, the control system further adapted to:
receive an input command to increase the power output;
in response to receiving the input command, cause an increase change in pressure developed in the combustion events.

45. An apparatus according to claim 39, the control system further adapted to:
receive an input command to decrease the power output;
in response to receiving the input command, cause a decrease in the frequency of combustion events per revolution.

46. An apparatus according to claim 39, the control system further adapted to:
receive an input command to decrease the power output;
in response to receiving the input command, cause a decrease change in pressure developed in the combustion events.

47. An apparatus forming a rotary internal combustion engine, comprising:
a combustion housing forming at least part of a stator, the housing having interior walls with combustion recesses formed therein;
an interior cavity substantially enclosed within the combustion housing when the apparatus is assembled;
a drive shaft extending within the combustion housing;
a rotor which is connected to the drive shaft and mounted in the interior cavity for rotation;
a plurality of combustion chambers formed within the interior cavity between the combustion recesses and the rotor;
radially movable rotor seals mounted upon the rotor which follow the interior walls with combustion recesses;
plural stationary combustion chamber seals which are positioned to seal against the rotor;
a control system adapted to cause a combustion event to occur in each of a selected number of the combustion chambers per revolution of the rotor to produce an associated power output.

48. An apparatus of claim 47, the control system further adapted to:
receive an input command to change the power output;
in response to receiving the input command, change the number of combustion chambers in which a combustion event occurs per revolution.

49. An apparatus of claim 47, the control system further adapted to:
receive an input command to increase the power output;
in response to receiving the input command, increase the number of combustion chambers in which a combustion event occurs per revolution.

50. An apparatus of claim 47, the control system further adapted to:
receive an input command to decrease the power output;
in response to receiving the input command, decrease the number of combustion chambers in which a combustion event occurs per revolution.

51. A method of operating a rotary engine, comprising:
selecting a rotary engine having a housing with substantially enclosed interior compartment, a rotor mounted for movement within the interior compartment, a plurality of combustion chambers recesses formed along interior walls of the housing interior compartment, movable rotor seals along peripheral portions of the rotor, and housing seals which engage peripheral portions of the rotor to define a plurality of combustion chambers;
controlling injection of fuel into the combustion chambers to produce a sequence of successive singular combustion events that progresses circuitously about the housing.

52. A method according to claim 51, wherein the controlling step also includes controlling injection of air under pressure into active combustion chambers to effect combustion events.

53. A method according to claim 51, wherein the sequence of combustion events progresses in a direction opposite of a direction of rotation of the rotor during operation of the apparatus.

54. A method according to claim 51, wherein the sequence of combustion events progresses in a direction of rotation of the rotor during operation of the apparatus.

55. A method according to claim 51, wherein the sequence of combustion events initially progresses in a first direction relative to the rotation of the rotor, the method further comprising:
receiving an input command to change a power output of the apparatus;
in response to receiving the input command, reversing the direction of progression of the sequence of combustion events.

56. An apparatus forming a rotary internal combustion engine, comprising:
a combustion housing forming at least part of a stator, the housing having interior walls with combustion recesses formed therein;
an interior cavity substantially enclosed within the combustion housing when the apparatus is assembled;
a drive shaft extending within the combustion housing;
a rotor which is connected to the drive shaft and mounted in the interior cavity for rotation;
a plurality of combustion chambers formed within the interior cavity between the combustion recesses and the rotor;
radially movable rotor seals mounted upon the rotor which follow the interior walls with combustion recesses;
plural stationary combustion chamber seals which are positioned to seal against the rotor;
a control system adapted to produce a sequence of successive singular combustion events that progresses circuitously about the housing.

57. An apparatus forming a rotary internal combustion engine, comprising:
a combustion housing forming at least part of a stator, the combustion housing having interior walls with combustion recesses formed therein;
an interior cavity substantially enclosed within the combustion housing when the apparatus is assembled;
a drive shaft extending within the combustion housing;
a rotor which is connected to the drive shaft and mounted in the interior cavity for rotation, the rotor defining a peripheral, outwardly facing groove;
a plurality of combustion chambers formed within the interior cavity between the combustion recesses and the groove;
radially movable rotor seals mounted within the groove which follow the interior walls with combustion recesses;
plural stationary combustion chamber seals which are positioned to protrude into the groove and to seal against the rotor.

58. An apparatus according to claim 57, wherein the groove is substantially in the form of an approximately U-shaped channel.

59. An apparatus according to claim 57, wherein the groove is substantially in the form of a channel comprising a pair of substantially flat walls in mutual juxtaposition, and a substantially flat floor extending between the walls.

60. An apparatus according to claim 57, the rotor comprising:
a circular rotor core of a first diameter;
a pair of circular rotor sides each of a second diameter greater than the first diameter, wherein the rotor core is secured between the pair of rotor sides.

61. An apparatus according to claim 57, the rotor comprising:
a rotor core substantially in the form of a flat disk of a first diameter;
a pair of rotor sides, each substantially in the form of a flat disk of a second diameter greater than the first diameter, wherein the rotor core is secured between the pair of rotor sides.

62. An apparatus according to claim 57, wherein the groove is substantially in the form of a channel comprising a pair of substantially flat walls in mutual juxtaposition, and a substantially flat floor extending between the walls, the rotor comprising:
a rotor core substantially in the form of a flat disk of a first diameter;
a pair of rotor sides, each substantially in the form of a flat disk of a second diameter greater than the first diameter, wherein the rotor core is secured between the pair of rotor sides, whereby:
a portion of the rotor core forms the channel floor;
a portion of each rotor side forms a respective channel side.

63. An apparatus forming a rotary internal combustion engine, comprising:
a combustion housing forming at least part of a stator, the combustion housing having interior walls with combustion recesses formed therein;
an interior cavity substantially enclosed within the combustion housing when the apparatus is assembled;
a drive shaft extending within the combustion housing;
a rotor which is connected to the drive shaft and mounted in the interior cavity for rotation, the rotor comprising a center core between a pair of sides;
a plurality of combustion chambers formed within the interior cavity between the combustion recesses and the groove;
radially movable rotor seals mounted within the groove which follow the interior walls with combustion recesses;
plural stationary combustion chamber seals which are positioned to protrude into the groove and to seal against the rotor.

64. An apparatus according to claim 63, wherein each of the pair of sides is fastened to the core.

65. An apparatus according to claim 63, wherein the core is substantially in the form of a flat disk.

66. An apparatus according to claim 63, wherein each of the sides is substantially in the form of a flat disk.

67. An apparatus according to claim 63, wherein each of the side and the core is substantially in the form of a flat disk.

68. A method for operating a rotary engine, comprising:
selecting a rotary engine having a housing with substantially enclosed interior compartment, a rotor mounted for rotation within the interior compartment, a circumferential groove formed on the periphery of the rotor, a plurality of recesses formed along interior walls of the housing interior compartment, rotor seals movably mounted within the groove, and housing seals which engage the groove to define a plurality of combustion chambers;
causing at least one combustion event to occur within at least one combustion chamber thereby moving the rotor.

69. A method for operating a rotary engine, comprising:
selecting a rotary engine having a housing with substantially enclosed interior compartment, a rotor mounted for rotation within the interior compartment, the rotor comprising a core secured between a pair of sides, a plurality of recesses formed along interior walls of the housing interior compartment, rotor seals movably supported by the core, and housing seals which engage the rotor to define a plurality of combustion chambers;
causing at least one combustion event to occur within at least one combustion chamber thereby moving the rotor.

70. An apparatus forming a rotary internal combustion engine, comprising:
a combustion housing forming at least part of a stator, the combustion housing having interior walls with combustion recesses formed therein;
an interior cavity substantially enclosed within the combustion housing when the apparatus is assembled;
a drive shaft extending within the combustion housing;
a rotor which is connected to the drive shaft and mounted in the interior cavity for rotation, the rotor defining a peripheral, outwardly facing groove;
a plurality of combustion chambers formed within the interior cavity between the combustion recesses and the groove;
plural stationary combustion chamber seals which are positioned to protrude into the groove and to seal against the rotor;
at least one pivotable rotor seal mounted within the groove to follow the interior walls with combustion recesses.

71. An apparatus according to claim 70, wherein the rotor seal is pivotable.

72. An apparatus according to claim 70, wherein the at least one rotor seal is substantially wedge-shaped.

73. An apparatus according to claim 70, wherein the at least one rotor seal is substantially wedge-shaped and has a leading edge substantially about which the seal is pivotable.

74. An apparatus according to claim 70, wherein the at least one rotor seal leading edge which rocks.

75. An apparatus according to claim 70, wherein:
a seal recess is defined in the groove;
the at least one rotor seal fits substantially within the recess.

76. An apparatus according to claim 70, wherein:
the at least one rotor seal is substantially wedge-shaped;
the at least one rotor seal has a substantially rounded leading edge;
a seal recess is defined in the groove;
the seal recess has a substantially rounded pocket;
the rounded leading edge is substantially captured within the pocket and is movable therein.

77. An apparatus according to claim 70, wherein the rotor seal extends across the groove.

78. An apparatus according to claim 70, wherein the at least one rotor seal is biased toward an extended position.

79. An apparatus forming a rotary internal combustion engine, comprising:
a combustion housing forming at least part of a stator, the combustion housing having interior walls with combustion recesses formed therein;
an interior cavity substantially enclosed within the combustion housing when the apparatus is assembled;
a drive shaft extending within the combustion housing;
a rotor which is connected to the drive shaft and mounted in the interior cavity for rotation, the rotor defining a peripheral, outwardly facing groove and at least one recess having a substantially rounded pocket, wherein the recess extends across the groove;
a plurality of combustion chambers formed within the interior cavity between the combustion recesses and the groove;
plural stationary combustion chamber seals which are positioned to protrude into the groove and to seal against the rotor;
at least one substantially wedge-shaped rotor seal having a substantially rounded leading edge captured in the pocket, thereby movable therein to follow the interior walls with combustion recesses.

80. An apparatus according to claim 79, wherein the at least one rotor seal is biased toward an extended position.

81. An apparatus according to claim 79, further comprising a seal element disposed between the rotor and the rotor seal.

82. An apparatus according to claim 79, wherein the rotor seal has a leading edge substantially on which the rotor seal is pivotable and a trailing edge, the apparatus further comprising a seal element disposed between the trailing edge of the rotor seal and the rotor.

83. An apparatus according to claim 79, wherein the rotor seal has a leading edge substantially on which the rotor seal is pivotable and a trailing edge, the apparatus further comprising a seal element disposed between the trailing edge of the rotor seal and the rotor, the seal element operatively secured to the rotor.

84. An apparatus according to claim 79, wherein the rotor seal has a leading edge substantially on which the rotor seal is rocks within a receptacle.

85. A method for operating a rotary engine, comprising:
selecting a rotary engine having a housing with substantially enclosed interior compartment, a rotor mounted for rotation within the interior compartment, a circumferential groove formed on the periphery of the rotor, a plurality of recesses formed along interior walls of the housing interior compartment, pivotable rotor seals movably mounted within the groove, and housing seals which engage the groove to define a plurality of combustion chambers;
causing at least one combustion event to occur within at least one combustion chamber thereby moving the rotor.

86. An apparatus forming a rotary internal combustion engine, comprising:
a combustion housing forming at least part of a stator, the combustion housing having interior walls with combustion recesses formed therein;
an interior cavity substantially enclosed within the combustion housing when the apparatus is assembled;
a drive shaft extending within the combustion housing;
a rotor which is connected to the drive shaft and mounted in the interior cavity for rotation, the rotor defining a peripheral, outwardly facing groove;
a plurality of combustion chambers formed within the interior cavity between the combustion recesses and the groove;
plural stationary combustion chamber seals which are positioned to protrude into the groove and to seal against the rotor;
at least one substantially radially slidable rotor seal mounted within the groove to follow the interior walls with combustion recesses.

87. An apparatus according to claim 86, wherein the rotor seal is radially movable at a fixed point relative to the rotor.

88. An apparatus according to claim 86, wherein the at least one rotor seal has a substantially constant cross section along a substantially radial dimension.

89. An apparatus according to claim 86, wherein the at least one rotor seal is substantially slidable along a substantially radially oriented path.

90. An apparatus according to claim 86, wherein:
a seal receptacle is defined in the groove;
the at least one rotor seal is substantially slidable within the receptacle.

91. An apparatus according to claim 86, wherein the rotor seal extends across the groove.

92. An apparatus according to claim 86, wherein the at least one rotor seal is biased toward an extended position.

93. An apparatus forming a rotary internal combustion engine, comprising:
a combustion housing forming at least part of a stator, the combustion housing having interior walls with combustion recesses formed therein;
an interior cavity substantially enclosed within the combustion housing when the apparatus is assembled;
a drive shaft extending within the combustion housing;
a rotor which is connected to the drive shaft and mounted in the interior cavity for rotation, the rotor defining a peripheral, outwardly facing groove and at least one seal receptacle defined within the groove;
a plurality of combustion chambers formed within the interior cavity between the combustion recesses and the groove;
plural stationary combustion chamber seals which are positioned to protrude into the groove and to seal against the rotor;
at least one rotor seal slidably disposed within the receptacle and is substantially radially movable to follow the interior walls of the combustion recesses during rotation of the rotor.

94. An apparatus according to claim 93, wherein the at least one rotor seal is biased toward an extended position.

95. A method for operating a rotary engine, comprising:
selecting a rotary engine having a housing with substantially enclosed interior compartment, a rotor mounted for rotation within the interior compartment, a circumferential groove formed on the periphery of the rotor, a plurality of recesses formed along interior walls of the housing interior compartment, rotor seals radially movable within the groove to substantially seal against the recesses, and housing seals which engage the groove to define a plurality of combustion chambers;
causing at least one combustion event to occur with controllably varying frequencies within plural combustion chambers thereby moving the rotor using different combustion chambers under different operating conditions.

96. An apparatus forming a rotary internal combustion engine, comprising:
a combustion housing forming at least part of a stator, said combustion housing having housing pieces, the housing pieces having interior walls with combustion recesses formed therein;
an interior cavity substantially enclosed within said combustion housing when the apparatus is assembled;
a drive shaft extending within the combustion housing;
a rotor which is connected to said drive shaft and mounted in the interior cavity for rotation, the rotor comprising a center portion positioned between a pair of end portions;
a plurality of combustion chambers formed within the interior cavity between the combustion recesses and the rotor;
radially movable rotor seals mounted upon said rotor which follow the interior walls with combustion recesses;
plural stationary combustion chamber seals which are positioned to seal against the rotor.

97. An apparatus according to claim 96, wherein the rotor center portion comprises a rotor core substantially in the form of a circular disk.

98. An apparatus according to claim 96, wherein each of the pair of rotor end portions comprises a rotor side substantially in the form of a circular disk.

99. An apparatus according to claim 96, wherein each of the pair of rotor end portions comprises a rotor side substantially in the form of a circular disk, wherein each rotor side is of a substantially similar size.

100. An apparatus according to claim 96, wherein:
the rotor center portion comprises a rotor core substantially in the form of a circular disk;
each of the pair of rotor end portions comprises a rotor side portion substantially in the form of a circular disk.

101. An apparatus forming a rotary internal combustion engine, comprising:
a combustion housing forming at least part of a stator, said combustion housing having housing pieces, the housing pieces having interior walls with combustion recesses formed therein;
an interior cavity substantially enclosed within said combustion housing when the apparatus is assembled;
a drive shaft extending within the combustion housing;
a rotor which is connected to said drive shaft and mounted in the interior cavity for rotation, the rotor comprising a rotor core positioned between a pair of rotor sides;
a plurality of combustion chambers formed within the interior cavity between the combustion recesses and the rotor;
radially movable rotor seals mounted upon said rotor which follow the interior walls with combustion recesses;
plural stationary combustion chamber seals which are positioned to seal against the rotor.

102. An apparatus according to claim 101, wherein:
the rotor core is substantially in the form of a circular disk of a given diameter;
each of the rotor sides is substantially in the form of a circular disk of a respective diameter different from the given diameter.

103. An apparatus according to claim 101, wherein:
the rotor core is substantially in the form of a flat circular disk of a given diameter;
each of the rotor sides is substantially in the form of a circular disk of a respective diameter different from the given diameter.

104. An apparatus according to claim 101, wherein:
the rotor core is substantially in the form of a flat circular disk of a given diameter;
each of the rotor sides is substantially in the form of a flat circular disk of a respective diameter different from the given diameter.

105. An apparatus according to claim 101, wherein:
the rotor core is substantially in the form of a circular disk of a first diameter;
each of the rotor sides is substantially in the form of a circular disk of a second diameter.

106. An apparatus according to claim 101, wherein:
the rotor core is substantially in the form of a circular disk;
each of the rotor sides is substantially in the form of a circular disk;
each of the rotor sides is substantially similar in diameter.

107. An apparatus according to claim 101, wherein:
the rotor core is substantially in the form of a circular disk of a first diameter;
each of the rotor sides is substantially in the form of a circular disk of a second diameter that is greater than the first diameter.

108. An apparatus according to claim 101, wherein:
the rotor core is substantially in the form of a flat circular disk of a first diameter;
each of the rotor sides is substantially in the form of a flat circular disk of a second diameter that is greater than the first diameter.

109. An apparatus according to claim 101, wherein the rotor core and rotor sides are fastened together.

110. A method for operating a rotary engine, comprising:
selecting a rotary engine having a housing with substantially enclosed interior compartment, a rotor mounted for movement within said interior compartment, the rotor comprising a center portion positioned between a pair of outer portions, a plurality of combustion chambers recesses formed along interior walls of the housing interior compartment, movable rotor seals along peripheral portions of the rotor, and housing seals which engage peripheral portions of the rotor to define a plurality of combustion chambers;
controllably injecting pressurized fuel into the combustion compartments;
controllably injecting pressurized air into the combustion compartments;
controlling the frequency of combustion events which occur to vary the power or torque developed by the rotary engine.

111. An apparatus forming a rotary internal combustion engine, comprising:
a stator comprising a plurality of adjoining combustion housing sections;
at least one combustion housing forming at least part of said stator;
an interior cavity substantially enclosed within said at least one combustion housing when assembled;
a drive shaft which extends from the interior cavity;
a rotor which is cylindrical and has a peripheral channel, said rotor being mounted within the interior cavity and connected to said drive shaft for rotation therewith;
a plurality of combustion recesses formed along interior walls of the at least one combustion interior cavity in opposing relationship to the rotor peripheral channel;
a plurality of combustion chambers formed between peripheral portions of the rotor and the combustion housing interior walls;
plural stationary combustion chamber seals, each mounted substantially between adjoining combustion housing sections and within the at least one combustion housing, and extending inwardly toward the cylindrical rotor for sealing against portions of the rotor to in part define the combustion chambers;
plural rotor seals mounted for movement upon the cylindrical rotor near a periphery of said at least one rotor within said peripheral channel, the rotor seals being mounted upon said at least one cylindrical rotor in a manner adapted to allow movement which includes radial movement to seal with the at least one interior cavity and the at least one combustion recess as the rotor rotates;
plural fuel injectors for injecting pressurized fuel into the plurality of combustion chambers adjacent to said plural stationary combustion chamber seals;
plural air injectors for injecting pressurized combustion air into the plurality of combustion chambers adjacent to said plural stationary combustion chamber seals;
plural exhaust ports to allow release of combustion gases from the plurality of combustion chambers.

112. An apparatus according to claim 111, wherein:
a joint is defined between each pair of adjoining combustion housing 2 sections;
a combustion chamber seal is positioned substantially proximate each joint.

113. An apparatus according to claim 111, wherein:
a gap is defined between each pair of adjoining combustion housing sections;
one of the combustion chamber seals is operatively disposed within each gap.

114. An apparatus forming a rotary internal combustion engine, comprising:
a combustion housing forming at least part of a stator, said combustion housing having adjoining housing pieces, the housing pieces having interior walls with combustion recesses formed therein;
an interior cavity substantially enclosed within said combustion housing when the apparatus is assembled;
a drive shaft extending within the combustion housing;
a rotor which is connected to said drive shaft and mounted in the interior cavity for rotation;
a plurality of combustion chambers formed within the interior cavity between the combustion recesses and the rotor;
radially movable rotor seals mounted upon said rotor which follow the interior walls with combustion recesses;
plural stationary combustion chamber seals which are positioned to seal against the rotor, wherein each combustion chamber seal is operatively disposed between a respective pair of adjoining housing pieces.

115. An apparatus according to claim 114, wherein:
a gap is defined between each pair of adjoining housing pieces;
a combustion chamber seal is operatively disposed within each gap.

116. A method for operating a rotary engine, comprising:
selecting a rotary engine having plural housing pieces joined to form a housing with a substantially enclosed interior compartment, a rotor mounted for movement within said interior compartment, a plurality of combustion chambers recesses formed along interior walls of the housing interior compartment, movable rotor seals along peripheral portions of the rotor, and a housing seal between each pair of adjoining housing pieces, which seals engage peripheral portions of the rotor to define a plurality of combustion chambers;
controllably injecting pressurized fuel into the combustion compartments;
controllably injecting pressurized air into the combustion compartments;
controlling the frequency of combustion events which occur to vary the power or torque developed by the rotary engine.

117. A method for operating a rotary engine, having a plurality of combustion chambers and controlling the frequency of combustion events which occur to vary the power or torque developed by the rotary engine.

118. A method according to claim 117 wherein the controlling varies which of the combustion chambers are active during different revolutions of operation.

119. An apparatus forming a rotary internal combustion engine, comprising:
a stator;
at least one combustion housing forming at least part of said stator;
an interior cavity substantially enclosed within said at least one combustion housing when assembled;
a drive shaft which extends from the interior cavity;
a rotor which is cylindrical and has a peripheral channel, said rotor being mounted within the interior cavity and connected to said drive shaft for rotation therewith;
a plurality of combustion recesses formed along interior walls of the at least one combustion interior cavity in opposing relationship to the rotor peripheral channel;
a plurality of combustion chambers formed between peripheral portions of the rotor and the combustion housing interior walls;
plural stationary combustion chamber seals mounted in the at least one combustion housing and extending inwardly toward the cylindrical rotor for sealing against portions of the rotor to in part define the combustion chambers;
plural rotor seals mounted for movement upon the cylindrical rotor near a periphery of said at least one rotor within said peripheral channel, the rotor seals being mounted upon said at least one cylindrical rotor in a manner adapted to allow movement which includes radial movement to seal with the at least one interior cavity and the at least one combustion recess as the rotor rotates;
plural fuel injectors for injecting pressurized fuel into the plurality of combustion chambers adjacent to said plural stationary combustion chamber seals;
plural air injectors for injecting pressurized combustion air into the plurality of combustion chambers adjacent to said plural stationary combustion chamber seals;
plural exhaust ports to allow release of combustion gases from the plurality of combustion chambers.

120. An apparatus forming a rotary internal combustion engine, comprising:
a combustion housing forming at least part of a stator, said combustion housing having housing pieces, the housing pieces having interior walls with combustion recesses formed therein;
an interior cavity substantially enclosed within said combustion housing when the apparatus is assembled;
a drive shaft extending within the combustion housing;
a rotor which is connected to said drive shaft and mounted in the interior cavity for rotation;
a plurality of combustion chambers formed within the interior cavity between the combustion recesses and the rotor;
radially movable rotor seals mounted upon said rotor which follow the interior walls with combustion recesses;
plural stationary combustion chamber seals.

121. A method for operating a rotary engine, comprising:
selecting a rotary engine having a housing with substantially enclosed interior compartment, a rotor mounted for movement within said interior compartment, a plurality of combustion chambers recesses formed along interior walls of the housing interior compartment, movable rotor seals along peripheral portions of the rotor, and housing seals which engage peripheral portions of the rotor to define a plurality of combustion chambers;
selectively adjusting the housing seals to engage the rotor with a desired force;
controllably injecting pressurized fuel into the combustion compartments;
controllably injecting pressurized air into the combustion compartments;
controlling the frequency of combustion events which occur to vary the power or torque developed by the rotary engine.

122. An apparatus forming a rotary internal combustion engine, having a stator with a combustion housing and an interior compartment with a plurality of substantially enclosed combustion chambers separated by stator seals the plurality of combustion chambers having internal surfaces configured to have varying working volumes at different angular positions of a rotor having movable rotor seals mounted upon the rotor to follow said internal surfaces to define changeable working volumes as the rotor rotates, combustion component injectors for injecting combustion materials into combustion chambers which are to be active for combustion adjacent to said stator seals, and a controller which senses operational parameters and provides variable firing frequencies during operation to achieve varying combustion event patterns.

123. An apparatus according to claim 122 wherein the rotor seals are movable relative to peripheral portions of the rotor.

124. An apparatus according to claim 122 wherein the rotor seals are movable relative to peripheral portions of the rotor and having rotor seal biasing mechanisms to urge the rotor seals toward the internal surfaces of the combustion chambers.

125. An apparatus according to claim 122 wherein the rotor seals are rockers that move within rocker receptacles formed in peripheral portions of the rotor.

126. An apparatus according to claim 122 wherein the rotor seals are rockers that move within rocker receptacles formed in peripheral portions of the rotor and further comprising rocker seals that seal between the rockers and rocker receptacles.

127. An apparatus according to claim 122 wherein the rotor seals are vane seals that move within vane receptacles formed in peripheral portions of the rotor.

128. An apparatus according to claim 122 wherein the rotor seals are vane seals that move within vane receptacles formed in peripheral portions of the rotor and rotor seal biasing mechanisms to urge the rotor seals toward the internal surfaces of the combustion chambers.

129. An apparatus according to claim 122 wherein the rotor seals are radial vane seals that move within vane receptacles formed in peripheral portions of the rotor.

130. An apparatus according to claim 122 wherein there are rotor seals and stator seals are positioned at approximately equal angular spacings between the respective seals.

131. An apparatus according to claim 122 wherein there are rotor seals and stator seals are positioned at approximately equal angular spacings.

132. An apparatus according to claim 122 and further comprising at least one compressor connected to controllably supply said combustion materials under pressure.

133. An apparatus according to claim 122 and further comprising at least one compressor connected to controllably supply said combustion materials under pressures in excess of 1000 pounds per square inch.

134. A method for operating a rotary engine wherein the rotary engine has plural combustion chambers and at least one controller adapted to change frequency of firing combustion chambers in response to at least one sensed operating parameter.

135. A method according to claim 134 wherein said at least one controller is further adapted to change the order of firing of said plural combustion chambers.

136. An apparatus forming a rotary internal combustion engine, having a stator with a combustion housing and an interior compartment with a plurality of substantially enclosed combustion chambers separated by stator seals, the plurality of combustion chambers having internal surfaces configured to have varying working volumes at different angular positions of a rotor having movable rotor seals mounted upon the rotor to follow said internal surfaces to define changeable combustion chamber working volumes as the rotor rotates, combustion component injectors for injecting combustion materials at pressures in excess of 1000 pounds per square inch as injected into combustion chambers which are to be active for combustion.

137. An apparatus forming a rotary internal combustion engine, having a stator with a combustion housing and an interior compartment with a plurality of substantially enclosed combustion chambers separated by stator seals, the plurality of combustion chambers having internal surfaces configured to have varying working volumes at different angular positions of a rotor having movable rotor seals mounted upon the rotor to follow said internal surfaces to define changeable combustion chamber working volumes as the rotor rotates, the rotor seals being movable in a rocking action.

138. An apparatus forming a rotary internal combustion engine, having a stator with a combustion housing and an interior compartment with a plurality of substantially enclosed combustion chambers separated by stator seals, the plurality of combustion chambers having internal surfaces configured to have varying working volumes at different angular positions of a rotor having movable rotor seals mounted upon the rotor to follow said internal surfaces to define changeable combustion chamber working volumes as the rotor rotates, the rotor seals being movable in a pivotable action with respect to the rotor.
